(19) United States
(12) Patent Application Publication
(10) Pub. No.: US 2026/0349363 A1
(43) Pub. Date: Nov. 5, 2026

(54) IMAGE FORMING APPARATUS AND TONER CARTRIDGE

(71) Applicant: CANON KABUSHIKI KAISHA, Tokyo (JP)

(72) Inventor: SHUNSUKE HIJIKATA, Kanagawa (JP)

(21) Appl. No.: 19/664,634

(22) Filed: Apr. 30, 2026

(30) Foreign Application Priority Data
May 2, 2025 (JP) 2025-076509

(51) Int. Cl. G03G 15/01; G03G 15/08; G03G 21/16

(52) U.S. Cl. CPC G03G 15/0173; G03G 15/0875; G03G 15/0886; G03G 21/1647; G03G 2221/1654

(57) ABSTRACT

An image forming apparatus includes a first developing unit including a first developing roller and a first inlet opening, a second developing unit including a second inlet opening, a first toner cartridge including a first discharge opening and a to-be-positioned portion, a second toner cartridge including a second discharge opening, and a positioning portion. The first toner cartridge is configured to move relative to the first developing unit between a first mounted position and a first retracted position. The positioning portion is configured to engage with the to-be-positioned portion of the first toner cartridge at the first mounted position. In a rotation axis direction of the first developing roller, at least a part of the to-be-positioned portion and at least a part of the first discharge opening are located at a same position.

### BACKGROUND

### Field of the Technology

The present disclosure relates to an image forming apparatus that forms an image on a recording material and to a toner cartridge.

### Description of the Related Art

Known are electrophotographic image forming apparatuses of rotary developing system that form a color image by rotating a rotary including a plurality of developing members. Japanese Patent Laid-Open Nos. 2007-183305 and 2008-096852 describe image forming apparatuses that include a rotary including a plurality of developing rollers and a plurality of toner cartridges (toner accommodation containers) each detachably attachable to the rotary.

### SUMMARY

The present disclosure is directed to providing an image forming apparatus of a new form that is an advancement of the conventional technology.

According to an aspect of the present disclosure, an image forming apparatus includes a first developing unit including a first developing roller configured to rotate, a first supply chamber configured to accommodate toner to be supplied to the first developing roller, and a first inlet opening communicating with the first supply chamber, a second developing unit including a second developing roller configured to rotate, a second supply chamber configured to accommodate toner to be supplied to the second developing roller, and a second inlet opening communicating with the second supply chamber, a first toner cartridge including a first accommodation chamber configured to accommodate toner, a first discharge opening communicating with the first accommodation chamber, and a to-be-positioned portion, the first toner cartridge being configured to move relative to the first developing unit between a first mounted position where the first discharge opening is opposed to the first inlet opening and a first retracted position retracted from the first mounted position, a second toner cartridge including a second accommodation chamber configured to accommodate toner and a second discharge opening communicating with the second accommodation chamber, the second toner cartridge being configured to move relative to the second developing unit between a second mounted position where the second discharge opening is opposed to the second inlet opening and a second retracted position retracted from the second mounted position, and a positioning portion configured to engage with the to-be-positioned portion of the first toner cartridge at the first mounted position such that the first toner cartridge is restricted from moving relative to the first developing unit in a rotation axis direction of the first developing roller, wherein in the rotation axis direction, at least a part of the to-be-positioned portion and at least a part of the first discharge opening are located at a same position, and at least a part of the positioning portion and at least a part of the first inlet opening are located at a same position, and wherein, in a direction orthogonal to the rotation axis direction, the positioning portion is disposed closer to the second developing unit than to the first developing unit.

According to another aspect of the present disclosure, a toner cartridge configured to be detachably mounted in a developing unit including a positioning portion, the toner cartridge includes a toner frame including an accommodation chamber configured to accommodate toner, a discharge opening communicating with the accommodation chamber, and a to-be-positioned portion, wherein the to-be-positioned portion is configured to engage with the positioning portion such that the toner cartridge is restricted from moving relative to the developing unit in a longitudinal direction of the toner cartridge, and a toner shutter configured to move in an opening direction from a closed position where the discharge opening is covered to an open position where the discharge opening is exposed, wherein the discharge opening has a first end and a second end opposite to the first end in the longitudinal direction, wherein the to-be-positioned portion is located between the first end and the second end in the longitudinal direction, and wherein the to-be-positioned portion extends along the opening direction of the toner shutter.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an image forming apparatus according to a first embodiment.

FIG. 2 is a configuration diagram of the image forming apparatus according to the first embodiment.

FIG. 3 is a schematic diagram illustrating a developing unit, a toner cartridge, and a tray according to the first embodiment.

FIGS. 4A and 4B are sectional views of the image forming apparatus according to the first embodiment.

FIG. 5 is a perspective view of a rotary main body according to the first embodiment.

FIGS. 6A to 6C are perspective views of the image forming apparatus according to the first embodiment.

FIGS. 7A and 7B are sectional views of the image forming apparatus according to the first embodiment.

FIG. 8 is an explanatory diagram of the rotary main body according to the first embodiment.

FIG. 9 is an explanatory diagram of the rotary main body according to the first embodiment.

FIG. 10 is an explanatory diagram of the rotary main body according to the first embodiment.

FIGS. 11A and 11B are explanatory diagrams of a configuration related to tray movement according to the first embodiment.

FIGS. 12A and 12B are explanatory diagrams of a configuration related to tray movement according to the first embodiment.

FIGS. 13A and 13B are explanatory diagrams of a toner cartridge according to the first embodiment.

FIG. 14 is an exploded perspective view of the toner cartridge according to the first embodiment.

FIG. 15 is an exploded perspective view of the toner cartridge according to the first embodiment.

FIG. 16 is a sectional view of the toner cartridge according to the first embodiment.

FIG. 17 is a sectional view of the toner cartridge according to the first embodiment.

FIG. 18 is a perspective view of the toner cartridge according to the first embodiment.

FIG. 19 is a perspective view of the developing unit according to the first embodiment.

FIG. 20 is an exploded perspective view of the developing unit according to the first embodiment.

FIG. 21 is an exploded perspective view of the developing unit according to the first embodiment.

FIG. 22 is a sectional view of the developing unit according to the first embodiment.

FIG. 23 is a perspective view of the rotary main body according to the first embodiment.

FIG. 24 is a perspective view for illustrating mounting of the toner cartridge according to the first embodiment.

FIG. 25 is a perspective view for illustrating mounting of the toner cartridge according to the first embodiment.

FIG. 26 is a sectional view for illustrating mounting of the toner cartridge according to the first embodiment.

FIG. 27 is a sectional view for illustrating mounting of the toner cartridge according to the first embodiment.

FIG. 28 is a sectional view for illustrating mounting of the toner cartridge according to the first embodiment.

FIG. 29 is a perspective view for describing mounting of the toner cartridge according to the first embodiment.

FIG. 30 is a sectional view for illustrating mounting of the toner cartridge according to the first embodiment.

FIG. 31 is a sectional view for illustrating mounting of the toner cartridge according to the first embodiment.

FIG. 32 is a sectional view for illustrating mounting of the toner cartridge according to the first embodiment.

FIG. 33 is a sectional view for illustrating mounting of the toner cartridge according to the first embodiment.

FIG. 34 is a sectional view for illustrating mounting of the toner cartridge according to the first embodiment.

FIG. 35 is a sectional view for illustrating mounting of the toner cartridge according to the first embodiment.

FIG. 36 is a perspective view for describing mounting of the toner cartridge according to the first embodiment.

FIGS. 37A and 37B are sectional views for illustrating mounting of the toner cartridge according to the first embodiment.

FIGS. 38A and 38B are explanatory diagrams of a toner cartridge according to a second embodiment.

FIG. 39 is an exploded perspective view of the toner cartridge according to the second embodiment.

FIG. 40 is an exploded perspective view of the toner cartridge according to the second embodiment.

FIG. 41 is a sectional view of the toner cartridge according to the second embodiment.

FIG. 42 is an exploded perspective view of the developing unit according to the second embodiment.

FIG. 43 is a perspective view of the rotary main body according to the second embodiment.

FIG. 44 is a perspective view for illustrating mounting of the toner cartridge according to the second embodiment.

FIG. 45 is a sectional view for illustrating mounting of the toner cartridge according to the second embodiment.

FIG. 46 is a sectional view for illustrating mounting of the toner cartridge according to the second embodiment.

FIG. 47 is a sectional view for illustrating mounting of the toner cartridge according to the second embodiment.

### DESCRIPTION OF THE EMBODIMENTS

Embodiments according to the present disclosure will be described below with reference to the drawings.

### First Embodiment

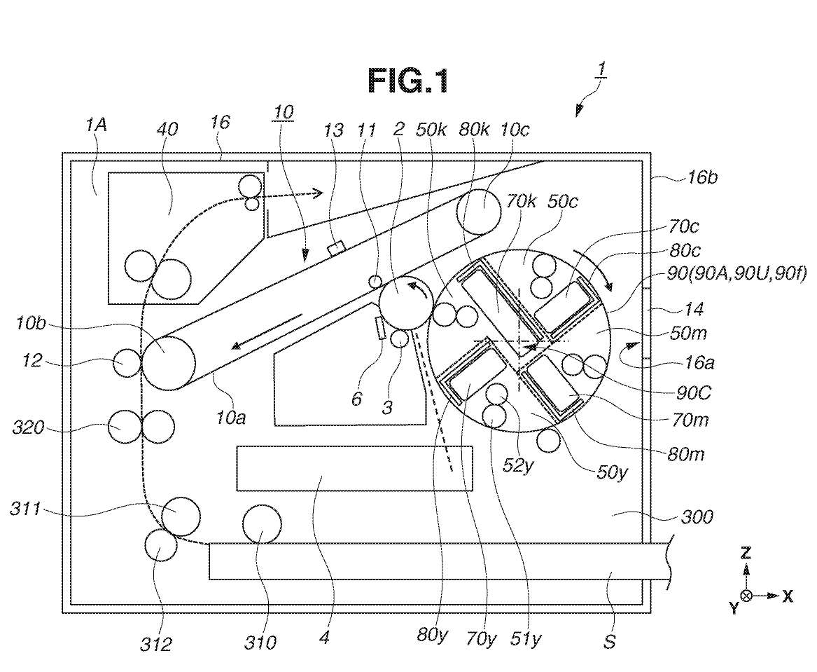

An image forming apparatus 1 according to a first embodiment will be described with reference to FIGS. 1 to 12B.

In the following description and the drawings, a vertical direction when the image forming apparatus 1 is installed on a horizontal surface will be referred to as a Z direction. A direction that intersects the Z direction and is along the direction of a rotation axis 90C of a rotary main body 90 to be described below (the rotation axis direction of the rotary) will be referred to as a Y direction. A direction intersecting both the Z and Y directions will be referred to as an X direction. The X and Y directions can be horizontal directions. The X, Y, and Z directions can be orthogonal to each other. Where needed, the directions of the arrows X, Y, and Z illustrated in the drawings are referred to as a +X side, a +Y side, and a +Z side, respectively, and the opposite sides as a -X side, a -Y side, and a -Z side, respectively.

### Overall Configuration of Image Forming Apparatus

An overall configuration of the image forming apparatus 1 will initially be described. The image forming apparatus 1 is a laser beam printer that electrophotographically forms images on sheets S. More specifically, the image forming apparatus 1 is a color laser beam printer including four developing units 50y, 50m 50c, and 50k. For sheets S serving as recording materials (recording media), various sheet members of different sizes and materials can be used, including paper such as plain paper and thick paper, plastic films, fabric, surface-treated sheet members such as coated paper, and special-shaped sheet members such as envelopes and index paper.

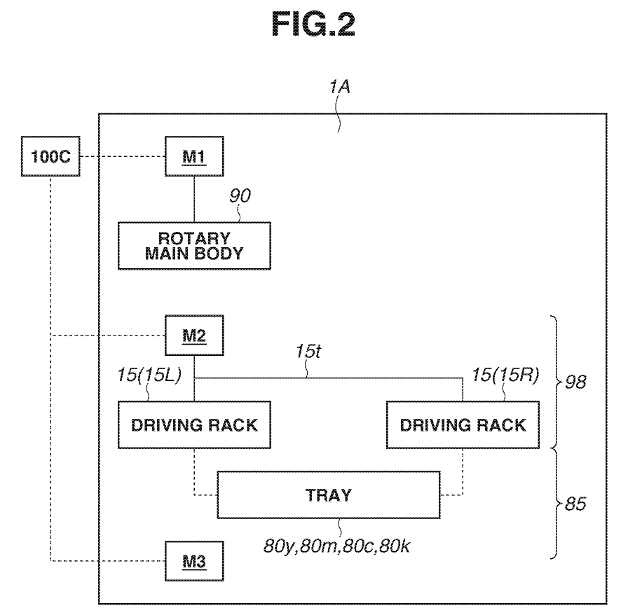

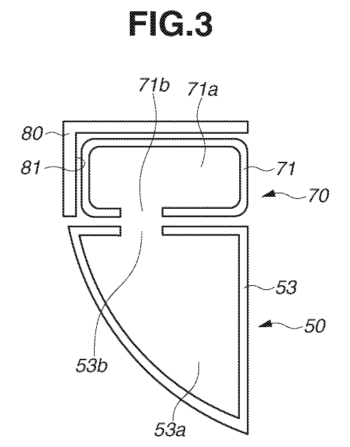

A schematic configuration and an image forming operation of the image forming apparatus 1 will be described with reference to FIGS. 1, 2, and 3. FIG. 1 is a schematic diagram illustrating a sectional configuration of the image forming apparatus 1. FIG. 2 is a diagram for describing drive sources of the image forming apparatus 1. FIG. 3 is a conceptual diagram illustrating a configuration for replenishing toner from a toner cartridge 70 to a developing unit 50.

As illustrated in FIG. 1, the image forming apparatus 1 includes an image forming apparatus main body (hereinafter, apparatus main body) 1A, and toner cartridges 70y, 70m, 70c, and 70k detachably attachable to the apparatus main body 1A. The apparatus main body 1A of the present embodiment refers to the image forming apparatus 1 excluding the toner cartridges 70y, 70m, 70c, and 70k.

The apparatus main body 1A of the image forming apparatus 1 includes a drum-shaped (cylindrical) electrophotographic photosensitive member (hereinafter, photosensitive drum) 2 as an image bearing member for bearing an electrostatic latent image. A charging roller 3, a scanner 4 serving as an exposure device, and a cleaning unit 6 are disposed near the photosensitive drum 2.

The charging roller 3 is an example of a charging unit for uniformly charging the photosensitive drum 2. The scanner 4 is an example of an exposure unit that irradiates and exposes the photosensitive drum 2 with laser light based on image information. Irradiating the charged photosensitive drum 2 with the laser light forms an electrostatic latent image on the surface of the photosensitive drum 2. The cleaning unit 6 is an example of a cleaning unit that removes toner remaining on the surface of the photosensitive drum 2.

The apparatus main body 1A also includes a sheet accommodation unit 300, a pickup roller 310, a feed roller 311, a separation roller 312, a conveyance roller pair 320, a secondary transfer roller 12, a fixing device 40, and an intermediate transfer unit 10. The pickup roller 310 is an example of a feed unit that feeds sheets S. The feed roller 311 and the separation roller 312 are an example of a separation conveyance unit that frictionally separates and conveys sheets S one by one. The secondary transfer roller 12 is an example of a transfer unit that transfers images from an intermediate transfer belt 10a to a sheet S.

The intermediate transfer unit 10 includes the intermediate transfer belt 10a, a belt driving roller 10b, a tension roller 10c, a cleaning device 13, and a primary transfer roller 11. The intermediate transfer belt 10a is an example of an intermediate transfer member for bearing images transferred (primarily transferred) from the photosensitive drum 2 and conveying the images for the sake of transfer (secondary transfer) to the sheet S. The intermediate transfer belt 10a is stretched across the belt driving roller 10b and the tension roller 10c. The belt driving roller 10b is a driving member that is driven to rotate by a drive source and thereby conveys the intermediate transfer belt 10a.

The apparatus main body 1A also includes a rotary main body (rotary, rotating body, or developing device) 90 including the developing units 50y, 50m, 50c, and 50k. As will be described below, in the present embodiment, trays (support members) 80y, 80m, 80c, and 80k are attached to the rotary main body 90. The toner cartridges 70y, 70m, 70c, and 70k are detachably mounted on the trays 80y, 80m, 80c, and 80k.

In the following description, multiple members and the like with similar functions can be numbered for distinction. For example, one of the toner cartridges 70y, 70m, 70c, and 70k may be referred to as a first toner cartridge, one of the remaining three as a second toner cartridge, one of the remaining two as a third toner cartridge, and the last one as a fourth toner cartridge. Similarly, one of the trays 80y, 80m, 80c, and 80k may be referred to as a first tray, one of the remaining three as a second tray, one of the remaining two as a third tray, and the last one as a fourth tray. In other words, one of the trays 80y to 80k is an example of a first support member, another one of the trays 80y to 80k is an example of a second support member, yet another one of the trays 80y to 80k is an example of a third support member, and the last one of the trays 80y to 80k is an example of a fourth support member. Such numbering is used merely for the convenience of description and can in principle be interchanged as appropriate.

The developing units (first to fourth developing units) 50y, 50m, 50c, and 50k are an example of developing units that develop (visualize) electrostatic latent images formed on the photosensitive drum 2 into toner images using toner of respective corresponding colors. The developing units 50y, 50m, 50c, and 50k develop electrostatic latent images formed on the photosensitive drum 2 using yellow toner, magenta toner, cyan toner, and black toner, respectively. The developing units 50y, 50m, 50c, and 50k may be arranged in a different order from that illustrated in FIG. 1.

The developing unit 50y includes a developing roller 51y, a supply roller 52y, and a developing blade. The developing roller 51y is a developer bearing member that rotates with toner serving as a developer borne thereon, and supplies the toner to the photosensitive drum 2. The supply roller 52y is a supply member that is disposed in contact with the developing roller 51y and supplies toner to the developing roller 51y. The developing blade is a regulating member that regulates the thickness of the toner layer borne on the developing roller 51y. The other developing units 50m, 50c, and 50k include similar developing rollers 51m, 51c, and 51k, supply rollers 52m, 52c, and 52k, and developing blades.

The toner cartridges 70y, 70m, 70c, and 70k corresponding to the developing units 50y, 50m, 50c, and 50k are mounted in the rotary main body 90. The toner cartridges 70y, 70m, 70c, and 70k accommodate yellow toner, magenta toner, cyan toner, and black toner, respectively, as toner to replenish the developing units 50y, 50m, 50c, and 50k with. One of the four color toners may be referred to as a first toner, one of the remaining three color toners as a second toner, one of the remaining two color toners as a third toner, and the last one as a fourth toner. For example, black toner can be said to be an example of the first toner, and magenta toner as an example of the second toner. Such numbering is used merely for the convenience of description and can in principle be interchanged as appropriate.

The rotary main body 90 includes a rotary frame 90f for supporting the developing units 50y, 50m, 50c, and 50k. The developing units 50y, 50m, 50c, and 50k are supported by the rotary frame 90f, which is a rotatable rotating support member.

The trays 80y, 80m, 80c, and 80k are attached to the rotary main body 90. The combination of the rotary main body 90 with the trays 80y, 80m, 80c, and 80k may be referred to as a rotary unit 90U. In other words, the rotary unit 90U includes the rotary main body 90 and the trays 80y, 80m, 80c, and 80k.

The toner cartridges 70y to 70k are held by the trays 80y to 80k in a detachably attachable manner. As will be described below, the trays 80y to 80k are supported to be slidable to outside the rotary main body 90. The combination of the rotary unit 90U with the toner cartridges 70y, 70m, 70c, and 70k may be referred to as a rotary assembly 90A. In other words, the rotary assembly 90A includes the rotary unit 90U and the toner cartridges 70y, 70m, 70c, and 70k.

As will be described below, the rotary main body 90 is rotatable about the rotation axis (rotation center) 90C. The rotation axis 90C matches the rotation axes of the rotary frame 90f, the rotary unit 90U, and the rotary assembly 90A. The rotation axis 90C is substantially parallel to the rotation axis (rotation center) of the photosensitive drum 2.

By rotating about the rotation axis 90C, the rotary main body 90 can assume developing orientations where one of the developing rollers 51y, 51m, 51c, and 51k is opposed to the photosensitive drum 2. The orientation where the developing roller 51y is opposed to the photosensitive drum 2 will be referred to as a yellow developing orientation. The orientation where the developing roller 51m is opposed to the photosensitive drum 2 will be referred to as a magenta developing orientation. The orientation where the developing roller 51c is opposed to the photosensitive drum 2 will be referred to as a cyan developing orientation. The orientation where the developing roller 51k is opposed to the photosensitive drum 2 will be referred to as a black developing orientation. That is, the rotary main body 90 can rotate about the rotation axis 90C such that the positions of the developing rollers 51y, 51m, 51c, and 51k relative to the photosensitive drum 2 change. In other words, the rotation of the rotary main body 90 displaces the developing rollers 51y, 51m, 51c, and 51k relative to the photosensitive drum 2. The black developing orientation is an example of a first developing orientation where a first developing roller (developing roller 51k) is opposed to the photosensitive drum 2. The other developing orientations are examples of a second developing orientation where a second developing roller (developing rollers 51y to 51c) is opposed to the photosensitive drum 2. The yellow, magenta, cyan, and black developing orientations may be referred to as first to fourth developing orientations. Such numbering is used merely for the convenience of description and can in principle be interchanged as appropriate.

As illustrated in FIG. 2, the apparatus main body 1A includes motors M1, M2, and M3 serving as drive sources, and a control unit 100C that controls the motors M1, M2, and M3. The control unit 100C includes one or more processing devices such as a central processing unit. As will be described below, the motor M1 supplies driving force for rotating the rotary main body 90 about the rotation axis 90C. In other words, the motor M1 rotates the rotary assembly 90A and the rotary unit 90U about the rotation axis 90C.

The apparatus main body 1A also includes a driving device 98 including the motor M2 and a transmission device. The transmission device includes driving racks 15L and 15R serving as drive gears to be described below, and a transmission unit 15t. The driving force of the motor M2 is transmitted to the driving racks 15L and 15R by the transmission unit 15t. In other words, the motor M2 is configured to drive the driving racks 15L and 15R, and moves the trays 80y, 80m, 80c, and 80k relative to the rotary main body 90 via the driving racks 15L and 15R.

The motor M3 drives members other than those driven by the motors M1 and M2. For example, the motor M3 drives the photosensitive drum 2, the developing units 50y, 50m, 50c, and 50k, the pickup roller 310, the feed roller 311, the conveyance roller pair 320, the secondary transfer roller 12, the belt driving roller 10b, and the fixing device 40.

The members for the motors M1, M2, and M3 to drive may be changed as appropriate. The roles of any two of the motors M1, M2, and M3, or all the three, may be integrated into one motor. Drive sources other than the motors M1, M2, and M3 may be added.

The suffixes y, m, c, and k attached to the developing units 50y, 50m, 50c, and 50k, the toner cartridges 70y, 70m, 70c, and 70k, the trays 80y, 80m, 80c, and 80k, and the like represent toner colors. The developing units 50y, 50m, 50c, and 50k have common basic configuration and functions. The toner cartridges 70y, 70m, 70c, and 70k have common basic configuration and functions. The trays 80y, 80m, 80c, and 80k have common basic configuration and functions. When there is no need to distinguish the members, the suffixes y, m, c, and k are therefore omitted, and the unit, cartridge, or tray will be described as referring to any one of the four units, cartridges, or trays.

As illustrated in FIG. 3, the toner cartridge 70 includes a toner frame 71. The toner frame 71 includes a toner accommodation portion (toner accommodation chamber, accommodation chamber) 71a that accommodates toner, and a discharge opening 71b that communicates with the toner accommodation portion 71a.

The developing unit 50 includes a developing frame (accommodation frame) 53. The developing frame 53 includes a developing-side accommodation portion 53a and an inlet opening 53b that communicates with the developing-side accommodation portion (toner supply chamber, supply chamber) 53a. As described above, the developing unit 50 also includes members such as the developing roller 51 and the supply roller 52, which are omitted in FIG. 3.

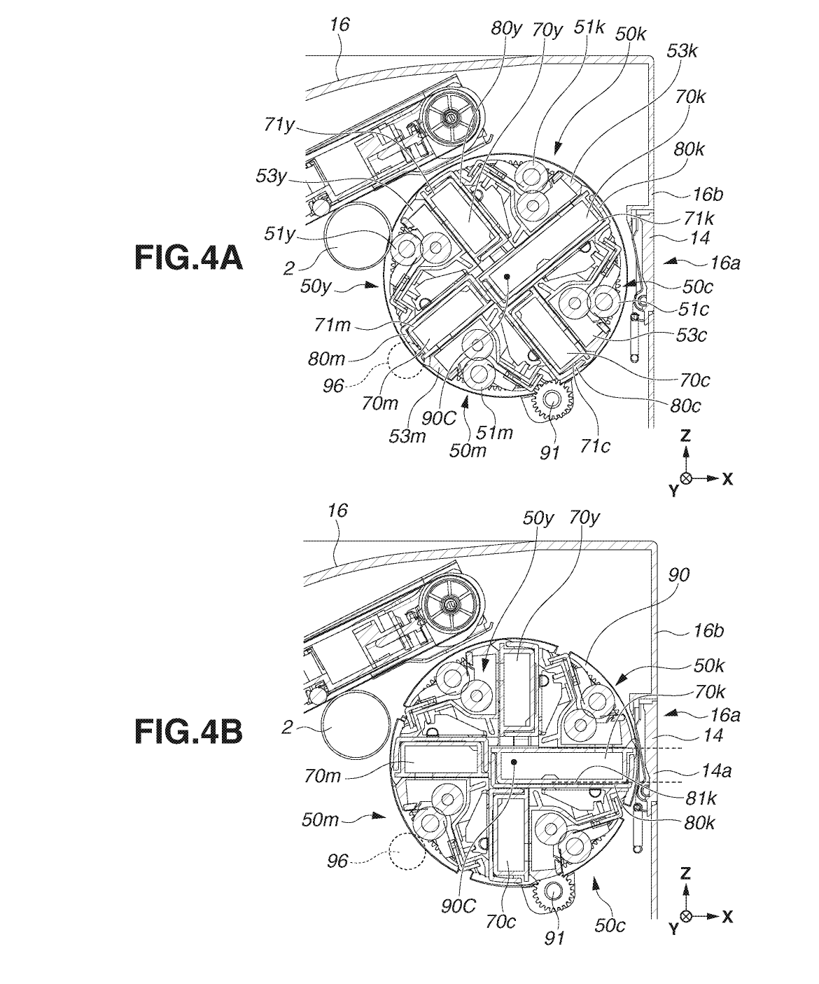

The developing roller 51k included in the developing unit 50k is an example of the first developing roller. The developing roller 51m included in the developing unit 50m is an example of the second developing roller. The developing frame 53k (FIG. 4A) of the developing unit 50k including the developing-side accommodation portion 53a is an example of a first accommodation frame including a first accommodation portion. The developing frame 53m (FIG. 4A) of the developing unit 50m including the developing-side accommodation portion 53a is an example of a second accommodation frame including a second accommodation portion. The rotary main body 90 is an example of a rotatable rotary including the first developing roller, the second developing roller, the first accommodation frame including the first accommodation portion, and the second accommodation frame including the second accommodation portion. In the present embodiment, the rotary main body 90 includes first to fourth developing rollers and first to fourth accommodation frames.

As will be described below, the toner cartridge 70 can move relative to the developing frame 53 between a mounted position and a retracted position retracted from the mounted position. With the toner cartridge 70 at the mounted position relative to the developing frame 53, the discharge opening 71b is opposed to the inlet opening 53b. In other words, the toner accommodation portion 71a of the toner cartridge 70 and the developing-side accommodation portion 53a of the developing unit 50 communicate via the discharge opening 71b and the inlet opening 53b. When toner is replenished from the toner cartridge 70 to the developing unit 50, at least a part of the inlet opening 53b is located under at least a part of the discharge opening 71b.

The toner accommodated in the toner accommodation portion 71a is then discharged from the discharge opening 71b. The toner discharged from the discharge opening 71b is accommodated into the developing-side accommodation portion 53a through the inlet opening 53b. The toner accommodated in the developing-side accommodation portion 53a is supplied to the developing roller 51 by the supply roller 52. Through such a path, the toner accommodated in the toner accommodation portion 71a is supplied to the developing roller 51.

The toner cartridge 70 desirably includes a not-illustrated sealing member (first sealing member) that covers the discharge opening 71b. The developing unit 50 desirably includes a not-illustrated sealing member (second sealing member) that covers the inlet opening 53b.

With the toner cartridge 70 not mounted in the developing unit 50, the discharge opening 71b and the inlet opening 53b are desirably covered by the respective sealing members to prevent toner outflow from the discharge opening 71b and the inlet opening 53b.

### Image Forming Operation

An image forming operation according to the present embodiment will be described. The photosensitive drum 2 is initially rotated in the direction of the arrow in FIG. 1 (counterclockwise) in synchronization with the rotation of the intermediate transfer belt 10a. The surface of the photosensitive drum 2 is then uniformly charged by the charging roller 3.

When forming a color image on a sheet S, the rotary main body 90 with the developing units 50y, 50m, 50c, and 50k supported thereon rotates in the direction of the arrow in FIG. 1 (clockwise) as described below. Electrophotographic processes are then repeated while the developing rollers 51y, 51m, 51c, and 51k are moved to a developing position one by one.

Initially, the scanner 4 emits laser light based on image data corresponding to a yellow image, and thereby forms an electrostatic latent image corresponding to the yellow image on the surface of the photosensitive drum 2. In parallel with the formation of this electrostatic latent image, the motor M1 rotates the rotary main body 90 such that the rotary main body 90 assumes the yellow developing orientation. With the rotary main body 90 in the yellow developing orientation, the developing roller 51y is located at the developing position and develops the electrostatic latent image formed on the photosensitive drum 2 with yellow toner.

In the present embodiment, the developing rollers 51y, 51m, 51c, and 51k are each an elastic roller having a metal shaft covered with rubber. At the developing position, the developing rollers 51y, 51m, 51c, and 51k each develop an electrostatic latent image in contact with the photosensitive drum 2. That is, the image forming apparatus 1 according to the present embodiment employs a contact developing system. However, at the developing position, the developing rollers 51y, 51m, 51c, and 51k may each develop an electrostatic latent image with a gap from the photosensitive drum 2. In other words, the image forming apparatus 1 may employ a non-contact developing system.

Once the yellow toner image is developed, the primary transfer roller 11 located inside the intermediate transfer belt 10a primarily transfers the yellow toner image on the photosensitive drum 2 to the intermediate transfer belt 10a.

The rotary main body 90 is subsequently rotated to move the developing rollers 51m, 51c, and 51k to the developing position in succession, whereby respective toner images are formed. More specifically, after the formation of the yellow toner image on the intermediate transfer belt 10a, the rotary main body 90 assumes the magenta developing orientation and a magenta toner image is formed on the intermediate transfer belt 10a. After the formation of the magenta toner image on the intermediate transfer belt 10a, the rotary main body 90 assumes the cyan developing orientation and a cyan toner image is formed on the intermediate transfer belt 10a. After the formation of the cyan toner image on the intermediate transfer belt 10a, the rotary main body 90 assumes the black developing orientation and a black toner image is formed on the intermediate transfer belt 10a. After the formation of the black toner image on the intermediate transfer belt 10a, the rotary main body 90 rotates in the direction of the arrow illustrated in FIG. 1 (clockwise) about the rotation axis 90C and returns to the yellow developing orientation. Note that the image first formed on the intermediate transfer belt 10a may be of any color. For example, a black toner image may be formed first.

A color image is formed on the intermediate transfer belt 10a by repeating the primary transfer such that the four color toner images are superposed on the intermediate transfer belt 10a. The secondary transfer roller 12 and the cleaning device 13 are not in contact with the intermediate transfer belt 10a until a color image is formed on the intermediate transfer belt 10a.

Meanwhile, sheets S are fed from the sheet accommodation unit 300 located in the lower part of the apparatus main body 1A by the pickup roller 310. The sheets S are fed to the conveyance roller pair 320 as separated one by one by the feed roller 311 and the separation roller 312. The conveyance roller pair 320 conveys the fed sheet S to a transfer portion (secondary transfer portion) that is a nip portion between the intermediate transfer belt 10a and the secondary transfer roller 12. The color image on the intermediate transfer belt 10a is transferred (secondarily transferred) to the surface of the conveyed sheet S.

The sheet S with the color image transferred thereto is conveyed to the fixing device 40. In the fixing device 40, the sheet S is heated and pressurized, whereby the image is fixed to the sheet S. The sheet S passed through the fixing device 40 is discharged to the outside of the image forming apparatus 1 as a product.

In the case of forming a monochrome image on a sheet S, the rotary main body 90 assumes the black developing orientation. In such a state, the photosensitive drum 2 is charged and exposed to form an electrostatic latent image on the surface of the photosensitive drum 2, and the developing roller 51k located at the developing position then develops the electrostatic latent image with black toner. The black toner image is primarily transferred to the intermediate transfer belt 10a, and then secondarily transferred to the sheet S. The subsequent steps are the same as with a color image.

### Rotary Configuration

A configuration of the rotary main body 90 will be described with reference to FIGS. 1, 4A, 4B, and 5.

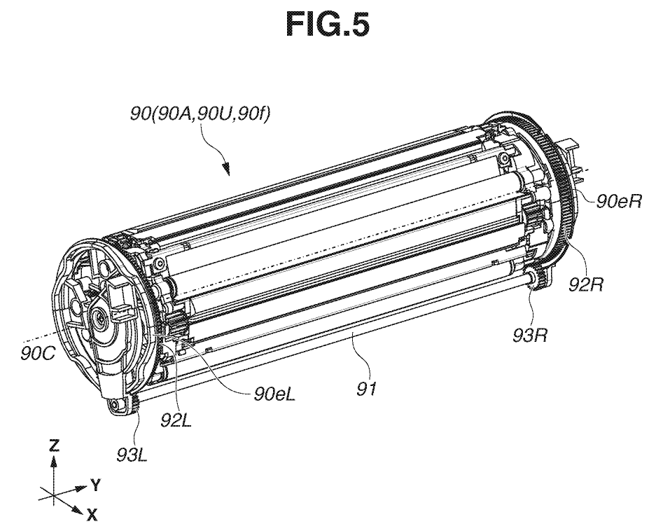

FIGS. 4A and 4B are sectional views illustrating the rotary main body 90 and its periphery in the image forming apparatus 1. FIGS. 4A and 4B are sectional views taken by sectioning the image forming apparatus 1 along an imaginary plane perpendicular to the rotation axis 90C of the rotary main body 90. FIG. 5 is a perspective view of the rotary main body 90.

As described above, the toner cartridges 70y to 70k are detachably attachable to the rotary main body 90. If the toner cartridges 70y to 70k run out of toner, the user can replenish the image forming apparatus 1 with toner by replacing the toner cartridges 70y to 70k.

As illustrated in FIG. 1, the apparatus main body 1A includes a frame 16 that accommodates the rotary main body 90.

The frame 16 is a main body frame of the image forming apparatus 1 according to the present embodiment. The frame 16 is a housing (framework) of the apparatus main body 1A, constituted by frame members and exterior members. In the present embodiment, the frame 16 has a substantially rectangular parallelopiped shape.

The frame 16 has an opening 16a. More specifically, the frame 16 has a side surface 16b extending in a direction intersecting the horizontal direction. The side surface 16b constitutes at least a part of the exterior surface of the apparatus main body 1A on the +X side. The opening 16a is disposed in this side surface 16b. The side surface 16b is a side surface located downstream of a discharge opening of the apparatus main body 1A in a discharge direction in which image-formed sheets S are discharged from the discharge opening. The user can access the sheet accommodation unit 300 to replenish sheets S or acquire the sheets S discharged from the discharge opening from the side surface 16b-side of the image forming apparatus 1. The side surface 16b can thus be said to be the front of the apparatus main body 1A.

The toner cartridges 70y, 70m, 70c, and 70k can be detachably attached to the rotary main body 90 via the opening 16a. That is, the toner cartridge 70k can be said to be an example of a first toner cartridge that accommodates toner to be supplied to the first developing roller (developing roller 51k) and is detachably attachable to the rotary (rotary main body 90) through the opening 16a in the frame 16 of the apparatus main body 1A. The toner cartridge 70m can be said to be an example of a second toner cartridge that accommodates toner to be supplied to the second developing roller (developing roller 51m) and is detachably attachable to the rotary (rotary main body 90) through the opening 16a in the frame 16 of the apparatus main body 1A.

In the present embodiment, the toner cartridges 70y, 70m, 70c, and 70k are attached to and detached from the rotary main body 90 through the opening 16a in a state of being supported by the trays 80y to 80k.

In other words, the user can attach and detach the toner cartridges 70y to 70k to/from the rotary main body 90 via the trays 80y to 80k.

The opening 16a is disposed in the side surface 16b of the frame 16. In the present embodiment, the side surface 16b is a surface substantially parallel to the rotation axis 90C of the rotary main body 90. When the toner cartridge 70 is replaced, the toner cartridge 70 thus passes through the opening 16a in a direction intersecting (desirably orthogonal to) the rotation axis 90C.

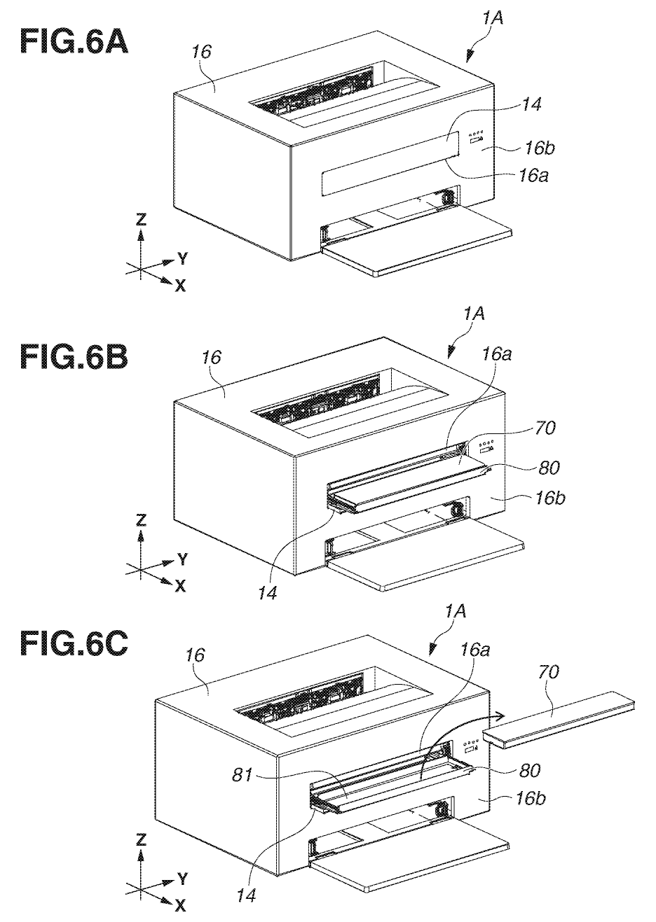

The image forming apparatus 1 includes a door 14 that covers the opening 16a of the frame 16. The door 14 is an opening and closing member movable between a closed position where the opening 16a is covered (see also FIG. 6A) and an open position where the opening 16a is exposed (see also FIGS. 6B and 6C).

As described above, in the present embodiment, the toner cartridge 70 is configured to be detachably attachable to the rotary main body 90 via the tray 80. The toner cartridge 70 can thus be stably attached to and detached from the rotary main body 90.

More specifically, the user can replace the toner cartridge 70 through an operation of attaching and detaching the toner cartridge 70 to/from the tray 80, which is configured to be movable relative to the rotary main body 90 (i.e., relative to the apparatus main body 1A). In a configuration where the user replaces a toner cartridge by directly inserting and removing the toner cartridge into/from the apparatus main body, the user needs to insert the toner cartridge up to a predetermined mounted position inside the apparatus main body. In the present embodiment, the tray 80 with the toner cartridge 70 supported thereon can move so that the toner cartridge 70 moves to the mounted position. The user can thus replace the toner cartridge 70 through the simple operation of placing the toner cartridge 70 on the tray 80, with improved operability.

The toner cartridge 70 has a slender long shape with the Y direction parallel to the rotation axis 90C of the rotary main body 90 as its longitudinal direction. That is, the longitudinal dimension of the toner cartridge 70 is greater than its height and width in a cross section perpendicular to the longitudinal direction. In other words, the projected area of the toner cartridge 70 upon an imaginary plane orthogonal to the Y direction is smaller than that of the toner cartridge 70 projected upon an imaginary plane orthogonal to the Z direction and that of the toner cartridge 70 projected upon an imaginary plane orthogonal to the X direction. Moreover, the projected area of the toner cartridge 70 upon the imaginary plane orthogonal to the X direction is smaller than that of the toner cartridge 70 projected upon the imaginary plane orthogonal to the Z direction. The Z direction may be referred to as the thickness direction of the toner cartridge 70, and the X direction as the transverse direction of the toner cartridge 70. In other words, the length of the toner cartridge 70 in the longitudinal direction is greater than that of the toner cartridge 70 in the transverse direction, and is greater than that of the toner cartridge 70 in the thickness direction. Moreover, the length of the toner cartridge 70 in the transverse direction is greater than that of the toner cartridge 70 in the thickness direction. The longitudinal direction, the transverse direction, and the thickness direction are orthogonal to each other. In handling the toner cartridge 70 of such a slender shape, the toner cartridge 70 can be passed through the opening 16a over a short moving distance, given that the opening 16a is disposed in the side surface 16b of the frame 16 substantially parallel to the longitudinal direction (Y direction) of the toner cartridge 70. This facilitates the replacement of the toner cartridge 70, compared to, for example, when the toner cartridge 70 is inserted and removed through an opening formed in a side surface on one side of the frame 16 in the longitudinal direction of the toner cartridge 70 (+Y side or -Y side).

The rotary main body 90 can rotate about the rotation axis 90C and assume replacement orientations where one of the toner cartridges 70y to 70k can be detached from the rotary main body 90. The orientation where the toner cartridge 70y can be detached will be referred to as a yellow replacement orientation. The orientation where the toner cartridge 70m can be detached will be referred to as a magenta replacement orientation. The orientation where the toner cartridge 70c can be detached will be referred to as a cyan replacement orientation.

The orientation where the toner cartridge 70k can be detached will be referred to as a black replacement orientation.

The black replacement orientation is an example of a first replacement orientation where the first toner cartridge can be detached from the rotary main body 90. The yellow, magenta, and cyan replacement orientations are examples of a second replacement orientation where a second toner cartridge can be detached from the rotary main body 90. The yellow, magenta, cyan, and black replacement orientations may be referred to as first to fourth replacement orientations. Such numbering is used merely for the convenience of description and can in principle be interchanged as appropriate.

The rotary main body 90 can rotate clockwise in FIG. 1 about the rotation axis 90C and sequentially assume the yellow, magenta, cyan, and black replacement orientations. In the present embodiment, the rotary main body 90 alternates the developing and replacement orientations by rotating clockwise in FIG. 1 about the rotation axis 90C. For example, in FIG. 1, the rotary main body 90 is in the black developing orientation. As the rotary main body 90 rotates clockwise from this state, the orientation of the rotary main body 90 switches in the order of the cyan replacement orientation, the yellow developing orientation, the black replacement orientation, the magenta developing orientation, the yellow replacement orientation, the cyan developing orientation, and the magenta replacement orientation. When the rotary main body 90 rotates clockwise from the magenta replacement orientation, the rotary main body 90 returns to the black developing orientation. That is, the rotary main body 90 can rotate clockwise by one rotation (360º) or more.

FIG. 4A illustrates a cross section of the rotary main body 90 assuming a developing orientation (specifically, the yellow developing orientation). FIG. 4B illustrates a cross section of the rotary main body 90 assuming a replacement orientation (specifically, the black replacement orientation).

As illustrated in FIGS. 4A and 4B, the four trays 80y to 80k are attached to the rotary main body 90. The trays 80y, 80m, 80c, and 80k hold the toner cartridges 70y, 70m, 70c, and 70k, respectively. In FIGS. 4A and 4B, the trays 80y to 80k are accommodated inside the rotary main body 90. This state can be said to be a state where the toner cartridges 70y, 70m, 70c, and 70k are mounted in the developing units 50y, 50m, 50c, and 50k.

As described above, the toner cartridge 70 can move relative to the developing frame 53 of the developing unit 50 between the mounted position and the retracted position retracted from the mounted position. Specifically, the first toner cartridge (toner cartridge 70k) can move relative to the first accommodation frame (developing frame 53k) between a first mounted position and a first retracted position. The second toner cartridge (toner cartridge 70m) can move relative to the second accommodation frame (developing frame 53m) between a second mounted position and a second retracted position.

With the toner cartridge 70 at the mounted position relative to the developing frame 53, as illustrated in FIG. 3, the discharge opening 71b and the inlet opening 53b are opposed to each other. The toner cartridge 70 is configured to supply toner to the developing-side accommodation portion 53a through the inlet opening 53b (opening in the accommodation frame) in such a state.

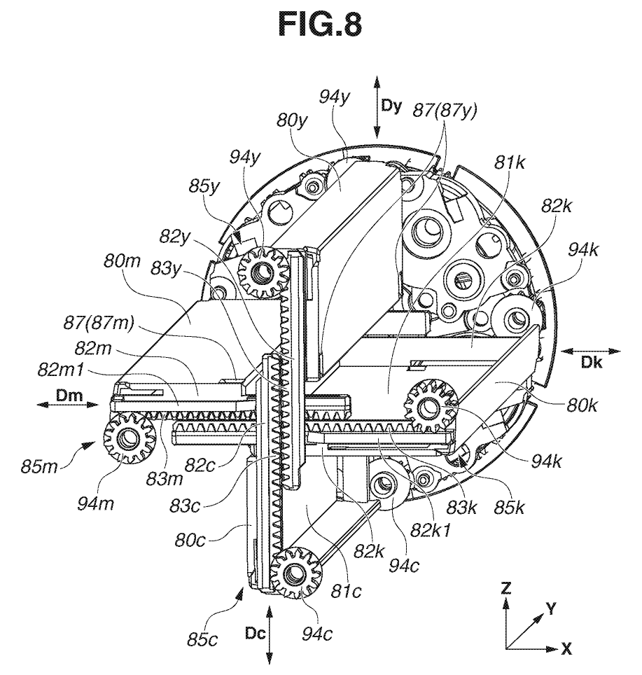

The apparatus main body 1A includes a moving device 85 configured to move the toner cartridge 70 relative to the rotary main body 90 (more specifically, relative to the developing frame 53 of the developing unit 50) from the mounted position to the retracted position. The moving device 85 will be described below with reference to FIG. 8 and the like. In the present embodiment, the rotary main body 90 includes a plurality of moving devices 85y to 85k corresponding to the plurality of toner cartridges 70y to 70k. The trays 80y to 80k can be said to be parts of the moving devices 85y to 85k.

In the present embodiment, the toner cartridge 70k accommodating black toner is greater in size and can accommodate more toner than the toner cartridges 70y to 70c accommodating yellow toner, magenta toner, and cyan toner. In other words, the first toner cartridge can accommodate a first amount of toner, the second toner cartridge can accommodate a second amount of toner, and the first amount can be said to be greater than the second amount.

Specifically, the length of the black toner cartridge 70k in a first radial direction with respect to the rotation axis 90C of the rotary main body 90 is greater than the length of the magenta toner cartridge 70m in a second radial direction. As employed herein, the first radial direction refers to a radial direction of rotation of the rotary main body 90 (radial direction of an imaginary circle about the rotation axes 90C) in which the toner cartridge 70k extends outward relative to the rotation axis 90C when viewed in the direction of the rotation axis 90C. The second radial direction refers to a radial direction of rotation of the rotary main body 90 in which the toner cartridge 70m extends outward relative to the rotation axis 90C when viewed in the direction of the rotation axis 90C. Similarly, the length of the black toner cartridge 70k in the first radial direction is greater than those of the other toner cartridges 70y and 70c in radial directions corresponding to the toner cartridges 70y and 70c.

The tray 80k holding the black toner cartridge 70k is thus greater in size than the trays 80y, 80m, and 80c holding the other toner cartridges 70y, 70m, and 70c. That is, the rotary main body 90 includes the four toner cartridges 70y to 70k and four trays 80y to 80k of different sizes. In other words, the toner cartridge 70k as an example of the first toner cartridge and the toner cartridge 70y as an example of the second toner cartridge smaller in size than the first toner cartridge can be detachably attached to the rotary main body 90. The rotary main body 90 accordingly includes the tray 80k as an example of the first support member that supports the first toner cartridge and the tray 80y as an example of the second support member smaller in size than the first support member. Moreover, the toner cartridges 70m and 70c as an example of the third and fourth toner cartridges smaller in size than the first toner cartridge can be detachably attached to the rotary main body 90. The rotary main body 90 accordingly includes the trays 80m and 80c as an example of the third and fourth support members smaller in size than the first support member.

Now, the rotational driving of the rotary main body 90 will be described with reference to FIG. 5. As illustrated in FIG. 5, the disk gears 92L and 92R are formed on the respective ends of the rotary main body 90. Rotary drive gears 93L and 93R are coupled to the respective ends of a swing shaft 91 in a manner capable of drive transmission. Here, the driving force of the motor M1 is transmitted to the rotary drive gear 93R by a drive transmission mechanism. The driving force is then transmitted to the disk gears 92L and 92R by the rotary drive gears 93L and 93R, whereby the rotary main body 90 is driven to rotate. The rotary main body 90 rotates clockwise in FIG. 1 about the rotation axis 90C.

The rotary main body 90 is also supported to be swingable about the swing shaft 91. The rotary main body 90 is biased counterclockwise in FIGS. 4A and 4B about the swing shaft 91 by a not-illustrated biasing member. This direction can be said to be a direction in which each of the developing rollers 51y to 51k approaches the photosensitive drum 2. As a result, when the rotary main body 90 assumes the developing orientations, the respective developing rollers 51y to 51k contact the photosensitive drum 2.

As illustrated in FIG. 5, rotary cams 90eL and 90eR are disposed at the respective ends of the rotary main body 90. When the rotary main body 90 rotates clockwise in FIGS. 4A and 4B about the rotation axis 90C, the rotary cams 90eL and 90eR come into contact with the roller 96 (FIGS. 4A and 4B) supported by the frame 16. The rotary main body 90 then moves clockwise in FIGS. 4A and 4B about the swing shaft 91. This direction can be said to be one in which each of the developing rollers 51y to 51k recedes from the photosensitive drum 2. This direction can also be said to be one in which the rotary main body 90 approaches the opening 16a of the frame 16 and the door 14.

When the rotary main body 90 rotates and switches from a developing orientation to a replacement orientation, the rotary main body 90 thus swings about the swing shaft 91. With the rotary main body 90 assuming the replacement orientation, the developing roller 51 is separated from the photosensitive drum 2.

As illustrated in FIG. 4B, in the black replacement orientation, the toner cartridge 70k stops at a position opposed to the opening 16a formed in the side surface 16b of the apparatus main body 1A and the door 14. If, in this state, the tray 80k is slid from the mounted position relative to the developing unit 50k to outside the rotary main body 90, the user can replace the toner cartridge 70k.

### Toner Cartridge Replacement Operation

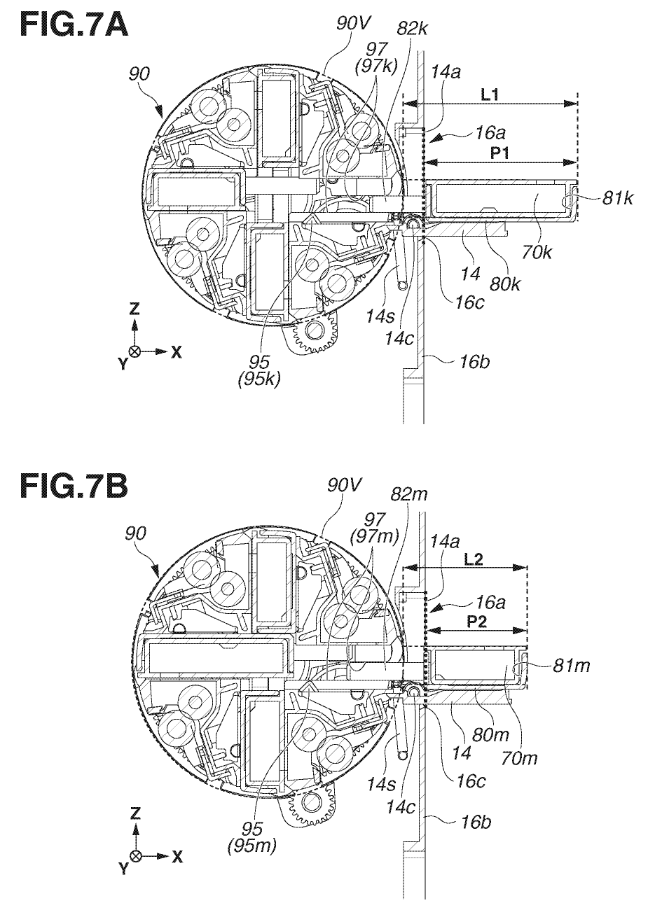

A toner cartridge replacement operation will be described with reference to FIGS. 4A, 6A to 6C, 7A, and 7B. FIGS. 6A to 6C are external views of the apparatus main body 1A. FIGS. 7A and 7B are sectional views of the vicinity of the rotary main body 90 during toner cartridge replacement. FIGS. 7A and 7B are sectional views of the image forming apparatus 1 taken along an imaginary plane perpendicular to the rotation axis 90C of the rotary main body 90.

FIG. 6A illustrates the appearance of the apparatus main body 1A during an image forming operation and in a standby state. During the image forming apparatus refers to a period when the image forming apparatus 1 performs a series of operations including feeding a sheet S, forming an image on the sheet S, and then discharging the sheet S as a product. The standby state refers to a state where the image forming apparatus 1 can start the image forming operation upon receiving an image forming instruction (print instruction) and is waiting for an image formation instruction from the user. As illustrated in FIG. 6A, the door 14 is closed during the image forming operation and in the standby state.

FIG. 6B illustrates the appearance of the apparatus main body 1A during toner cartridge replacement. During toner cartridge replacement, the door 14 is open, and the tray 80 and the toner cartridge 70 are moved to outside the apparatus main body 1A.

The toner cartridge 70 can move relative to the developing frame 53 of the developing unit 50, between the mounted position and the retracted position retracted from the mounted position. With the toner cartridge 70 at the mounted position relative to the developing frame 53, as illustrated in FIG. 3, the discharge opening 71b and the inlet opening 53b are opposed to each other. As illustrated in FIGS. 4A and 4B, the rotary main body 90 is configured to rotate about the rotation axis 90C and assume the developing orientations and the replacement orientations with the toner cartridges 70 at the mounted positions.

The toner cartridge replacement operation will be described. The user initially issues an instruction for the toner cartridge replacement operation to the control unit 100C of the apparatus main body 1A. For example, the instruction for the toner cartridge replacement operation is input via an operation panel (operation unit) disposed on the apparatus main body 1A.

When the control unit 100C receives the instruction for the toner cartridge replacement operation, the rotary main body 90 rotates to and stops at the replacement orientation for the toner cartridge 70 to be replaced (toner cartridge 70 having run out of toner). More specifically, the control unit 100C rotates the rotary main body 90 to the replacement orientation for the toner cartridge specified by the instruction for the toner cartridge replacement operation (in FIG. 4B, the black replacement orientation for replacing the black toner cartridge 70k). In the replacement orientation, the tray 80 supporting the replacement-instructed toner cartridge 70 is opposed to the opening 16a in the frame 16 of the apparatus main body 1A.

For example, the rotary main body 90 of FIG. 4A is in the yellow developing orientation where the yellow developing roller 51y is opposed to the photosensitive drum 2. Here, the black toner cartridge 70k and tray 80k do not need to be opposed to the opening 16a and the door 14. In other words, the toner cartridge 70 and the tray 80 do not need to be opposed to the opening 16a and the door 14 when the rotary main body 90 is in a replacement orientation other than that for the toner cartridge or in a developing orientation. The opening 16a therefore need only be large enough for each toner cartridge 70 to pass through singly. When the rotary main body 90 is rotated clockwise in the diagram by a predetermined angle from the yellow developing orientation, as illustrated in FIG. 4B, the black toner cartridge 70k and tray 80k are opposed to the opening 16a and the door 14.

Here, "the tray 80 is opposed to the opening 16a" means that the tray 80 is positioned to be movable to outside the apparatus main body 1A through the opening 16a. In other words, when the tray 80 is opposed to the opening 16a, the tray 80 and the toner cartridge 70 supported by the tray 80 can protrude out of the apparatus main body 1A by the tray 80 being moved outward in the radial direction of rotation of the rotary main body 90 by the moving mechanism to be described below. In FIG. 4A, none of the trays 80y to 80k is opposed to the opening 16a. In FIG. 4B, only the black tray 80k is opposed to the opening 16a, and the other trays 80y to 80c are not opposed to the opening 16a.

With the rotary main body 90 positioned in the replacement orientation, the motor M2 moves the tray 80 supporting the toner cartridge 70 to be replaced to outside the apparatus main body 1A.

As a result, the toner cartridge 70 to be replaced moves relative to the rotary main body 90 from the mounted position to the retracted position. As illustrated in FIGS. 6B, 6C, 7A, and 7B, the tray 80 and the toner cartridge 70 to be replaced supported by the tray 80 protrude out of the apparatus main body through the opening 16a.

More specifically, the tray 80 can move relative to the rotary main body 90 between an accommodation position and a removal position. The accommodation position refers to a position where the tray 80 is accommodated in the rotary main body 90. The removal position refers to a position where the tray 80 protrudes from the rotary main body 90 and the toner cartridge 70 can be removed from the tray 80 (detachment position, replaceable position). The positions of the trays 80y to 80k in FIGS. 4A and 4B are examples of the accommodation position. The positions of the tray 80 in FIGS. 6B and 6C, the tray 80k in FIG. 7A, and the tray 80m in FIG. 7B are examples of the removal position.

When the tray 80 is at the accommodation position, the toner cartridge 70 attached to the tray 80 is located at the mounted position. When the tray 80 is at the removal position, the toner cartridge 70 attached to the tray 80 is located at the retracted position.

As illustrated in FIGS. 7A and 7B, the rotary main body 90 includes protrusions 95 for holding the trays 80 at the accommodation positions to hold the toner cartridges 70 at the mounted positions. As illustrated in FIG. 8, the trays 80 have recesses 87 to fit the protrusions 95. While FIGS. 7A and 7B illustrate protrusions 95k and 95m corresponding to the trays 80y and 80m and FIG. 8 illustrates recesses 87y and 87m of the trays 80y and 80m, the protrusions 95 and the recesses 87 are provided to correspond to the respective trays 80y to 80k. The protrusions 95 can be biased in the directions of engagement with the recesses 87.

Fitting the protrusions 95 to the recesses 87 of the trays 80 locks the trays 80 to the rotary frame 90f. Even when the rotary main body 90 rotates, the trays 80 thus remain at the accommodation positions, and the toner cartridges 70 are prevented from moving from the mounted positions. When a tray 80 is moved between the accommodation position and the removal position by the moving device to be described below, the corresponding protrusions 95 can be moved by the tray 80 and disengaged from the recesses 87.

In the present embodiment, the door 14 is supported to be rotatable relative to the apparatus main body 1A. As illustrated in FIG. 7A, the door 14 is biased from an open position to a closed position by a spring 14s. The spring 14s is a tension spring, for example, and biases the door 14 to generate counterclockwise moment in FIGS. 7A and 7B about a pivot 14c of the door 14.

The door 14 is brought into an open state (the state of FIG. 6B) by the tray 80 pushing the door 14. This state can be said to be a state where the tray 80 is supported by the door 14. The door 14 supports at least a part of the tray 80 protruding out of the apparatus main body 1A, whereby the toner cartridge 70 can be more stably supported. In other words, when the first toner cartridge (toner cartridge 70k) is at the first retracted position, the opening and closing member (door 14) at the open position supports the first support member (tray 80k). When the second toner cartridge (toner cartridges 70y to 70c) is at the second retracted position, the opening and closing member (door 14) at the open position supports the second support member (trays 80y to 80c).

The door 14 is configured to contact a part of the frame 16 of the apparatus main body 1A (for example, a lower edge 16c of the opening 16a) at the open position and not rotate downward beyond the open position. When the tray 80 is withdrawn from outside to inside the apparatus main body 1A, the door 14 returns to the closed position due to the biasing force of the spring 14s.

The toner cartridge 70 is held by the tray 80 in a detachably attachable manner. As illustrated in FIG. 6C, the user can thus perform an operation of detaching the toner cartridge 70 from the tray 80 and attaching a new toner cartridge 70 (replacement operation). When replacing a plurality of toner cartridges 70, the user can perform the replacement operation by repeating the foregoing operation.

FIGS. 7A and 7B illustrate cross sections of the vicinity of the rotary main body 90 during toner cartridge replacement.

FIG. 7A illustrates a state during replacement of the black toner cartridge 70k. FIG. 7B illustrates a state during replacement of the magenta toner cartridge 70m.

The image forming apparatus 1 includes the moving device 85 (FIG. 8) that moves the toner cartridge 70 from the mounted position to the retraced position. In the present embodiment, the moving device 85 can be said to include the tray 80. The moving device 85k including the tray 80k can be said to be an example of a first moving device including the first support member. The moving device 85m including the tray 80m can be said to be an example of a second moving device including the second support member.

Even with the toner cartridge 70 at the retracted position, the tray 80 remains connected to the rotary main body 90 (supported by the rotary main body 90). To facilitate the operation of removing the toner cartridge 70 from the rotary main body 90, the protruding length of the toner cartridge 70 at the retracted position from the rotary main body 90 can be large. Since the toner cartridge 70 is configured to be detachably attachable to the rotary main body 90 via the tray 80, the toner cartridge 70 can be stably supported by the tray 80 despite its large protruding length from the rotary main body 90.

The moving direction of the toner cartridge 70 when the toner cartridge 70 moves from the mounted position to the retracted position will be referred to as a retracting direction. In the present embodiment, the retracting direction of the toner cartridge 70 intersects the direction of the rotation axis 90C (Y direction). As illustrated in FIGS. 7A and 7B, when viewed in the direction of the rotation axis 90C (Y direction), the retracting direction of the toner cartridge 70 is thus orthogonal to the direction of the rotation axis 90C (Y direction). The retracting direction of the toner cartridge 70 can also be said to be a direction outward in the radial direction of rotation of the rotary main body 90 (direction away from the rotation axis 90C). The moving direction of the toner cartridge 70 when the toner cartridge 70 moves from the retracted position to the mounted position will be referred to as a mounting direction.

As illustrated in FIGS. 7A and 7B, for the user to perform the operation of removing the toner cartridge 70 from the rotary main body 90, at least a part of the toner cartridge 70 can protrude from the rotary main body 90 when the toner cartridge 70 is removed. In the present embodiment, when the toner cartridge 70 is at the retracted position, the entire toner cartridge 70 protrudes from the rotary main body 90.

When the rotary main body 90 rotates about the rotation axis 90C, the rotation path of the rotary main body 90 can be said to match the circumscribed circle of the rotary main body 90 about the rotation axis 90C (an imaginary circle 90V illustrated by a broken line in FIGS. 7A and 7B). When the toner cartridge 70 is at the retracted position, one half or more of the length of the toner cartridge 70 in the retracting direction can be located outside the rotation path of the rotary main body 90. In other words, when viewed in the rotation axis direction of the rotary, with the toner cartridge 70 at the retracted position, one half or more of the entire length of the toner cartridge 70 in the moving direction of the toner cartridge 70 from the mounted position toward the retracted position can be located outside the rotation path of the rotary. This applies to all the toner cartridges 70 including the toner cartridge 70k as an example of a first cartridge and the toner cartridge 70m as an example of a second cartridge. In the present embodiment, as illustrated in FIGS. 7A and 7B, when the toner cartridge 70 is at the retracted position, the entire toner cartridge 70 is located outside the rotation path (imaginary circle 90V) of the rotary main body 90.

Moreover, to facilitate the user gripping the toner cartridge 70, when the toner cartridge 70 is at the retracted position, at least a part of the toner cartridge 70 can be located outside the image forming apparatus 1 (outside the apparatus main body 1A). As employed herein, "outside the apparatus" refers to a space external to the image forming apparatus 1 (external to the apparatus main body 1A) when the image forming apparatus 1 is in use, such as during an image forming operation on sheets S.

In the present embodiment, the exterior surface of the apparatus main body 1A is constituted by the exterior surface of the frame 16. In other words, "outside the apparatus" can be said to be the outside of the frame 16. The state where at least a part of the toner cartridge 70 is located outside the apparatus can therefore be said to be a state where at least a part of the toner cartridge 70 protrudes from the opening 16a in the frame 16 of the apparatus main body 1A to the outside of the frame 16.

In the present embodiment, when the door 14 is at the closed position, the opening 16a in the frame 16 of the apparatus main body 1A is covered by the door 14. An exterior surface 14a of the door 14 at the closed position forms a part of the exterior surface of the apparatus main body 1A. In such a case, "outside the apparatus" refers to the outside of the exterior surface 14a of the door 14 at the closed position. That is, with the position of the exterior surface 14a of the door 14 at the closed position as an exterior position, at least a part of the toner cartridge 70, when the toner cartridge 70 is at the retracted position, is located on the outer side of the apparatus main body 1A relative to the exterior position.

In other words, at least a part of the toner cartridge 70, if the door 14 were at the closed position, would be located in a space external to the apparatus main body 1A. At least a part of the toner cartridge 70 is located downstream of the exterior position in the retracting direction of the toner cartridge 70.

With the side surface 16b where the opening 16a is formed as the front of the apparatus main body 1A, at least a part of the toner cartridge 70 can be said to protrude forward from the front exterior surface of the apparatus main body 1A when the toner cartridge 70 is at the retracted position. In such a case, the user can access the toner cartridge 70 from the front side of the image forming apparatus 1 and easily perform the replacement operation of the toner cartridge 70.

When the toner cartridge 70 is at the retracted position, one half or more of the length of the toner cartridge 70 in the retracting direction can be located outside the apparatus. That is, when viewed in the rotation axis direction of the rotary, with the toner cartridge 70 at the retracted position, one half or more of the entire length of the toner cartridge 70 can be located outside the main body frame in the moving direction of the toner cartridge 70 from the mounted position toward the retracted position. This applies to all the toner cartridges 70 including the toner cartridge 70k as an example of the first cartridge and the toner cartridge 70m as an example of the second cartridge. Moreover, when the toner cartridge 70 is at the retracted position, the entire toner cartridge 70 can be located outside the apparatus. In the present embodiment, the front exterior surface of the apparatus main body 1A is constituted by the exterior surface 14a of the door and the side surface 16b. However, the configuration of the door 14 is not limited thereto. For example, the door 14 may be sized to cover the entire side surface 16b. In such a case, the front exterior surface of the apparatus main body 1A is constituted by the exterior surface 14a of the door 14.

The tray 80 includes a cartridge holding portion 81 (see FIGS. 3 and 6C) for holding the toner cartridge 70. The cartridge holding portion 81 is an attachment portion where the toner cartridge 70 is attached. When the tray 80 is at the removal position, the entire cartridge holding portion 81 can be located outside the rotation path of the rotary main body 90 in the retracting direction. When the tray 80 is at the removal position, one half or more of the length of the cartridge holding portion 81 in the retracting direction can be located outside the apparatus.

As described above, the toner cartridge 70k and the tray 80k are greater in size than the other toner cartridges 70y to 70c and trays 80y to 80c. As illustrated in FIGS. 7A and 7B, in the present embodiment, the amount of movement of the tray 80 during toner cartridge replacement is changed depending on the size of the toner cartridge 70.

Specifically, as illustrated in FIG. 7A, the moving distance of the tray 80k (first support member) moving from the accommodation position (first accommodation position) to the removal position (first removal position) is L1. The moving distance of the tray 80m (second support member) moving from the accommodation position (second accommodation position) to the removal position (second removal position) is L2. While FIG. 7B illustrates a state where the toner cartridge 70m and the tray 80m have moved, the moving distances of the trays 80y and 80c moving from the accommodation position to the removal position are also L2. Here, L1 is greater than L2. In other words, the moving distance of the first support member when the first toner cartridge moves from the first mounted position to the first retracted position can be said to be greater than that of the second support member when the second toner cartridge moves from the second mounted position to the second retracted position.

As illustrated in FIG. 7A, with the tray 80k at the removal position and the toner cartridge 70k at the retracted position, the toner cartridge 70k protrudes outside the apparatus from the exterior surface of the apparatus main body 1A by a distance P1. In the present embodiment, the tray 80k also protrudes outside the apparatus from the exterior surface of the apparatus main body 1A by the distance P1.

As illustrated in FIG. 7B, with the tray 80m at the removal position and the toner cartridge 70m at the retracted position, the toner cartridge 70m protrudes outside the apparatus from the exterior surface of the apparatus main body 1A by a distance P2. In the present embodiment, the tray 80m also protrudes outside the apparatus from the exterior surface of the apparatus main body 1A by the distance P2. The toner cartridges 70y and 70c also protrude outside the apparatus from the exterior surface of the apparatus main body 1A by the distance P2.

The distance P1 is greater than the distance P2. Suppose that the protruding length of the first toner cartridge at the first retracted position from the opening 16a of the apparatus main body 1A is a first length (P1), and the protruding length of the second toner cartridge at the second retracted position from the opening 16a is a second length (P2). In such a case, the first length can be said to be greater than the second length.

In view of strength, the distance P2 by which the toner cartridges 70y to 70c smaller in size than the toner cartridge 70k protrude outside the apparatus at their retracted position can be made smaller than the distance P1 by which the toner cartridge 70k protrudes outside the apparatus at its retracted position. The reasons are as follows. When the toner cartridge 70 is located at the retracted position, at least a part of the toner cartridge 70 protrudes outside the rotation path of the rotary main body 90, or outside the apparatus from the exterior surface of the apparatus main body 1A. Here, the tray 80 is cantilevered by the rotary main body 90 while supporting the weight of the toner cartridge 70. Reducing the distance P2 by which the toner cartridges 70y to 70c protrude outside the apparatus at the retracted position can thus reduce the load acting on the trays 80y to 80c and guide portions 97 of the rotary main body 90 supporting the trays 80y to 80k. Moreover, since the toner cartridges 70y to 70c are smaller in size than the toner cartridge 70k, the workability of the cartridge replacement for the trays 80y to 80c can be maintained even with the distance P2 made smaller than the distance P1.

### Tray Layout Inside Rotary

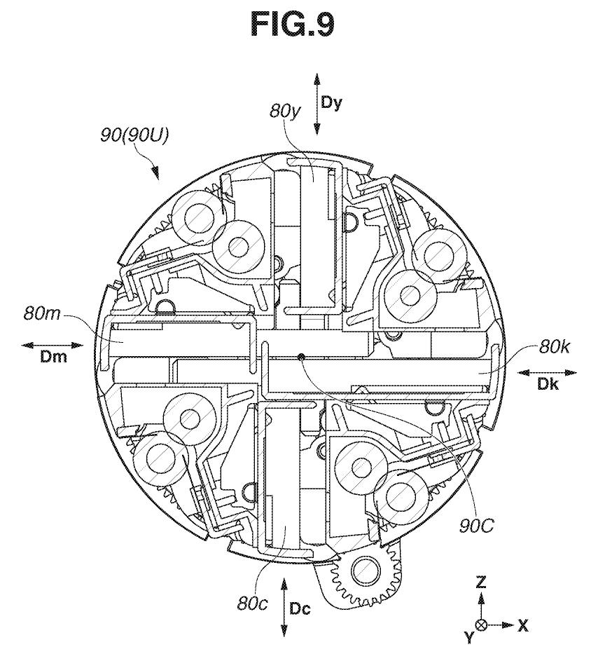

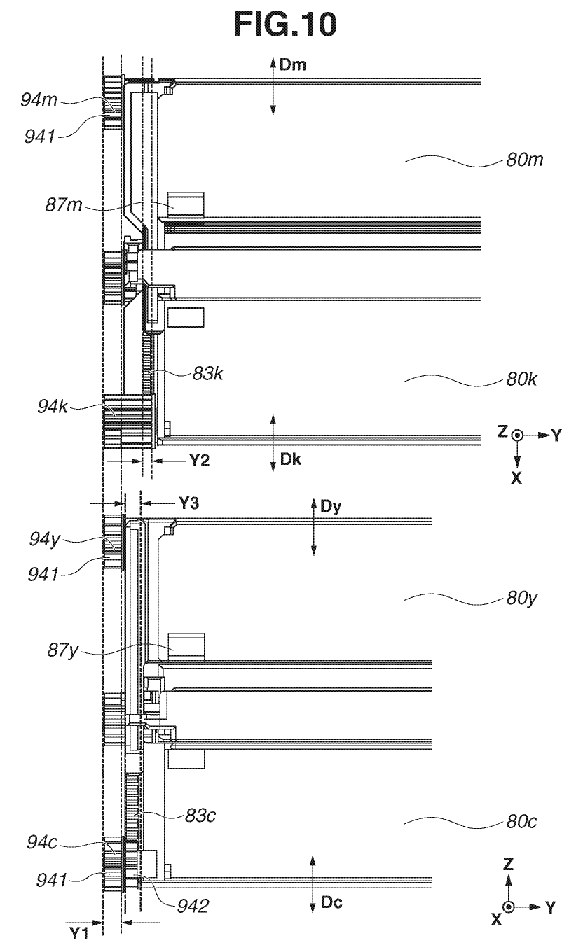

The layout of the trays 80y to 80k inside the rotary main body 90 will be described with reference to FIGS. 8, 9, and 10. FIG. 8 is a perspective view illustrating the layout of the trays 80y to 80k inside the rotary main body 90. FIG. 9 is a sectional view illustrating the layout of the trays 80y to 80k inside the rotary main body 90. FIG. 10 is a diagram illustrating arrangement of members at one end side of the trays 80y to 80k in the Y direction. FIG. 9 illustrates a cross section of the rotary main body 90 taken along an imaginary plane perpendicular to the rotation axis 90C of the rotary main body 90. The upper half of FIG. 10 is a view of the rotary main body 90 and the trays 80m and 80k of FIG. 8 as seen from above (+Z side) in FIG. 8. The lower half of FIG. 10 is a view of the rotary main body 90 and the trays 80c and 80y of FIG. 8 as seen from the right (+X side) in FIG. 8.

As illustrated in FIG. 8, the trays 80y to 80k include the cartridge holding portions 81y to 81k and to-be-guided portions 82y to 82k, respectively.

The toner cartridges 70y to 70k are attached to the cartridge holding portions 81y to 81k, respectively. The cartridge holding portions 81y to 81k accommodate at least a part of the respective toner cartridges 70y to 70k attached thereto.

The to-be-guided portions 82y to 82k are located at both ends of the trays 80y to 80k in the Y direction, with the cartridge holding portions 81y to 81k therebetween. The to-be-guided portions 82y to 82k are each a slender member extending in a direction orthogonal to the rotation axis 90C of the rotary main body 90.

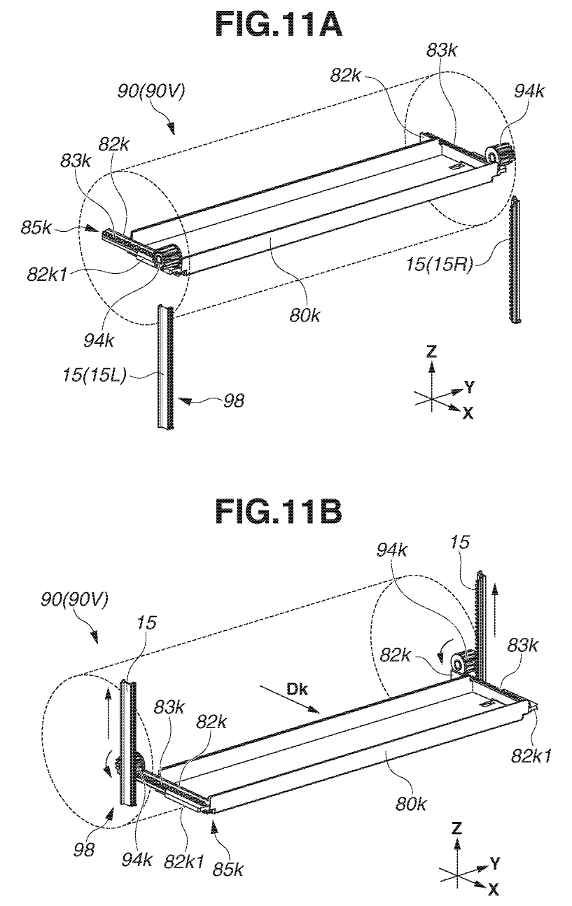

In the present embodiment, reinforcing ribs 82k1 are formed on parts of the to-be-guided portions 82k in the moving direction Dk of the tray 80k, and reinforcing ribs 82m1 are formed on parts of the to-be-guided portions 82m in the moving direction Dm of the tray 80m (see also FIGS. 11A and 11B). The reinforcing ribs 82k1 and 82m1 are rib-shaped protrusions (ridges) that protrude outward in the Y direction from the to-be-guided portions 82k and 82m located at both ends of the trays 80k and 80m in the Y direction and extend long in the moving directions Dk and Dm of the trays 80k and 80m. The reinforcing ribs 82k1 and 82m1 improve the rigidity of the to-be-guided portions 82k and 82m.

In the present embodiment, the reinforcing ribs 82m1 and 82k1 are limited in length to avoid the to-be-guided portions 82y and 82c. If no interference occurs with the to-be-guided portions 82y and 82c, the reinforcing ribs 82m1 and 82k1 may be disposed over the entire lengths of the to-be-guided portions 82m and 82k. Reinforcing ribs may be added to the to-be-guided portions 82y and 82c. If the to-be-guided portions 82m and 82k have sufficient rigidity, the reinforcing ribs 82m1 and 82k1 may be omitted.

Rack portions 83y to 83k (rack gears) are formed on the to-be-guided portions 82y to 82k. Pinion gears 94y to 94k are rotatably held inside the rotary main body 90. The pinion gears 94y to 94k mesh with the rack portions 83y to 83k, respectively, in a manner capable of drive transmission.

The rack portions 83y to 83k and the pinion gears 94y to 94k are parts of the moving devices 85y to 85k configured to move the toner cartridges 70y to 70k from the mounted positions to the retracted positions. The rack portions 83y to 83k and the pinion gears 94y to 94k can be said to be parts of to-be-driven devices that are driven by the driving device 98 of the apparatus main body 1A.

The pinion gears 94y to 94k can be said to be rotating bodies (rotating members) that rotate to move the trays 80y to 80k relative to the rotary main body 90.

The pinion gears 94y to 94k and the rack portions 83y to 83k function as to-be-driven units for the moving devices 85y to 85k of the rotary main body 90 to receive driving force from the driving device 98 of the apparatus main body 1A. The pinion gear 94k and the rack portion 83k are an example of a first pinion gear and a first rack gear that constitute at least a part of a first to-be-driven unit included in the first moving device. The pinion gear 94m and the rack portion 83m are an example of a second pinion gear and a second rack gear that constitute at least a part of a second to-be-driven unit included in the second moving device.

The rotary main body 90 includes the guide portions 97 (see FIGS. 7A and 7B) that engage with the respective to-be-guided portions 82y to 82k. FIG. 7A illustrates guide portions 97 (97k) that engage with a to-be-guided portion 82k of the tray 80k. FIG. 7B illustrates guide portions 97 (97m) that engage with a to-be-guided portion 82m of the tray 80m. The rotary main body 90 includes similar guide portions that engage with the to-be-guided portions 82y and 82c of the trays 80y and 80c. While FIGS. 7A and 7B illustrate the guide portions 97 disposed on one side (+Y side) of the rotary main body 90 in the Y direction, similar guide portions 97 are also disposed on the other side (-Y side) of the rotary main body 90 in the Y direction.

When the tray 80 moves between the accommodation position and the removal position, the guide portions 97 remain engaged with the to-be-guided portions 82 and guide the tray 80 in the moving direction in at least a part of the movable range. In the present embodiment, the guide portions 97k remain engaged with the to-be-guided portions 82k over the entire moving range of the tray 80k between the accommodation position and the removal position. In the present embodiment, the guide portions 97m remain engaged with the to-be-guided portions 82m over the entire moving range of the tray 80m between the accommodation position and the removal position.

As illustrated in FIGS. 8 and 9, the four trays 80y to 80k are laid out inside the rotary main body 90 to overlap one another as will be specifically described below.

When the pinion gears 94y to 94k rotate, the rack portions 83y to 83k and the trays 80y to 80k move relative to the rotary main body 90. As illustrated in FIG. 9, the four trays 80y to 80k are arranged such that their moving directions relative to the rotary main body 90 are rotated by 90º from one another. The trays 80y and 80c, and the trays 80m and 80k, are thus held slidably in substantially the same direction (parallel directions). Such moving directions of the trays 80y to 80k during slide movement are regulated by the foregoing engagement of the to-be-guided portions 82y to 82k and the guide portions 97.

The trays 80y to 80k move to outside the apparatus through the opening 16a. When each of the trays 80y to 80k moves to outside the apparatus through the opening 16a, the moving direction of each tray is substantially the same (parallel).

As illustrated in FIG. 9, in the moving direction Dk of the tray 80k, the range where the tray 80k is located is laid out to overlap the range where the tray 80y is located and the range where the tray 80c is located. Moreover, in the moving direction Dk of the tray 80k, the range where the tray 80k is located overlaps the rotation axis 90C of the rotary main body 90. That is, the toner cartridge 70k held by the cartridge holding portion 81k of the tray 80k can be said to overlap the rotation axis 90C of the rotary main body 90 (FIG. 4B).

By contrast, in the moving direction Dm of the tray 80m, the range where the tray 80m is located is offset to not overlap the range where the tray 80y is located or the range where the tray 80c is located. In the moving direction Dy of the tray 80y, the range where the tray 80y is located is offset to not overlap the range where the tray 80m is located or the range where the tray 80k is located. Similarly, in the moving direction Dc of the tray 80c, the range where the tray 80c is located is offset to not overlap the range where the tray 80m is located or the range where the tray 80k is located.

The positional relationship between the trays 80 can also be expressed as follows. When viewed in the moving direction Dy of the tray 80y, the tray 80y and the tray 80k overlap, and the tray 80y and the tray 80m do not overlap. When viewed in the moving direction Dm of the tray 80m, the tray 80m and the tray 80k overlap, and the tray 80m and the trays 80y and 80c do not overlap. When viewed in the moving direction Dc of the tray 80c, the tray 80c and the tray 80k overlap, and the tray 80c and the tray 80m do not overlap.

As employed herein, two elements (members, components, units, etc.) overlapping when viewed in a specific direction means that when the elements are perpendicularly projected upon an imaginary plane perpendicular to that direction, the projected area of one element and the projected area of the other overlap at least in part.

As illustrated in FIGS. 8 and 10, in the direction of the rotation axis 90C (Y direction), the range where the rack portion 83m and the to-be-guided portion 82m are located and the range where the rack portion 83k and the to-be-guided portion 82k are located overlap at least in part. That is, in the present embodiment, the range where the first rack gear (rack portion 83k) is located and the range where the second rack gear (rack portion 83m) is located can be said to at least partially overlap in the rotation axis direction of the rotary (Y direction). The rack portions 83m and 83k and the to-be-guided portions 82m and 82k can thus be laid out in a reduced space in the Y direction compared to a layout where the rack portion 83m and the to-b-guided portion 82m do not overlap the rack portion 83k and the to-be-guided portion 82k.

In the direction of the rotation axis 90C (Y direction), the range where the rack portion 83y and the to-be-guided portion 82y are located and the range where the rack portion 83c and the to-be-guided portion 82c are located overlap at least in part. That is, in the present embodiment, the range where the third rack gear (rack portion 83y) is located and the range where the fourth rack gear (rack portion 83c) is located at least partially overlap in the rotation axis direction of the rotary (Y direction). The rack portions 83y and 83c and the to-be-guided portions 82y and 82c can thus be laid out in a reduced space in the Y direction compared to a layout where the rack portion 83y and the to-be-guided portion 82y do not overlap the rack portion 83c and the to-be-guided portion 82c.

The meshing positions between the rack portions 83 and the pinion gears 94 will now be described with reference to FIG. 10. The upper half of FIG. 10 illustrates the meshing position between the rack portion 83k and the pinion gear 94k. The lower half of FIG. 10 illustrates the meshing position between the rack portion 83c and the pinion gear 94c.

In the direction of the rotation axis 90C of the rotary main body 90 (Y direction), the driving force transmitted from the motor M2 (FIG. 2) serving as a drive source via the transmission device to be described below is conveyed to the pinion gears 94y to 94k over a region Y1 in the diagram. In the Y direction, the pinion gear 94k meshes with the rack portion 83k in a manner capable of drive transmission over a region Y2 in the diagram. In the Y direction, the pinion gear 94c meshes with the rack portion 83c in a manner capable of drive transmission over a region Y3 in the diagram. Like the rack portion 83k, the rack portion 83m meshes with the pinion gear 94m (FIG. 8) in a manner capable of drive transmission over the region Y2. Like the rack portion 83c, the rack portion 83y meshes with the pinion gear 94y (FIG. 8) in a manner capable of drive transmission over the region Y3.

The regions Y2 and Y3 are located at different positions in the Y direction (offset in the Y direction). The region Y1 is located at a different position from both the regions Y2 and Y3 in the Y direction. In other words, the region Y1 is offset from the regions Y2 and Y3 in the Y direction.

With the toner cartridges 70y and 70c at their mounted positions, the range where the rack portion 83y is located and the range where the rack portion 83c is located at least partially overlap in the moving direction of the rack portion 83y (the moving direction Dy of the tray 80y). In the present embodiment, since the moving directions Dy and Dc of the trays 80y and 80c are substantially the same (parallel), the range where the rack portion 83y is located and the range where the rack portion 83c is located also at least partially overlap in the moving direction Dc of the tray 80c. With the toner cartridges 70y and 70c at their mounted positions, the tooth flanks of the rack portions 83y and 83c are thus opposed to each other in a direction (lateral direction in FIG. 8) orthogonal to the moving directions Dy and Dc of the rack portions 83y and 83c.

Moreover, with the toner cartridges 70m and 70k at their mounted positions, the range where the rack portion 83m is located and the range where the rack portion 83k is located at least partially overlap in the moving direction of the rack portion 83m (the moving direction Dm of the tray 80m). In the present embodiment, since the moving directions Dm and Dk of the trays 80m and 80k are substantially the same (parallel), the range where the rack portion 83m is located and the range where the rack portion 83k is located also at least partially overlap in the moving direction Dk of the tray 80k. With the toner cartridges 70m and 70k at their mounted positions, the tooth flanks of the rack portions 83m and 83k are thus opposed to each other in a direction (vertical direction in FIG. 8) orthogonal to the moving directions Dm and Dk of the rack portions 83m and 83k.

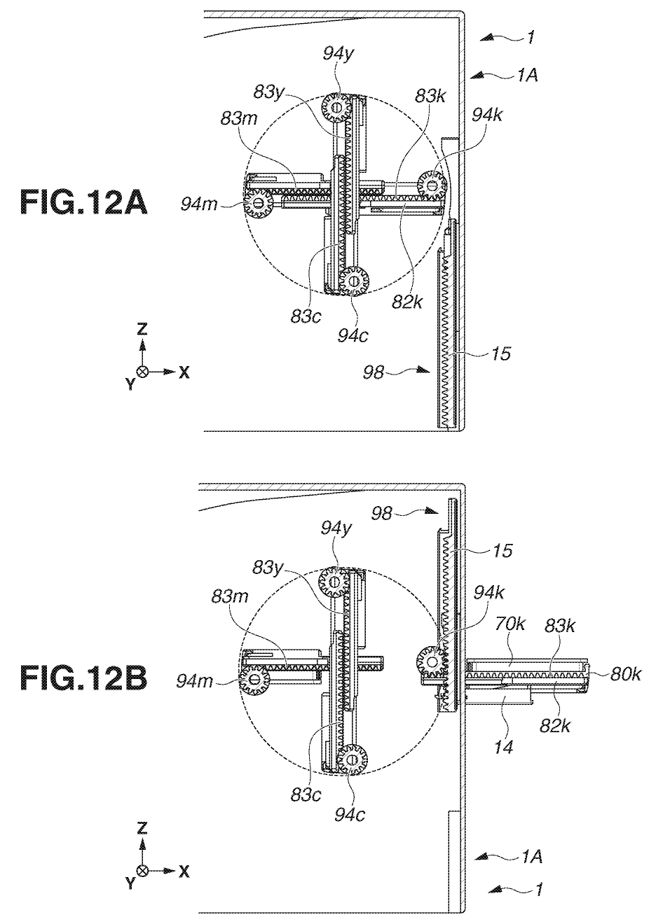

As also illustrated in FIG. 12A to be described below, when viewed in the direction of the rotation axis 90C (Y direction), the rack portion 83y overlaps the rack portions 83m and 83k. When viewed in the direction of the rotation axis 90C (Y direction), the rack portion 83m overlaps the rack portion 83y and 83c. When viewed in the direction of the rotation axis 90C (Y direction), the rack portion 83c overlaps the rack portions 83m and 83k. When viewed in the direction of the rotation axis 90C (Y direction), the rack portion 83k overlaps the rack portions 83y and 83c. In other words, the range where the first rack gear (rack portion 83k) is located and the range where the second rack gear (rack portion 83y) is located can be said to not overlap in the rotation axis direction of the rotary (Y direction). Moreover, when viewed in the rotation axis direction of the rotary (Y direction), with the first toner cartridge 70k at the first mounted position and the second toner cartridge 70y at the second mounted position, the first rack gear (rack portion 83k) and the second rack gear (rack portion 83y) can be said to overlap.

Since the positions where the rack portions 83k and 83m are located and the positions where the rack portions 83y and 83c are located are different in the Y direction, the rack portions 83y and 83c and the rack portions 83m and 83k can be located to overlap when viewed in the Y direction.

This enables a space-saving layout of the four trays inside the rotary main body 90, whereby the rotary main body 90 can be reduced in size in the radial direction of rotation. More specifically, if the rack portions 83 are arranged to not overlap when viewed in the Y direction while the moving distances of the respective trays 80y to 80k are maintained equivalent to those in the present embodiment, the layout area needed for the four rack portions increases as viewed in the Y direction. Compared to such a configuration, laying out the plurality of rack portions 83 at positions offset in the Y direction so that the rack portions 83 overlap when viewed in the Y direction can reduce the layout area of the rack portions 83 as viewed in the Y direction.

In the present embodiment, the four rack portions 83y to 83k are disposed at positions offset in the Y direction in two sets of two. More specifically, in the rotation axis direction of the rotary main body 90 (Y direction), the ranges where the first and second rack gears are located can be said to overlap, and the ranges where the third and fourth rack gears are located can be said to overlap. Furthermore, in the Y direction, the ranges where the first and second rack gears are located can be said to be arranged to not overlap the ranges where the third and fourth rack gears are located. This can reduce the rotary main body 90 in size in the Y direction compared to when the four rack portions 83y and 83k are all located at different positions in the Y direction.

### Tray Movement Configuration

A configuration related to the movement of the trays 80y to 80k disposed in the rotary main body 90 will be described with reference to FIGS. 11A, 11B, 12A, and 12B. FIGS. 11A and 11B are perspective views illustrating a configuration related to the movement of the tray 80k. FIGS. 12A and 12B are sectional views illustrating the configuration related to the movement of the tray 80k.

In the present embodiment, the trays 80y to 80k are all driven by the driving force of the motor M2 being transmitted to their respective pinion gears 94y to 94k by the driving racks 15L and 15R serving as the transmission device. Here, the configuration for moving the tray 80k relative to the rotary main body 90 will be described. The configurations for moving the trays 80y to 80c relative to the rotary main body 90 are substantially the same as that for moving the tray 80k, and a description thereof will thus be omitted.

FIG. 11A illustrates a state where the tray 80k is located inside the rotary main body 90 (i.e., a state where the toner cartridge 70k is mounted in the developing unit 50k). In other words, the FIG. 11A illustrates a state where the tray 80k is at the accommodation position, which corresponds to the state where the toner cartridge 70k is at the mounted position relative to the developing frame 53k (FIG. 4A). FIG. 11B illustrates a state where the tray 80k is slid out of the rotary main body 90. In other words, FIG. 11B illustrates a state where the tray 80k is at the removal position, which corresponds to the state where the toner cartridge 70k is at the retracted position relative to the developing frame 53k (FIG. 4B).

The apparatus main body 1A of the present embodiment includes the driving racks 15L and 15R serving as drive gears for driving the pinion gears 94. Each driving rack 15 is driven by the motor M2 via the not-illustrated drive transmission mechanism.

As described above, two rack portions 83k are disposed at the respective ends of the tray 80k in the Y direction. Two pinion gears 94k and two driving racks 15L and 15R are located at positions corresponding to the rack portions 83k at the respective ends. That is, the apparatus main body 1A of the present embodiment includes the driving racks 15L and 15R serving as a first drive gear and a second drive gear. The driving rack 15L can be said to be an example of the first drive gear, and the driving rack 15R an example of the second drive gear.

Such number is used merely for the convenience of description and can in principle be interchanged. If no distinction is needed, the driving racks 15L and 15R will be referred to as "driving racks 15".

The rack portions 83 according to the present embodiment are configured as rack gear pairs, and the pinion gears 94 according to the present embodiment are configured as pinion gear pairs. In the present embodiment, the rack gears of each rack gear pair and the pinion gears of each pinion gear pair are disposed on one end side and the other end side of the support member (tray 80) in the Y direction, respectively, but may be disposed at other positions. The rack portions 83k and the pinion gears 94k of the moving device 85k corresponding to the tray 80k can be said to be a first rack gear pair and a first pinion gear pair, respectively.

The rack portions 83y to 83c and the pinion gears 94y to 94c of the moving devices 85y to 85c corresponding to the other trays 80y to 80c can be said to be examples of a second rack gear pair and a second pinion gear pair, respectively.

One of the rack gear pair meshes with one of the pinion gear pair, and the other of the rack gear pair meshes with the other of the pinion gear pair. At least one of the pinion gear pair is driven by the driving rack 15L serving as a first driving rack. In the present embodiment, both pinion gears of the pinion gear pair are simultaneously driven by the driving racks 15L and 15R serving as the first driving rack and a second driving rack. This suppresses rotation of the tray 80 and enables stable movement of the toner cartridge 70.

However, the tray 80 may be configured to include one rack portion 83 and be moved by one driving rack 15 via one pinion gear 94.

The tray 80k is held slidably relative to the rotary main body 90 in a direction parallel to the to-be-guided portions 82k (i.e., the moving direction Dk). The driving racks 15 are held slidably relative to the apparatus main body 1A in a direction intersecting the moving direction Dk of the tray 80k. The driving racks 15 are configured to slide (reciprocate) relative to the apparatus main body 1A in a first direction (in the present embodiment, vertically upward) and a second direction opposite to the first direction (in the present embodiment, vertically downward). In other words, the moving direction of the driving racks 15 in the present embodiment is a direction intersecting (desirably orthogonal to) both the moving direction Dk of the tray 80k and the direction of the rotation axis 90C of the rotary main body 90 (Y direction).

A tray moving operation for sliding the tray 80k between the accommodation position and the removal position will be described with reference to FIGS. 11A and 11B. The tray moving operation of the tray 80k is performed by the motor M2 (FIG. 2), the not-illustrated drive transmission mechanism, the driving racks 15, the minion gears 94k, and the rack portions 83k.

The tray moving operation when the toner cartridge 70k is removed from the rotary main body 90 (tray pull-out operation) will initially be described. Before the tray pull-out operation is started, the driving racks 15 are located below the position where the driving racks 15 mesh with the pinion gears 94k (FIG. 11A). As described above, during the replacement operation of the toner cartridge 70k, the rotary main body 90 assumes the replacement orientation for the toner cartridge 70k (FIG. 4B).

Once the tray pull-in operation is started, the driving racks 15 are slid upward relative to the apparatus main body 1A by the driving force of the motor M2. In the moving process, the driving racks 15 come into mesh with the pinion gears 94k, and the pinion gears 94k are driven to rotate.

As illustrated in FIG. 11B, the rotational driving of the pinion gears 94k in the direction of the arrows in the diagram inputs driving force to the rack portions 83k in mesh with the pinion gears 94k. The tray 80k is thereby pushed to outside the apparatus, and moves relative to the rotary main body 90 from the accommodation position to the removal position. The moving direction of the tray 80k here is guided to the predetermined moving direction Dk by the engagement of the to-be-guided portions 82k with the guide portions 97k (FIG. 7A) of the rotary main body 90. As a result of the movement of the tray 80k from the accommodation position to the removal position, the toner cartridge 70k is moved relative to the developing unit 50k from the mounted position to the retracted position.

With the tray 80k at the removal position and the toner cartridge 70k at the retracted position, the user can detach and attach the toner cartridge 70k from/to the tray 80k.

The tray moving operation when the toner cartridge 70 is attached to the rotary main body 90 (tray pull-in operation, tray insertion operation) is performed in a process reverse to the tray pull-in operation. For example, the tray pull-in operation is started by the user operating a predetermined operation unit. Once the tray pull-in operation is started, the driving racks 15 are slid downward relative to the apparatus main body 1A by the driving force of the motor M2. The direction of rotation of the motor M2 in the tray pull-in operation is reverse to that in the tray pull-out operation.

The rotational driving of the pinion gears 94k in the direction opposite to the arrows in FIG. 11B inputs driving force to the rack portion 83k in mesh with the pinion gears 94k. The tray 80k is thereby pulled into the image forming apparatus 1, and moves relative to the rotary main body 90 from the removal position to the accommodation position.

The moving direction of the tray 80k is guided to the moving direction Dk (direction opposite to the arrows in FIG. 11B) by the engagement of the to-be-guided portions 82k with the guide portions 97k (FIG. 7A) of the rotary main body 90. As a result of the movement of the tray 80k from the removal position to the accommodation position, the toner cartridge 70k moves from the retracted position to the mounted position relative to the developing unit 50k.

While the movement of the black tray 80k and toner cartridge 70k has been described above, the other trays 80y to 80c and toner cartridges 70y to 70c are also moved using similar mechanisms. That is, the driving racks 15 transmit driving force to the pinion gears 94y to 94c in the replacement orientation for the respective toner cartridges.

The motor M2 included in the apparatus main body 1A and the transmission device including the driving racks 15 (15L and 15R) and the drive transmission mechanism constitute the driving device 98 for driving the moving devices 85 included in the rotary main body 90.

As described above, in the present embodiment, the rotary main body 90 includes the plurality of moving devices 85k to 85y corresponding to the plurality of toner cartridges 70k to 70y. The driving device 98 of the apparatus main body 1A is a common driving device that drives the plurality of moving devices 85k to 85y (plurality of to-be-driven devices) of the rotary main body 90.

In the present embodiment, the driving target of the driving device 98 is switched by the rotation of the rotary main body 90. In other words, the driving device 98 according to the present embodiment includes the driving racks 15 serving as transmission members for transmitting the driving force of the drive source. The driving device 98 can assume a state where the transmission members engage with first to-be-driven portions (pinion gears 94k) in a manner capable of drive transmission and a state where the transmission members engage with second to-be-driven portions (pinion gears 94m) in a manner capable of drive transmission. The driving device 98 can also assume a state where the transmission members are disengaged from the first and second to-be-driven portions.

As described above, the pinion gears 94y to 94k are held by the rotary main body 90. The meshing between the pinion gears 94y to 94k and the driving racks 15 can thus be disengaged when the rotary main body 90 rotates.

FIG. 12A illustrates a state where the tray 80k is located inside the rotary main body 90 (located at the accommodation position). FIG. 12B illustrates a state where the tray 80k is moved out of the rotary main body 90 (moved to the removal position).

As illustrated in FIG. 12A, when the tray 80k is located inside the rotary main body 90, the driving racks 15 lie in the lower part of the apparatus main body 1A. Here, the driving racks 15 are withdrawn from the pinion gears 94k. The rotary main body 90 can thus be rotated without interference from the driving racks 15. More specifically, the driving racks 15 can be withdrawn out of the rotation path of the rotary main body 90 illustrated by the dotted line in FIGS. 12A and 12B.

As described above, by driving the motor M2 to rotate in the forward and reverse directions, the tray 80 attached to the rotary main body 90 can be moved relative to the rotary main body 90 from the accommodation position to the removal position and from the removal position to the accommodation position. In other words, the driving device 98 according to the present embodiment can not only drive each moving device 85 of the rotary such that the toner cartridge 70 moves from the mounted position to the retracted position, but also drive each moving device 85 such that the toner cartridge 70 moves from the retracted position to the mounted position.

As described above, in the present embodiment, the amount of movement of the tray 80 during toner cartridge replacement is changed depending on the size of the toner cartridge 70. Specifically, as illustrated in FIGS. 7A and 7B, the moving distance L1 when the black tray 80k moves from the accommodation position to the removal position is greater than the moving distance L2 when the other trays 80y to 80c move from the accommodation position to the removal position.

In the present embodiment, when the toner cartridges 70y to 70k are moved from their mounted position to their retracted position, the value of the speed of the rack portions 83k divided by the speed of the driving racks 15 is greater than the value of the speed of the rack portions 83y to 83c divided by the speed of the driving racks 15.

For example, as illustrated in FIG. 10, the pinion gear 94y is configured as a stepped gear such that a small-diameter gear 942 to mesh with the rack portion 83y has a pitch circle radius smaller than that of a large-diameter gear 941 to mesh with the driving rack 15. The pinon gears 94m and 94c are also configured as similar stepped gears. On the other hand, the pinion gear 94k has the same pitch circle radius in the portion that meshes with the drive rack 15 and in the portion that meshes with the rack portion 83k. The pitch circle radius of the pinion gear 94k here can be the same as that of the large-diameter gears 941 of the pinion gears 94y to 94c. Such a configuration can increase the moving distance of the rack portion 83k compared to that of the other rack portions 83y to 83c, given the same moving distance of the driving rack 15. In other words, the moving distance L1 when the black tray 80k moves from the accommodation position to the removal position can be made greater than the moving distance L2 when the other trays 80y to 80c move from the accommodation position to the removal position.

Since the pinion gears 94y to 94c are configured as stepped gears, the moving distance L1 of the tray 80k can be made greater than the moving distance L2 of the other trays 80y to 80c even with the configuration that the pinion gears 94y to 94kreceive the driving force from the same driving rack 15.

Instead of (or in combination with) configuring the pinion gears 94y to 94c as stepped gears, the pinion gear 94k may also be configured as a stepped gear. In such a case, the portion of the pinion gear 94k to mesh with the driving rack 15 may be configured as a small-diameter gear, and the portion of the pinion gear 94k to mesh with the rack portion 83k as a large-diameter gear with a pitch circle radius greater than that of the small-diameter gear. Note that the stepped gears are an example of a reduction mechanism, and may be replaced with known reduction mechanisms that make the amount of movement of an output-side (tray 80-side) member smaller than that of an input-side (drive source-side) member.

Alternatively, the amount of movement of the driving rack 15 in moving the toner cartridge 70k from the mounted position to the retracted position may be made greater than the amount of movement of the driving rack 15 in moving the toner cartridges 70y to 70c from the mounted position to the retracted position.

By the way, the shorter the distance by which the toner cartridge 70 moves from the mounted position to the retracted position, the shorter the moving time of the toner cartridge 70 and the shorter the time for the user to wait for the movement of the toner cartridge 70 can be made. The foregoing configuration that the amount of movement of the driving rack 15 for the toner cartridge 70k is greater than the amount of movement of the driving rack 15 for the toner cartridges 70y to 70c can reduce the time for the user to wait for the movement of the toner cartridges 70y to 70c.

Using such a configuration, the moving distance L1 can be made greater than the moving distance L2. These configurations may be used in combination.

While the to-be-driven portion is described to include the pinion gear 94 that meshes with both the driving rack 15 and the rack portion 83, the to-be-driven portion may include a gear that meshes with the driving rack 15 and a gear that meshes with the rack portion 83.

The configuration of the moving device 85 for moving the tray 80 is not limited to a rack-and-pinion configuration. For example, the member corresponding to the pinion gear 94 may be replaced with a roller that is driven to rotate by the motor M2, and the tray 80 may be moved by friction between the roller and the tray 80.

In the case of using the roller driven to rotate by the motor M2, the roller may be brought into contact with the toner cartridge 70. In such a case, the toner cartridges 70y to 70k may be configured to be directly attachable to and detachable from the rotary main body 90 without the intermediary of the trays 80y to 80k. Here, the moving device 85 is constituted by the roller. The rotary assembly 90A can be said to include the rotary main body 90 and the toner cartridges 70y to 70k.

As described above, the toner cartridges 70y to 70k are mounted in the developing units 50y to 50k, respectively. In the present embodiment, the toner cartridges 70y to 70k have a common configuration except for the color of the toner accommodated therein and the shape of the toner frame 71. The developing units 50y to 50k have a common configuration except for the color of the toner accommodated therein.

With any one of the developing units 50y to 50k as the first developing unit, the developing roller 51 of the first developing unit is an example of the first developing roller, and the developing frame 53 of the first developing unit is an example of a first developing frame. The developing-side accommodation portion (supply chamber) 53a of the first developing unit is an example of a first developing-side accommodation portion (first supply chamber), and the inlet opening 53b of the first developing unit is an example of a first inlet opening. With any one of the developing units 50y to 50k as the second developing unit, the developing roller 51 of the second developing unit is an example of the second developing roller, and the developing frame 53 of the second developing unit is an example of a second developing frame. The developing-side accommodation portion (supply chamber) 53a of the second developing unit is an example of a second developing-side accommodation portion (second supply chamber), and the inlet opening 53b of the second developing unit is an example of a second inlet opening.

With the toner cartridge 70 mounted in the first developing unit as the first toner cartridge, the toner frame 71 of the first toner cartridge is an example of a first toner frame, and the toner accommodation chamber 71a of the first toner cartridge is an example of a first accommodation chamber. The discharge opening 71b of the first toner cartridge is an example of a first discharge opening. The mounted position of the first toner cartridge is an example of the first mounted position, and the retracted position of the first toner cartridge is an example of the first retracted position.

With the toner cartridge 70 mounted in the second developing unit as the second toner cartridge, the toner frame 71 of the second toner cartridge is an example of a second toner frame, and the toner accommodation chamber 71a of the second toner cartridge is an example of a second accommodation chamber. The discharge opening 71b of the second toner cartridge is an example of a second discharge opening. The mounted position of the second toner cartridge is an example of the second mounted position, and the retracted position of the second toner cartridge is an example of the second retracted position.

### Configuration of Toner Cartridge

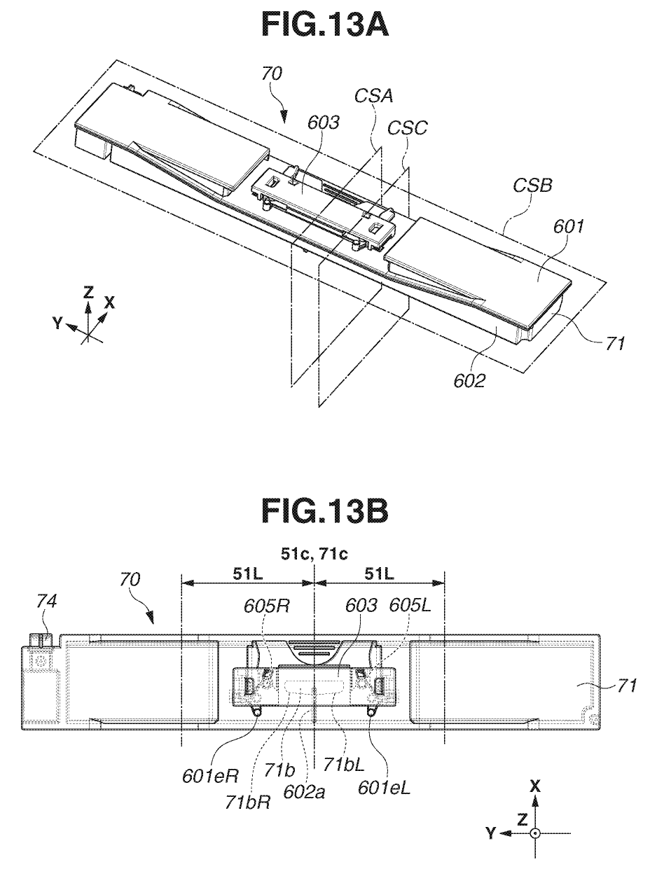

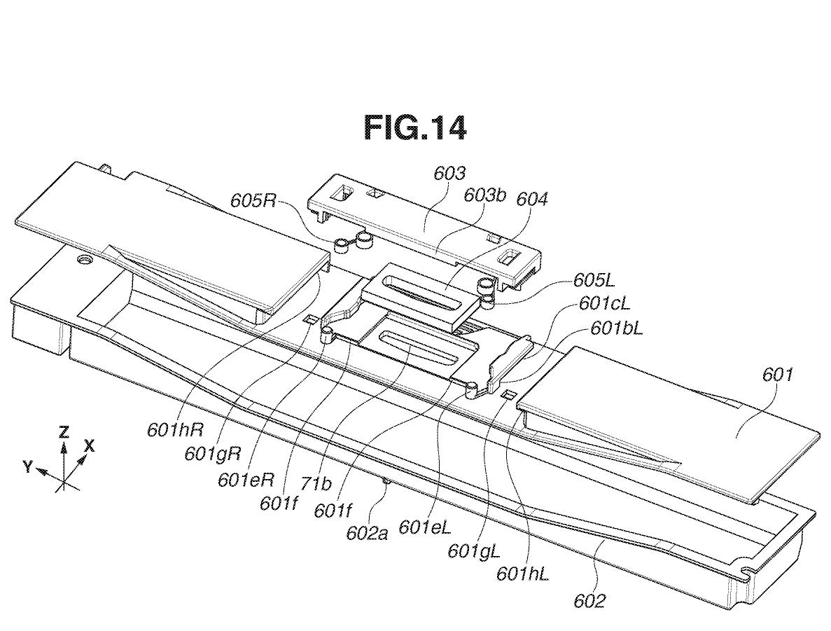

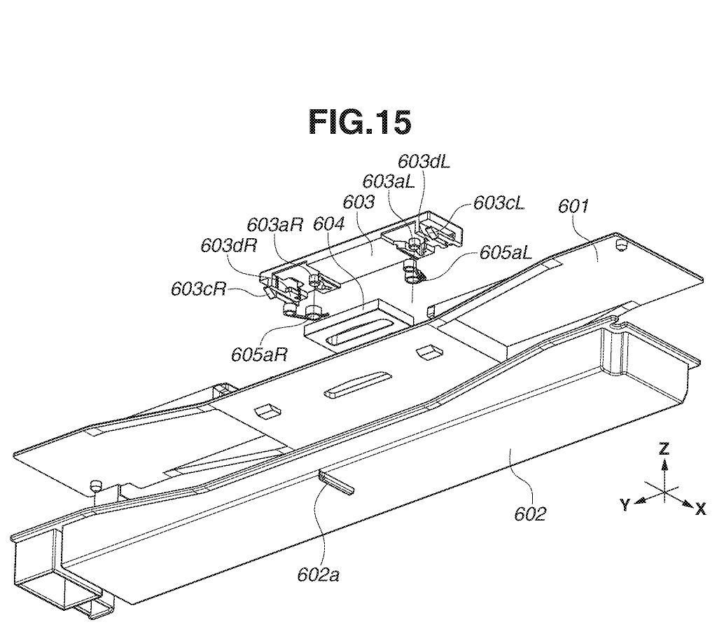

A configuration of the toner cartridge 70 will be described with reference to FIGS. 13A to 18. FIGS. 13A and 13B are explanatory diagrams of the toner cartridge 70. Specifically, FIG. 13A is a perspective view of the toner cartridge 70. FIG. 13B is a top view of the toner cartridge 70 as seen in the Z direction. FIGS. 14 and 15 are exploded perspective views of the toner cartridge 70.

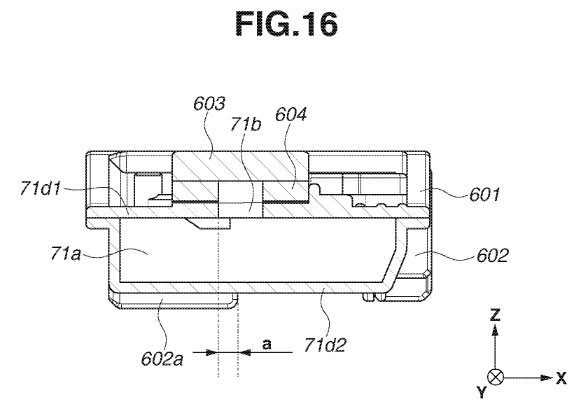

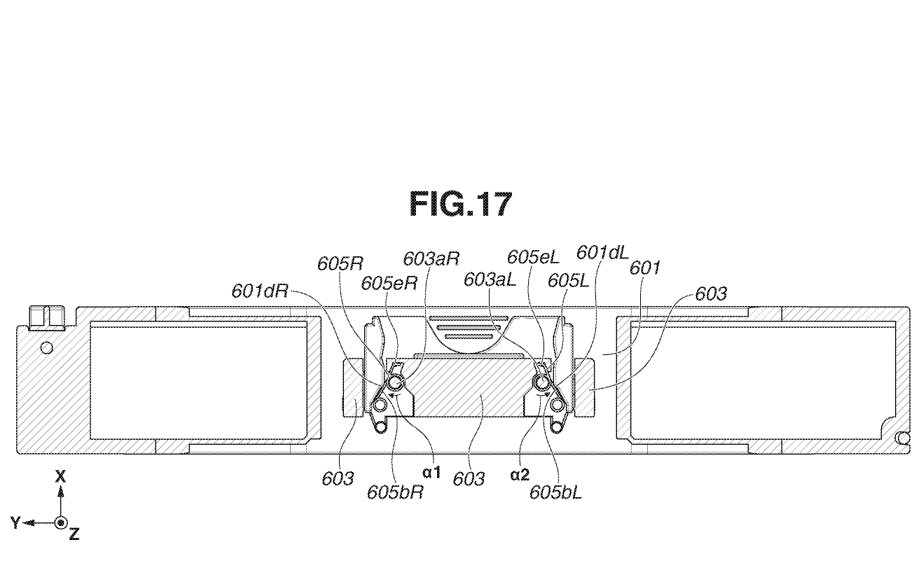

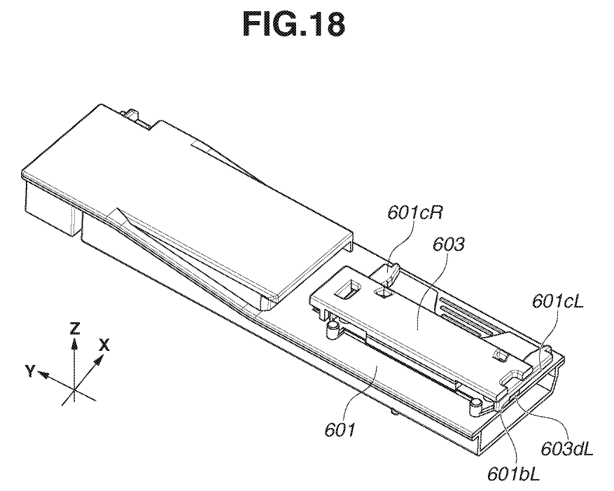

FIGS. 16, 17, and 18, are sectional views of the toner cartridge 70. Specifically, FIG. 16 is a sectional view when the toner cartridge 70 of FIG. 13A is sectioned along a cross section CSA. FIG. 17 is a sectional view when the toner cartridge 70 of FIG. 13A is sectioned along a cross section CSB. FIG. 18 is a sectional view when the toner cartridge 70 of FIG. 13A is sectioned along a cross section CSC.

The toner cartridge 70 includes a toner lid 601, a toner container 602, a toner shutter 603, a toner seal 604, and toner springs 605L and 605R. The toner springs 605L and 605R are an example of a first spring and a second spring. The discharge opening 71b and a to-be-positioned portion 602a to be described below are located between the toner springs 605L and 605R in the Y direction. The toner lid 601 is shaped such that both end portions protrude in the Z direction from a central portion where the discharge opening 71b is located. The cross-sectional area of the toner accommodation portion 71a is larger at both ends in the Y direction than at the center in the Y direction.

The toner frame 71 includes the toner lid 601 and the toner container 602. The toner lid 601 and the toner container 602 are fixed to each other by welding or adhesive bonding, whereby the toner accommodation portion (toner accommodation chamber, accommodation chamber) 71a for accommodating toner is formed. The toner lid 601 has the discharge opening 71b communicating with the toner accommodation portion 71a.

With the toner cartridge 70 detached from the developing unit 50, the toner shutter 603 is closed. In other words, the toner shutter 603 is located at a closed position. The toner shutter 603 at the closed position covers the discharge opening 71b. When the toner shutter 603 is located at an open position, the discharge opening 71b is exposed to allow toner discharge from the discharge opening 71b. As will be described below, the toner shutter 603 is configured to translate between the open position and the closed position.

The toner seal 604 is fixed to the toner lid 601 by adhesive bonding or using a tape with an adhesive layer. The toner seal 604 has an opening, and the toner discharged from the discharge opening 71b passes through the opening in the toner seal 604. The toner seal 604 is compressed between the toner shutter 603 at the closed position and the toner lid 601. This prevents toner leakage from between the toner shutter 603 and the toner lid 601.

The toner shutter 603 includes stoppers 603cL and 603cR. The toner lid 601 includes stopper engagement portions 601gL and 601gR. With the toner shutter 603 closed, the stoppers 603cL and 603cR of the toner shutter 603 fit to the stopper engagement portions 601gL and 601gR. As a result, the toner shutter 603 is held at the closed position. The stoppers 603cL and 603cR are elastically deformable snap fits. When the toner shutter 603 is moved from the closed position, the stoppers 603cL and 603cR need to be deformed against the restoring force thereof to disengage the stoppers 603cL and 603cR from the stopper engagement portions 601gL and 601gR. The fitting of the stoppers 603cL and 603cR to the stopper engagement portions 601gL and 601gR can prevent the toner shutter 603 from being accidentally opened.

The toner shutter 603 moves relative to the discharge opening 71b in the direction opposite to the moving direction of the toner cartridge 70. Specifically, when moving from the retracted position to the mounted position, the toner cartridge 70 moves in the -X direction. Here, the toner shutter 603 moves in the +X direction relative to the discharge opening 71b. That is, the toner shutter 603 moves from the closed position to the open position in the +X direction. When moving from the mounted position to the retracted position, the toner cartridge 70 moves in the +X direction. Here, the toner shutter 603 moves in the -X direction relative to the discharge opening 71b. That is, the toner shutter 603 moves from the open position to the closed position in the -X direction.

In the following direction, the +X direction will be referred to as an opening direction of the toner shutter 603, and the -X direction as a closing direction of the toner shutter 603. In other words, the +X direction is the direction in which the toner shutter 603 moves from the closed position toward the open position. The -X direction is the direction in which the toner shutter 603 moves from the open position toward the closed position. In the following direction, the "X direction" refers to at least one of the closing and opening directions of the toner shutter. The "X direction" may also refer to at least one of the mounting and retracting directions of the toner cartridge 70.

In the present embodiment, the moving direction (retracting direction and mounting direction) of the toner cartridge 70 and the moving direction (opening direction and closing direction) of the toner shutter 603 are both parallel to the horizontal direction. However, the moving direction of the toner cartridge 70 and the moving direction of the toner shutter 603 do not need to be perfectly parallel to each other. At least one of the moving directions of the toner cartridge 70 and the toner shutter 603 may be inclined relative to the horizontal direction.

In the present embodiment, the rotation axis direction of the developing roller 51 is parallel to the Y direction.

The mounting direction and retracting direction of the toner cartridge 70 and the closing direction and opening direction of the toner shutter 603 are directions intersecting (desirably orthogonal to) the rotation axis direction of the developing roller 51. In the present embodiment, the direction of the rotation axis 90C of the rotary main body 90 is parallel to the Y direction. The mounting direction and retracting direction of the toner cartridge 70 and the closing direction and opening direction of the toner shutter 603 are directions intersecting (desirably orthogonal to) the direction of the rotation axis 90C.

The toner springs 605L and 605R are biasing members for restricting the toner shutter 603 at the closed position from moving from the closed position. When the toner shutter 603 is at the closed position, the biasing force of the toner springs 605L and 605R acts on the toner shutter 603 in the closing direction.

In the present embodiment, the toner springs 605L and 605R are torsion springs, and include coil portions 605aL and 605aR. The toner shutter 603 includes spring attachment portions 603aL and 603aR. The coil portions 605aL and 605aR and the spring attachment portions 603aL and 603aR are engaged with each other, and the toner springs 605L and 605R can swing about the spring attachment portions 603aL and 603aR.

The toner springs 605L and 605R include to-be-supported arms 605eL and 605eR and biasing arms 605bL and 605bR. The to-be-supported arms 605eL and 605eR are supported by the toner shutter 603. As a result, the biasing arms 605bL and 605bR generate biasing force in α1 and α2 directions about the spring attachment portions 603aL and 603aR, respectively.

The toner shutter (shutter main body) 603 and the toner springs 605L and 605R can be said to be parts of a toner shutter unit. Closing of the toner shutter 603 means closing of the toner shutter unit. Opening of the toner shutter 603 means opening of the toner shutter unit. The closing direction of the toner shutter unit is the same as that of the toner shutter 603. The opening direction of the toner shutter unit is the same as that of the toner shutter 603.

The toner lid 601 includes spring guide portions 601dL and 601dR. As illustrated in FIG. 17, with the toner shutter 603 closed, the biasing arms 605bL and 605bR press the spring guide portions 601dL and 601dR in the α1 and α2 directions. Meanwhile, by the law of action and reaction, a force in the -X direction acts on the toner shutter 603. In other words, the toner shutter 603 is subjected to a force in the closing direction.

As illustrated in FIG. 14, the toner lid 601 includes shutter guides 601cL and 601cR. As illustrated in FIG. 15, the toner shutter 603 includes to-be-guided portions 603dL and 603dR. The to-be-guided portion 603dL engages with the shutter guide 601cL, and the to-be-guided portion 603dR engages with the shutter guide 601cR. The to-be-guided portions 603dL and 603dR are guided by the shutter guides 601cL and 601cR such that the toner shutter 603 moves in the opening direction and the closing direction.

When moving from the closed position to the open position, the toner shutter 603 receives a repulsive force from the toner seal 604. As a result, the to-be-guided portions 603dL and 603dR slide against the shutter guides 601cL and 601cR.

A shutter receiving portion 601bL is located at the downstream end of the shutter guide 601cL in the closing direction of the toner shutter 603. As illustrated in FIG. 18, when the toner shutter 603 is at the closed position, the to-be-guided portion 603dL is in contact with the shutter receiving portion 601bL, whereby the toner shutter 603 is restricted from further moving in the −X direction from the closed position.

The structure of the to-be-guided portion 603dR and the shutter guide 601cR is reverse to that of the to-be-guided portion 603dL and the shutter guide 601cL with respect to the XZ plane. Since the relationship between the to-be-guided portion 603dR and the shutter guide 601cR is similar to that between the to-be-guided portion 603dL and the shutter guide 601cL, a description thereof will be omitted.

The toner lid 601 is also provided with spring engagement portions 601eL and 601eR and to-be-supported portions 601hL and 601hR that engage with components of the developing unit 50 when the toner cartridge 70 is mounted in the developing unit 50. The functions of the spring engagement portions 601eL and 601eR and the to-be-supported portions 601hL and 601hR will be described below.

The toner cartridge 70 according to the present embodiment further includes a memory 74 storing information about the toner cartridge 70.

The to-be-positioned portion 602a is disposed on a lower part of the toner container 602. When the toner cartridge 70 is at the mounted position, the to-be-positioned portion 602a engages with a positioning portion 612a to be described below, whereby the toner cartridge 70 is restricted from moving relative to the developing unit 50 in the Y direction.

The position of the discharge opening 71b and the position of the to-be-positioned portion 602a at least partially overlap in the Y direction. In other words, at least a part of the discharge opening 71b and at least a part of the to-be-positioned portion 602a are located at the same position in the Y direction.

The close arrangement of the to-be-positioned portion 602a and the discharge opening 71b enables highly accurate positioning of the discharge opening 71b. That is, the discharge opening 71b can be positioned with respect to the inlet opening with high accuracy.

The to-be-positioned portion 602a is a protrusion protruding from the bottom of the toner container 602 (the bottom of the toner frame 71). The to-be-positioned portion 602a is a rib extending in the X direction. The to-be-positioned portion 602a is exposed to the outside of the toner container 602. As illustrated in FIG. 13B, the length of the to-be-positioned portion 602a in the Y direction is smaller than the length of the to-be-positioned portion 602a in the X direction. The length of the to-be-positioned portion 602a in the Y direction is also smaller than the length of the to-be-positioned portion 602a in the moving direction (opening direction and closing direction) of the toner shutter 603. At least a part of the to-be-positioned portion 602a and at least a part of the discharge opening 71b are located at the same position in the moving direction of the toner shutter 603. When viewed in the Z direction, the to-be-positioned portion 602a overlaps the discharge opening 71b.

The to-be-positioned portion 602a is located substantially at the center of the toner cartridge 70.

Specifically, as illustrated in FIG. 13B, the center of the developing roller 51 in the Y direction will be referred to as a center 51c. The center 51c refers to the center of the toner coat region of the developing roller 51.

Twenty percent of the length of the developing roller 51 in the Y direction will be referred to as a reference length 51L. A position of the reference length 51L away from the center 51c to one side in the Y direction will be referred to as a first position, and a position of the reference length 51L away from the center 51c to the other side as a second position. The to-be-positioned portion 602a of the toner cartridge 70 at the mounted position falls between the first position and the second position.

The length of the to-be-positioned portion 602a in the Y direction is smaller than that of the toner accommodation portion 71a. Moreover, the length of the to-be-position position 602a in the Y direction is smaller than that of the discharge opening 71b. In the Y direction (longitudinal direction of the toner cartridge 70), the discharge opening 71b has a first end 71bL and a second end 71bR opposite to the first end 71bL. The to-be-positioned portion 602a is located between the first end 71bL and the second end 71bR in the Y direction.

In the present embodiment, the center 71c of the toner cartridge 70 (the center of the toner frame 71) is located between the first end 71bL and the second end 71bR in the Y direction (longitudinal direction of the toner cartridge 70). When the toner cartridge 70 is at the mounted position, the center 71c of the toner cartridge 70 is located at the same position as the center 51c of the developing roller 51.

As illustrated in FIG. 16, the position of the to-be-positioned portion 602a and the position of the discharge opening 71b at least partially overlap in the X direction. That is, at least a part of the to-be-positioned portion 602a and at least a part of the discharge opening 71b are located at the same position in the X direction. More specifically, the to-be-positioned portion 602a and the discharge opening 71b overlap across a range a illustrated in FIG. 16.

In other words, the position of the to-be-positioned portion 602a and the position of the discharge opening 71b at least partially overlap in the Y direction and the X direction. As a result, when the to-be-positioned portion 602a is positioned by the positioning portion 612a, the discharge opening 71b can be positioned with even higher accuracy. That is, the discharge opening 71b can be positioned with respect to the inlet opening 53b with high accuracy.

The position of the to-be-positioned portion 602a and the position of the toner shutter 603 at least partially overlap in the Y direction. In other words, at least a part of the to-be-positioned portion 602a and at least a part of the toner shutter 603 are located at the same position in the Y direction. As a result, when the to-be-positioned portion 602a is positioned by the positioning portion 612a, the movement of the toner shutter 603 is stabilized.

At least a part of the to-be-positioned portion 602a is located downstream of the discharge opening 71b in the -X direction. Moreover, at least a part of the to-be-positioned portion 602a is located downstream of the toner shutter 603 at the closed position in the -X direction. The to-be-positioned portion 602a is closer to the downstream end of the toner frame 71 than to the upstream end of the toner frame 71 in the -X direction.

The toner frame 71 includes a first wall 71d1 where the discharge opening 71b is disposed, and a second wall 71d2 opposed to the first wall 71d1. The first wall 71d1 and the second wall 71d2 are opposed via the toner accommodation portion 71a. That is, the toner accommodation portion 71a is located between the first wall 71d1 and the second wall 71d2. The to-be-positioned portion 602a is disposed on the second wall 71d2.

### Configuration of Developing Unit

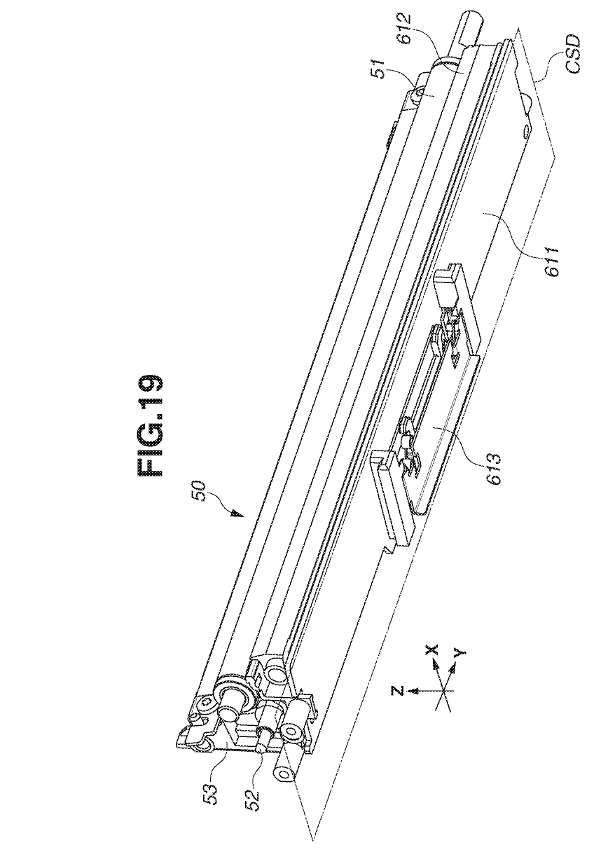

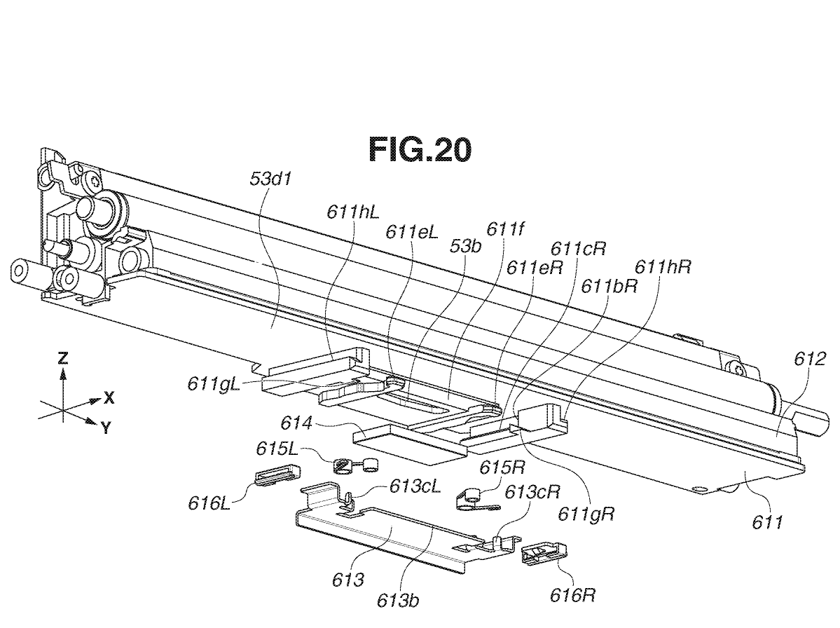

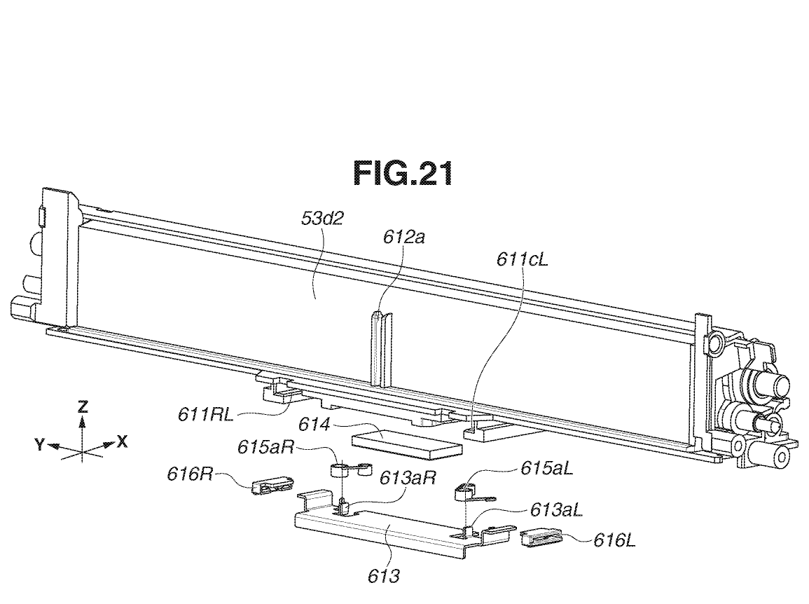

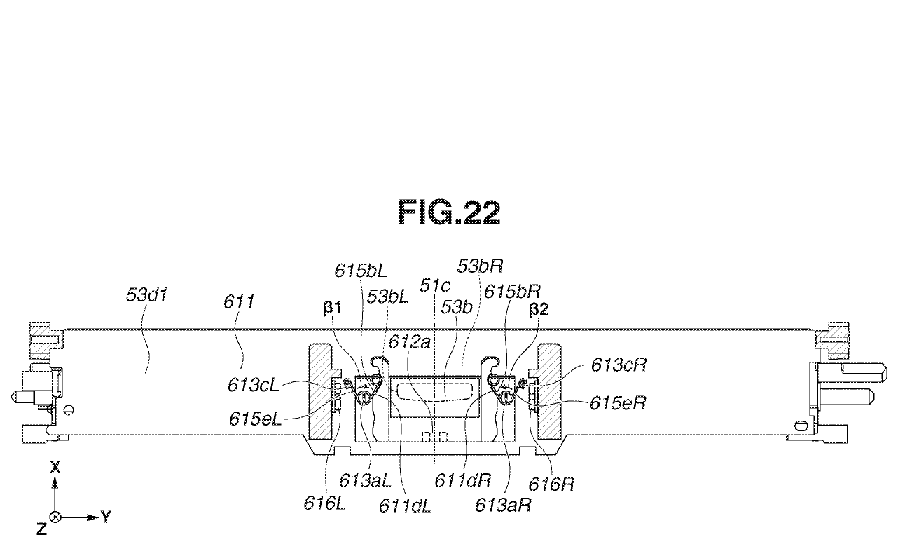

A configuration of the developing unit 50 will be described with reference to FIGS. 19 to 22. FIG. 19 is a perspective view of the developing unit 50. FIGS. 20 and 21 are exploded perspective views of the developing unit 50. FIG. 22 is a sectional view of the developing unit 50. Specifically, FIG. 22 is a sectional view when the developing unit 50 is sectioned along a cross section CSD of FIG. 19.

As illustrated in FIGS. 19 to 21, the developing unit 50 includes a developing lid 611, a developing container 612, a developing shutter 613, a developing seal 614, and developing springs 615L and 615R.

The developing frame 53 includes the developing lid 611 and the developing container 612. The developing lid 611 and the developing container 612 are fixed to each other by welding or adhesive bonding to form the developing-side accommodation portion 53a. As described above, the developing unit 50 includes the developing roller 51 and the supply roller 52.

The developing lid 611 has the inlet opening 53b communicating with the developing-side accommodation portion 53a.

Once the toner cartridge 70 reaches the mounted position, the inlet opening 53b and the discharge opening 71b are opposed to and communicate with each other. The toner discharged from the discharge opening 71b of the toner cartridge 70 is then supplied to the developing-side accommodation portion 53a through the inlet opening 53b.

With the toner cartridge 70 detached from the developing unit 50, the developing shutter 613 is closed. In other words, the developing shutter 613 is located at a closed position. The developing shutter 613 at the closed position covers the inlet opening 53b. When the developing shutter 613 is located at an open position, the inlet opening 53b is exposed to let in toner therethrough. As will be described below, the developing shutter 613 is configured to translate between the open position and the closed position.

The developing seal 614 is fixed to the developing shutter 613 by adhesive bonding or using a tape with an adhesive layer. The developing seal 614 is compressed between the developing lid 611 and the developing shutter 613. This prevents toner leakage from between the developing lid 611 and the developing shutter 613. When the developing shutter 613 is located at the closed position, the developing seal 614 covers the inlet opening 53b.

The developing shutter 613 and the developing seal 614 can be said to form a developing shutter unit. In such a case, the developing shutter 613 functions as a shutter main body, and the developing seal 614 as a seal portion. The state where the developing shutter 613 is at the closed position can be said to be a state where the developing shutter unit is at a closed position. The state where the developing shutter 613 is at the open position can be said to be a state where the developing shutter unit is at an open position. When the developing shutter unit is located at the closed position, the inlet opening 53b is covered by the developing shutter unit. When the developing shutter unit is located at the open position, the inlet opening 53b is exposed.

The developing shutter 613 moves relative to the inlet opening 53b in the same direction as the moving direction of the toner cartridge 70. That is, when moving from the retracted position to the mounted position, the toner cartridge 70 moves in the -X direction. Here, the developing shutter 613 moves in the -X direction relative to the inlet opening 53b. In other words, the developing shutter 613 moves from the closed position to the open position in the -X direction. When moving from the mounted position to the retracted position, the toner cartridge 70 moves in the +X direction. Here, the developing shutter 613 moves in the +X direction relative to the inlet opening 53b. In other words, the developing shutter 613 moves from the open position to the closed position in the +X direction.

In the following direction, the -X direction will be referred to as the opening direction of the developing shutter 613, and the +X direction as the closing direction of the developing shutter 613. In other words, the -X direction is the direction in which the developing shutter 613 moves from the closed position toward the open position. The +X direction is the direction in which the developing shutter 613 moves from the open position toward the closed position. In the following description, the "X direction" refers to at least one of the closing direction and the opening direction of the developing shutter 613.

In the present embodiment, the moving direction (retracting direction and mounting direction) of the toner cartridge 70 and the moving direction (opening direction and closing direction) of the developing shutter 613 are both parallel to the horizontal direction. However, the moving direction of the toner cartridge 70 and the moving direction of the developing shutter 613 do not need to be perfectly parallel to each other. The moving direction of the developing shutter 613 may be inclined relative to the horizontal direction.

The developing shutter 613 is formed of sheet metal. Alternatively, the developing shutter 613 may be made of a resin material. To-be-guided members 616L and 616R are attached to the developing shutter 613.

The developing springs 615L and 615R are biasing members for restricting the developing shutter 613 at the closed position from moving from the closed position. When the developing shutter 613 is at the closed position, the biasing force of the developing springs 615L and 615R acts on the developing shutter 613 in the closing direction.

In the present embodiment, the developing springs 615L and 615R are torsion springs, and include coil portions 615aL and 615aR. The developing shutter 613 includes spring attachment portions 613aL and 613aR. The coil portions 615aL and 615aR and the spring attachment portions 613aL and 613aR are engaged with each other, and the developing springs 615L and 615R can swing about the spring attachment portions 613aL and 613aR.

The developing springs 615L and 615R include to-be-supported arms 615eL and 615eR and biasing arms 615bL and 615bR. The developing shutter 613 includes arm supporting portions 613cL and 613cR. The to-be-supported arms 615eL and 615eR are supported by the arm supporting portions 613cL and 613cR of the developing shutter 613. As a result, the biasing arms 615bL and 615bR generate biasing force in β1 and β2 directions about the spring attachment portions 613aL and 613aR, respectively.

The developing springs 615L and 615R can be said to be parts of a developing shutter unit. The to-be-guided members 616L and 616R can also be said to be parts of the developing shutter unit.

Closing of the developing shutter 613 means closing of the developing shutter unit. Opening of the developing shutter 613 means opening of the developing shutter unit. The closing direction of the developing shutter unit is the same as that of the developing shutter 613. The opening direction of the developing shutter unit is the same as that of the developing shutter 613.

As illustrated in FIG. 22, the developing lid 611 includes spring guide portions 611dL and 611dR.

With the developing shutter 613 closed, the biasing arms 615bL and 615bR press the spring guide portions 611dL and 611dR in the β1 and β2 directions. Meanwhile, by the law of action and reaction, a force in the +X direction acts on the developing shutter 613. In other words, the developing shutter 613 is subjected to a force in the closing direction.

As illustrated in FIGS. 20 and 21, the developing lid 611 includes shutter guides 611cL and 611cR. The to-be-guided members 616L and 616R are attached to the developing shutter 613. The to-be-guided member 616L engages with the shutter guide 611cL, and the to-be-guided member 616R engages with the shutter guide 611cR. The to-be-guided members 616L and 616R are guided by the shutter guides 611cL and 611cR such that the developing shutter 613 moves in the opening direction and the closing direction.

When moving from the closed position to the open position, the developing shutter 613 receives a repulsive force from the developing seal 614. As a result, the to-be-guided members 616L and 616R slide against the shutter guides 611cL and 611cR.

As illustrated in FIG. 20, a shutter receiving portion 611bR is located at the downstream end of the shutter guide 611cR in the closing direction of the developing shutter 613. When the developing shutter 613 is located at the closed position, the to-be-guided member 616R is in contact with the shutter receiving portion 611bR, whereby the developing shutter 613 is restricted from further moving in the +X direction from the closed position.

The structure of the to-be-guided member 616L and the shutter guide 611cL is reverse to that of the to-be-guided member 616R and the shutter guide 611cR with respect to the XZ plane. Since the relationship between the to-be-guided member 616L and the shutter guide 611cL is similar to that between the to-be-guided member 616R and the shutter guide 611cR, a description thereof will be omitted.

The developing lid 611 is also provided with spring engagement portions 611eL and 611eR and cartridge support portions 611hL and 611hR that engage with components of the toner cartridge 70 when the toner cartridge 70 is mounted in the developing unit 50. The functions of the spring engagement portions 611eL and 611eR and the cartridge support portions 611hL and 611hR will be described below.

The developing frame 53 has a first surface 53d1 where the inlet opening 53b is disposed and a second surface 53d2 inclined relative to the first surface 53d1. That is, the second surface 53d2 extends in a direction intersecting (desirably orthogonal to) the first surface 53d1. The second surface 53d2 is a surface different from the first surface 53d1. The first surface 53d1 is a part of the developing lid 611, and the second surface 53d2 is a part of the developing container 612. The inlet opening 53b and the developing shutter 613 are disposed in/on the first surface 53d1. The positioning portion 612a is disposed on the second surface 53d2.

The engagement of the to-be-positioned portion 602a of the toner cartridge 70 with the positioning portion 612a restricts the toner cartridge 70 from moving relative to the developing unit 50 in the Y direction.

The position of the inlet opening 53b and the position of the positioning portion 612a at least partially overlap in the Y direction. In other words, at least a part of the inlet opening 53b and at least a part of the positioning portion 612a are located at the same position in the Y direction.

The position of the developing shutter 613 and the position of the positioning portion 612a at least partially overlap in the Y direction. In other words, at least a part of the developing shutter 613 and at least a part of the positioning portion 612a are located at the same position in the Y direction.

The positioning portion 612a is a pair of opposed surfaces, which forms a groove for the to-be-positioned portion 602a to be inserted into. The positioning portion 612a according to the present embodiment protrudes from the second surface 53d2 of the developing frame 53. The groove formed by the positioning portion 612a extends in the Z direction.

The positioning portion 612a is located substantially at the center of the developing unit 50. The position of the center 51c of the developing roller 51, the position of the inlet opening 53b, and the position of the positioning portion 612a overlap in the Y direction.

In the Y direction (longitudinal direction of the toner cartridge 70), the inlet opening 53b has a first end 53bL and a second end 53bR opposite to the first end 53bL. The positioning portion 612a is located between the first end 53bL and the second end 53bR in the Y direction.

In the foregoing description, the positional relationship between the positioning portion 612a and the inlet opening 53b of a single developing unit 50 has been described. As described above, the developing units 50y to 50k have a common configuration except for the color of the toner accommodated therein. The developing units 50y to 50k are fixed inside the rotary main body 90. The positional relationship between the positioning portion 612a of one developing unit 50 and the inlet opening 53b of another developing unit 50 is thus similar to that between the positioning portion 612a and the inlet opening 53b of a single developing unit 50.

### Configuration of Rotary Main Body and Plurality of Developing Units

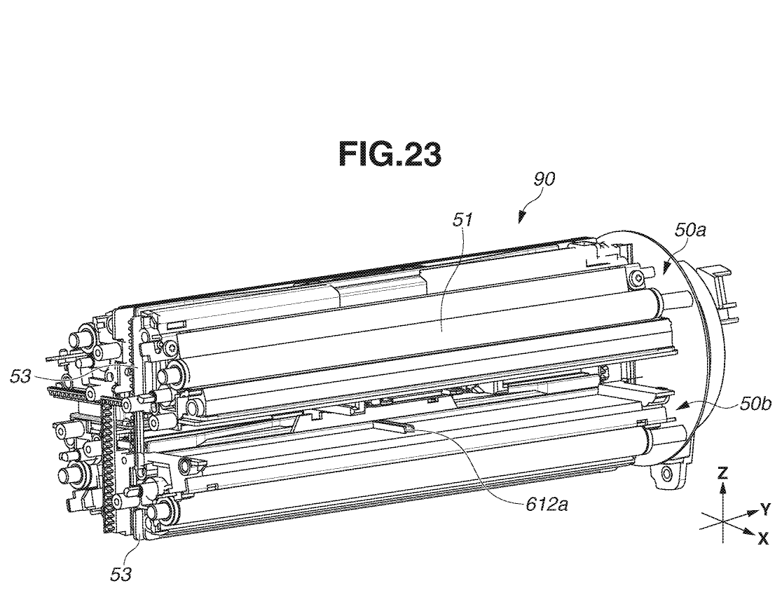

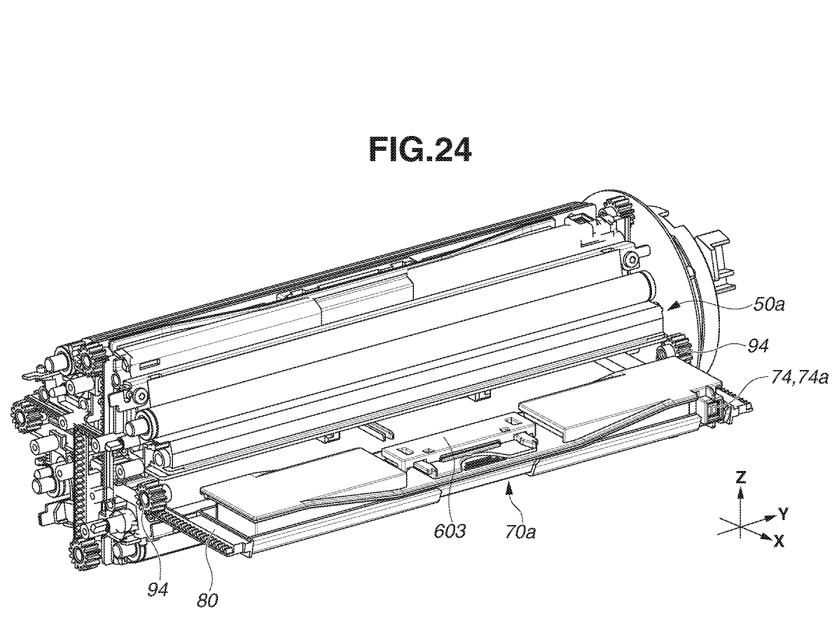

A configuration of the rotary main body 90 and the plurality of developing units 50 will be described with reference to FIGS. 23 and 24.

FIG. 23 is a perspective view of the rotary main body 90. FIG. 24 is a perspective view for describing the mounting of the toner cartridge 70 (first toner cartridge 70a). Specifically, FIG. 24 is a perspective view when the first toner cartridge 70a is placed on the tray 80 of the rotary main body 90.

In the rotary main body 90, the plurality of developing units 50 is arranged at intervals of 90º.

The first developing unit will be denoted by 50a, and the second developing unit adjacent to the first developing unit 50a will be denoted by 50b. The toner cartridge 70 mounted in the first developing unit 50a will be referred to as a first toner cartridge 70a. The first developing unit 50a and the second developing unit 50b have the same configuration as that of the foregoing developing unit 50, and the first toner cartridge 70a has the same configuration as that of the foregoing toner cartridge 70.

In FIG. 23, the tray 80 of the first developing unit 50a is omitted. The first toner cartridge 70a accommodating toner to be supplied to the first developing unit 50a is mounted between the first developing unit 50a and the second developing unit 50b.

As will be described in detail below, the to-be-positioned portion 602a disposed on the first toner cartridge 70a engages with the positioning portion 612a disposed on the second developing unit 50b. In other words, when the first toner cartridge 70a is located at the mounted position, the first toner cartridge 70a is positioned by the positioning portion 612a disposed on the second developing unit 50b.

In mounting the first toner cartridge 70a in the first developing unit 50a, the first toner cartridge 70a is attached to the tray 80 included in the first developing unit 50a. The tray 80 is them moved to move the first toner cartridge 70a to the mounted position.

Note that when the first toner cartridge 70a is placed on the tray 80, memory electrodes 74a of the memory 74 face outward in the radial direction of rotation of the rotary main body 90.

### Operation When Mounting Toner Cartridge

An operation (mounting operation) when placing the first toner cartridge 70a on the tray 80 and mounting the first toner cartridge 70a into the first developing unit 50a will be described with reference to FIGS. 24 to 37. An operation (detachment operation) when detaching the first toner cartridge 70a from the first developing unit 50a is performed in reverse order to that of the mounting operation.

When the amount of toner in the first developing unit 50a falls below a predetermined level, the image forming apparatus 1 displays information related to a replacement request for the first toner cartridge 70a to the user.

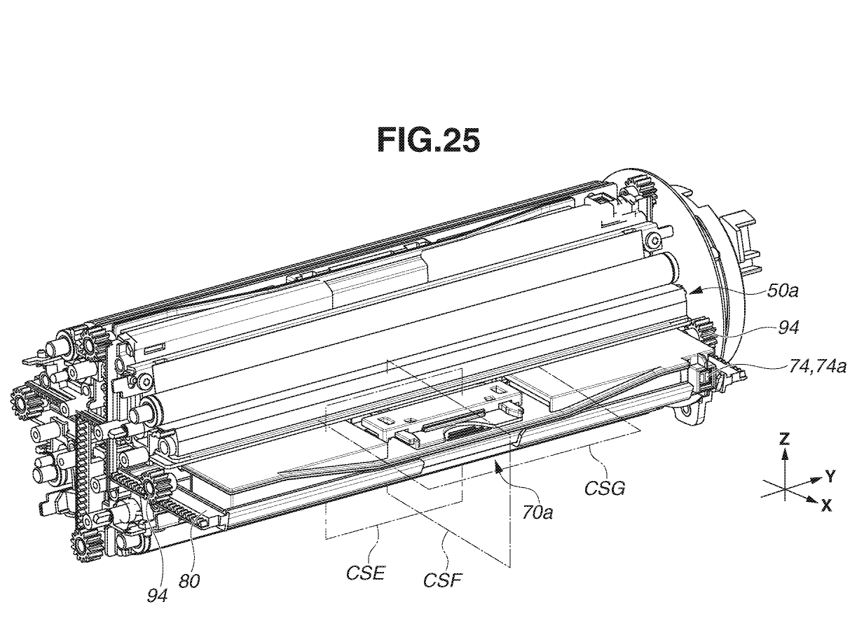

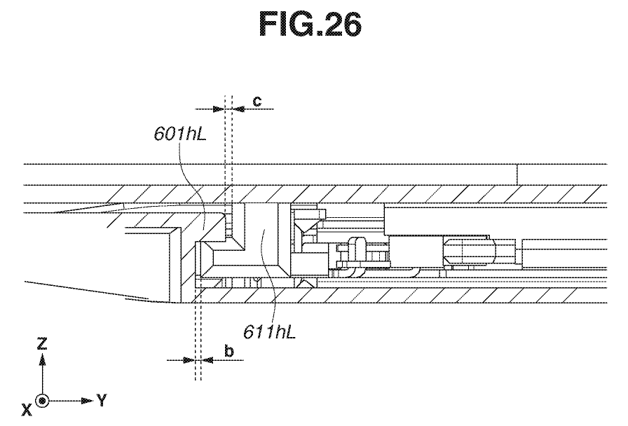

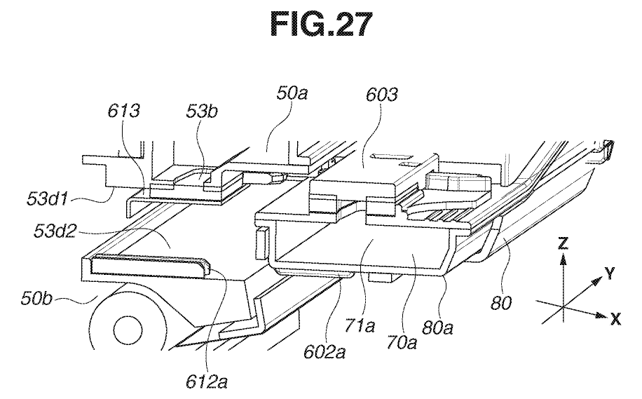

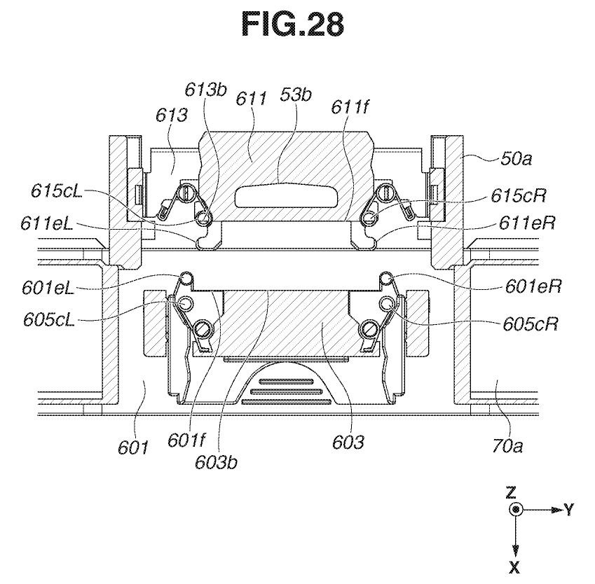

FIG. 25 is a perspective view for describing the mounting of the toner cartridge 70 (first toner cartridge 70a). FIG. 25 illustrates a state where the first toner cartridge 70a is pulled into the rotary main body 90 by a predetermined amount from the position illustrated in FIG. 24. FIGS. 26, 27, and 28, are sectional views for describing the mounting of the toner cartridge 70 (first toner cartridge 70a). Specifically, FIG. 26 is a sectional view when the rotary main body 90 is sectioned along a cross section CSE of FIG. 25. FIG. 27 is a sectional perspective view when the rotary main body 90 is sectioned along a cross section CSF of FIG. 25. FIG. 28 is a sectional view when the rotary main body 90 is sectioned along a cross section CSG of FIG. 25.

As illustrated in FIG. 24, the user removes the old first toner cartridge 70a from the tray 80 and places a new first toner cartridge 70a on the tray 80.

When the tray 80 is pulled into the rotary main body 90, as illustrated in FIG. 26, the to-be-supported portion 601hL of the first toner cartridge 70a contacts the cartridge supporting portion 611hL of the first developing unit 50a in the Z direction. At least one of the downstream end of the to-be-supported portion 601hL in the -X direction and the upstream end of the cartridge support portion 611h in the -X direction is sloped. As the tray 80 is pulled in, the cartridge support portion 611hL of the first developing unit 50a lifts the to-be-supported portion 601hL of the first toner cartridge 70a.

As illustrated in FIG. 26, there are gaps b and c in the Y direction between the cartridge support portion 611h of the first developing unit 50a and the to-be-supported portion 601hL of the first toner cartridge 70a.

The structure of the cartridge support portion 611hR and the to-be-supported portion 601hR is reverse to that of the cartridge support portion 611hL and the to-be-supported portion 601hL with respect to the XZ plane. Since the relationship between the cartridge support portion 611hR and the to-be-supported portion 601hR is similar to that between the cartridge support portion 611hL and the to-be-supported portion 601hL, a description thereof will be omitted.

In such a manner, when the first toner cartridge 70a moves from the retracted position to the mounted position, the to-be-supported portions 601hL and 601hR and the cartridge support portions 611hL and 611hR engage with each other before the first toner cartridge 70a reaches the mounted position.

Before the to-be-supported portions 601hL and 601hR are lifted by the cartridge support portions 611hL and 611hR, the own weight of the first toner cartridge 70a is borne by the tray 80. After the to-be-supported portions 601hL and 601hR are lifted by the cartridge support portions 611hL and 611hR, the own weight of the first toner cartridge 70a is borne by the cartridge support portions 611hL and 611hR. In other words, in the Z direction, the first toner cartridge 70a is positioned by the cartridge support portions 611hL and 611hR.

As illustrated in FIG. 27, the tray 80 has an opening 80a, where the to-be-positioned portion 602a of the first toner cartridge 70a is exposed. In a state where the to-be-supported portions 601hL and 601hR start to engage with the cartridge support portions 611hL and 611hR, as illustrated in FIG. 27, the positioning portion 612a of the second developing unit 50b and the to-be-positioned portion 602a of the first toner cartridge 70a are not engaged.

As illustrated in FIG. 28, in the state where the to-be-supported portions 601hL and 601hR start to engage with the cartridge support portions 611hL and 611hR, a toner shutter contact portion 603b of the toner shutter 603 is not in contact with the first developing unit 50a. A developing shutter contact portion 613b of the developing shutter 613 is not in contact with the first toner cartridge 70a, either.

When the tray 80 moves from the position illustrated in FIG. 25 and the first toner cartridge 70a is further pulled into the rotary main body 90, the to-be-positioned portion 602a of the first toner cartridge 70a comes into engagement with the positioning portion 612a of the second developing unit 50b. As a result, the first toner cartridge 70a is restricted from moving in the Y direction relative to the first developing unit 50a and the second developing unit 50b.

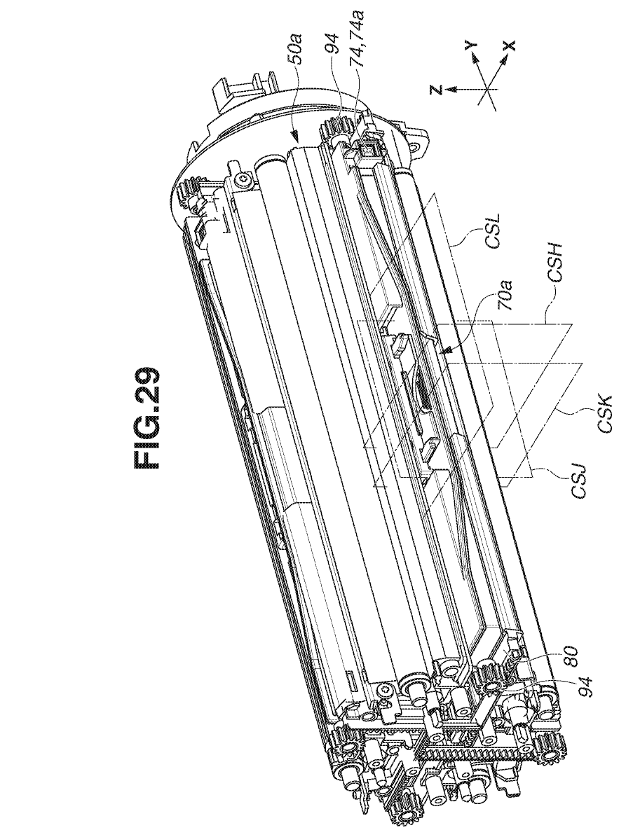

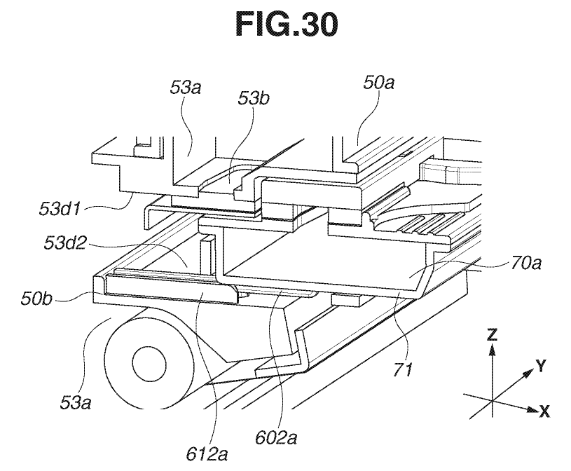

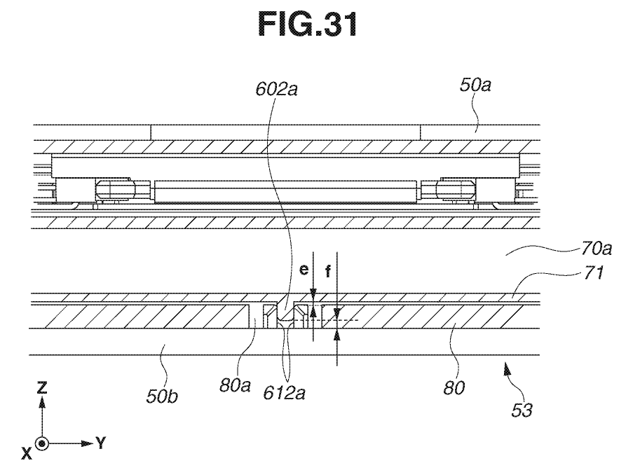

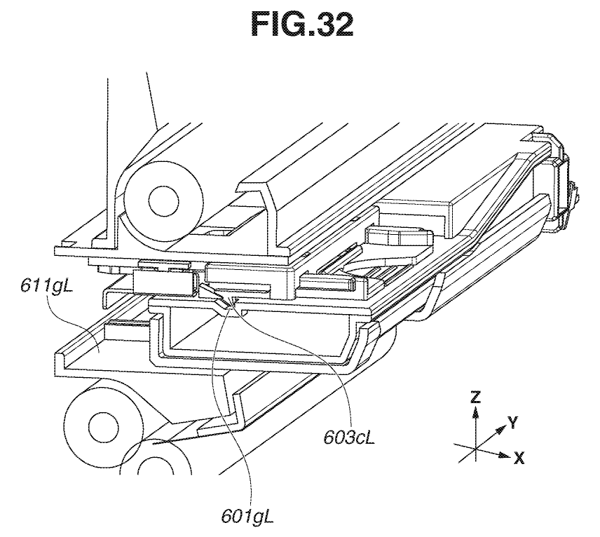

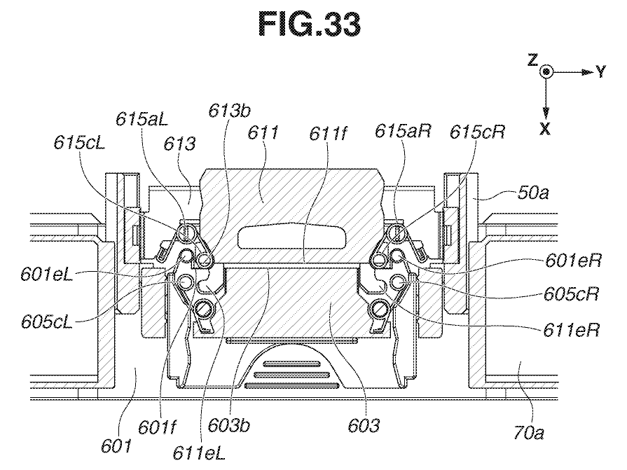

FIG. 29 is a perspective view for describing the mounting of the toner cartridge 70 (first toner cartridge 70a). FIG. 29 illustrates a state where the first toner cartridge 70a is further pulled into the rotary main body 90 from the position illustrated in FIG. 25. FIGS. 30, 31, 32, and 33, are sectional views for describing the mounting of the toner cartridge 70 (first toner cartridge 70a). Specifically, FIG. 30 is a sectional perspective view when the rotary main body 90 is sectioned along a cross section CSH of FIG. 29. FIG. 31 is a sectional view when the rotary main body 90 is sectioned along a cross section CSJ of FIG. 29. FIG. 32 is a sectional perspective view when the rotary main body 90 is sectioned along a cross section CSK of FIG. 29. FIG. 33 is a sectional view when the rotary main body 90 is sectioned along a cross section CSL of FIG. 29.

As illustrated in FIGS. 30 and 31, the positioning portion 612a of the second developing unit 50b engages with the to-be-positioned portion 602a of the first toner cartridge 70a. As a result, the first toner cartridge 70a is positioned with respect to the first developing unit 50a and the second developing unit 50b in the Y direction. In other words, the contact between the to-be-positioned portion 602a and the positioning portion 612a restricts movement of the first toner cartridge 70a in the +Y direction and the -Y direction.

As illustrated in FIG. 31, there is a gap f in the Z direction between the tip of the to-be-positioned portion 602a and the developing frame 53 of the second developing unit 50b. Meanwhile, there is a gap e between the tips of the positioning portion 612a and the toner frame 71 of the first toner cartridge 70a.

With the to-be-supported portions 601hL and 601hR and the cartridge support portions 611hL and 611hR engaged with each other and the to-be-positioned portion 602a and the positioning portion 612a engaged with each other, movement of the first toner cartridge 70a is restricted in the Y direction and the Z direction. Meanwhile, in this state, the first toner cartridge 70a can move in the X direction.

As described above, when the first toner cartridge 70a moves from the retracted position to the mounted position, the to-be-positioned portion 602a and the positioning portion 612a engage with each other before the first toner cartridge 70a reaches the mounted position. The to-be-positioned portion 602a and the positioning portion 612a remain engaged with each other with the first toner cartridge 70a at the mounted position.

The to-be-positioned portion 602a and the positioning portion 612a are in a clearance fit relationship. Due to the difference in size between the to-be-positioned portion 602a and the positioning portion 612a, the first toner cartridge 70a may tilt such that the longitudinal direction of the first toner cartridge 70a is oblique to the Y direction. Since the position of the to-be-positioned portion 602a and the position of the discharge opening 71b at least partially overlap in the Y direction, displacement of the discharge opening 71b due to the tilt of the first toner cartridge 70a can be suppressed. In other words, the discharge opening 71b can be positioned with high accuracy.

The inlet opening 53b of the first developing unit 50a is disposed in the first surface 53d1. The positioning portion 612a is located away from the first surface 53d1. As a result, the to-be-positioned portion 602a of the first toner cartridge 70a is located away from the discharge opening 71b. At least a part of the to-be-positioned portion 602a and at least a part of the discharge opening 71b can thus be located at the same position in the Y direction without the to-be-positioned portion 602a obstructing the toner discharge from the discharge opening 71b.

In the present embodiment, the to-be-positioned portion 612a is disposed on the second surface 53d2 of the second developing unit 50b. The second surface 53d2 of the second developing unit 50b is an example of a surface opposed to the inlet opening 53b of the first developing unit 50a. The second surface 53d2 of the second developing unit 50b is an example of a surface opposed to the developing shutter 613 of the first developing unit 50a at the closed position. In other words, the positioning portion 612a of the second developing unit 50b is opposed to the inlet opening 53b of the first developing unit 50a. The positioning portion 612a of the second developing unit 50b is also opposed to the developing shutter 613 of the first developing unit 50a at the closed position.

The positioning portion 612a is closer to the second developing unit 50b than to the first developing unit 50a in a direction orthogonal to the Y direction. More specifically, the positioning portion 612a is closer to the developing-side accommodation portion 53a of the second developing unit 50b than to the developing-side accommodation portion 53a of the first developing unit 50a. In the present embodiment, the positioning portion 612a is disposed on the developing frame 53 of the second developing unit 50b.

Such an arrangement prevents the to-be-positioned portion 602a from interfering with the toner discharge from the discharge opening 71b, even with the position of the to-be-positioned portion 602a and the position of the discharge opening 71b at least partially overlapping in the Y direction and the X direction. Moreover, the configuration for positioning the first toner cartridge 70a in the Y direction can be disposed in a space-saving manner.

The positioning portion 612a may be disposed on a component different from the developing frame 53 of the second developing unit 50b. However, the integral disposition of the positioning portion 612a on the developing frame 53 of the second developing unit 50b as in the present embodiment can reduce an increase in parts count.

As described above, when the toner shutter 603 is located at the closed position, the stoppers 603cL and 603cR are fitted to the stopper engagement portions 601gL and 601gR. As illustrated in FIG. 20, the developing lid 611 includes stopper release portions 611gL and 611gR.

As illustrated in FIG. 32, when the to-be-positioned portion 602a and the positioning portion 612a start to engage, the stopper 603cL of the first toner cartridge 70a is in contact with the stopper release portion 611gL of the developing lid 611. As the first toner cartridge 70a is further pulled into the rotary main body 90, the stopper release portion 611gL moves the stopper 603cL in the Z direction, whereby the stopper 603cL is disengaged from the stopper engagement portion 601gL.

The structure of the stopper 603cR, the stopper engagement portion 601gR, and the stopper release portion 611gR is reverse to that of the stopper 603cL, the stopper engagement portion 601gL, and the stopper release portion 611gL with respect to the XZ plane. Since the relationship between the stopper 603cR, the stopper engagement portion 601gR, and the stopper release portion 611gR is similar to that between the stopper 603cL, the stopper engagement portion 601gL, and the stopper release portion 611gL, a description thereof will be omitted.

With the stoppers 603cL and 603cR disengaged from the stopper engagement portions 601gL and 601gR, the toner shutter 603 can move in the +X direction relative to the discharge opening 71b.

As illustrated in FIG. 33, when the to-be-positioned portion 602a and the positioning portion 612a start to engage, the toner shutter contact portion 603b of the toner shutter 603 is not in contact with the first developing unit 50a. The developing shutter contact portion 613b of the developing shutter 613 is not in contact with the first toner cartridge 70a, either.

As described above, when the first toner cartridge 70a moves from the retracted position to the mounted position, the to-be-positioned portion 602a and the positioning portion 612a engage with each other before the first toner cartridge 70a reaches the mounted position.

In the present embodiment, when the first toner cartridge 70a moves from the retracted position to the mounted position, the to-be-positioned portion 602a and the positioning portion 612a engage with each other before the discharge opening 71b is opposed to the inlet opening 53b. Moreover, the to-be-positioned portion 602a and the positioning portion 612a engage with each other before the developing shutter 613 moves in the opening direction and before the toner shutter 603 moves in the opening direction. The discharge opening 71b can thus be opposed to the inlet opening 53b, and the developing shutter 613 and the toner shutter 603 can move, with the first toner cartridge 70a stable.

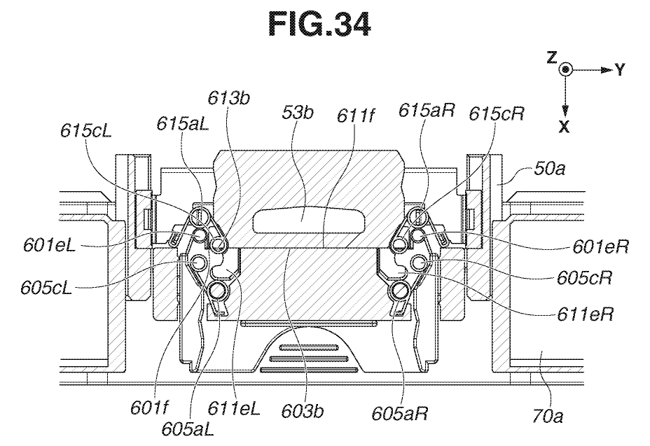

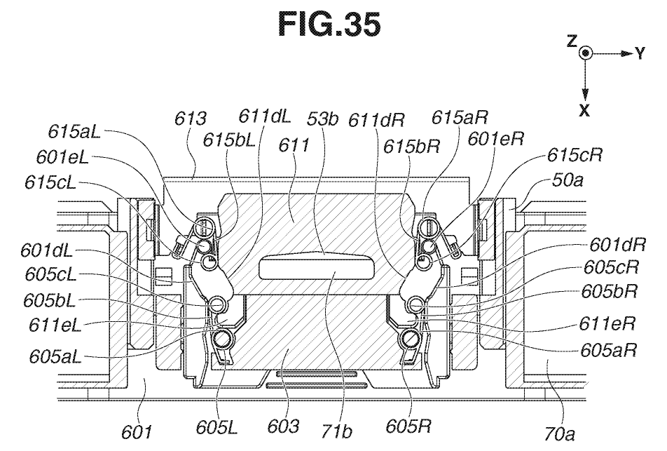

FIGS. 34 and 35 are sectional views for describing the mounting of the toner cartridge 70 (first toner cartridge 70a). FIG. 34 illustrates a state where the first toner cartridge 70a is further pulled into the rotary main body 90 from the position illustrated in FIG. 33. FIG. 35 illustrates a state where the first toner cartridge 70a is further pulled into the rotary main body 90 from the position illustrated in FIG. 34.

As illustrated in FIGS. 14 and 20, the developing lid 611 includes a developing contact portion 611f, and the toner lid 601 includes a toner contact portion 601f.

When the first toner cartridge 70a is further pulled in from the state illustrated in FIG. 33, the toner shutter contact portion 603b of the toner shutter 603 comes into contact with the developing contact portion 611f of the developing lid 611 as illustrated in FIG. 34. As a result, the toner shutter 603 is restricted from moving relative to the developing lid 611 of the developing frame 53.

Moreover, the developing shutter contact portion 613b of the developing shutter 613 comes into contact with the toner contact portion 601f of the toner lid 601. As a result, the developing shutter 613 is restricted from moving relative to the toner lid 601.

Here, the coil portions 615aL and 615aR of the developing springs 615L and 615R come into contact with the spring engagement portions 601eL and 601eR of the toner lid 601. Moreover, the coil portions 605aL and 605aR of the toner springs 605L and 605R come into contact with the spring engagement portions 611eL and 611eR of the developing lid 611. In other words, the toner shutter 603 and the toner springs 605L and 605R stop relative to the developing lid 611, in contact with the developing lid 611.

When in such a state the first toner cartridge 70a is further pulled in, the toner frame 71 and the discharge opening 71b move in the -X direction relative to the toner shutter 603 and the toner springs 605L and 605R. In other words, the toner shutter 603 and the toner springs 605L and 605R move in the +X direction relative to the toner frame 71 and the discharge opening 71b. The developing contact portion 611f of the developing lid 611 may be referred to as a receiving portion for receiving the toner shutter 603, an opener for opening the toner shutter 603, a pressing portion for pressing the toner shutter 603, etc.

When the first toner cartridge 70a is further pulled in from the state illustrated in FIG. 34, the developing shutter 613 and the developing springs 615L and 615R move along with the toner lid 601 in the -X direction relative to the developing frame 53 and the inlet opening 53b as illustrated in FIG. 35. The toner contact portion 601f of the toner lid 601 may be referred to as a receiving portion that receives the developing shutter 613, an opener for opening the developing shutter 613, a pressing portion for pressing the developing shutter 613, etc.

As described above, the toner shutter 603 and the toner springs 605L and 605R stop relative to the developing lid 611, in contact with the developing lid 611. In such a state, the toner lid 601, which is a part of the toner frame 71, moves in the -X direction relative to the toner shutter 603 and the toner springs 605L and 605R. As a result, the spring guide portions 601dL and 601dR are displaced relative to the biasing arms 605bL and 605bR. The spring guide portions 601dL and 601dR are configured to move the biasing arms 605bL and 605bR. Specifically, the spring guide portions 601dL and 601dR have inclined surfaces that are inclined relative to the X direction. The biasing arms 605bL and 605bR contact the inclined surfaces of the spring guide portions 601dL and 601dR and rotate in directions reverse to the α1 and α2 directions (see FIG. 18) against the restoring force. The spring guide portions 601dL and 601dR may be referred to as action portions for deforming the toner springs 605L and 605R, or spring deformation portions.

The biasing arms 605bL and 605bR include hook portions (tip portions) 605cL and 605cR. The hook portions 605cL and 605cR contact the spring guide portions 601dL and 601dR.

As the biasing arm 605bL rotates in the direction reverse to the α1 direction, the spring engagement portion 611eL is sandwiched between the hook portion 605cL and the coil portion 605aL. Similarly, as the biasing arm 605bR rotates in the direction reverse to the α2 direction, the spring engagement portion 611eR is sandwiched between the hook portion 605cR and the coil portion 605aR.

The developing shutter 613 and the developing springs 615L and 615R move in the -X direction relative to the developing frame 53 and the inlet opening 53b. As a result, the biasing arms 615bL and 615bR are displaced relative to the spring guide portions 611dL and 611dR. The spring guide portions 611dL and 611dR are configured to move the biasing arms 615bL and 615bR. Specifically, the spring guide portions 611dL and 611dR have inclined surfaces that are inclined relative to the X direction.

The biasing arms 615bL and 615bR contact the inclined surfaces of the spring guide portions 611dL and 611dR and rotate in directions reverse to the β1 and β2 directions (see FIG. 22) against the restoring force. The spring guide portions 611dL and 611dR may be referred to as action portions for deforming the developing springs 615L and 615R, or spring deformation portions.

The biasing arms 615bL and 615bR include hook portions (tip portions) 615cL and 615cR. The hook portions 615cL and 615cR contact the spring guides 611dL and 611dR.

As the biasing arm 615bL rotates in the direction reverse to the β1 direction, the spring engagement portion 601eL is sandwiched between the hook portion 615cL and the coil portion 615aL. Similarly, as the biasing arm 615bR rotates in the direction reverse to the β2 direction, the spring engagement portion 601eR is sandwiched between the hook portion 615cR and the coil portion 615aR.

As illustrated in FIG. 17, with the toner shutter 603 at the closed position, the biasing forces acting on the spring guide portions 601dL and 601dR from the toner springs 605L and 605R include a component in the +X direction. As a result, the toner shutter 603 is subjected to a force in the -X direction by the biasing forces of the toner springs 605L and 605R.

By contrast, in the state illustrated in FIG. 35, the toner spring 605L biases the spring guide portion 601dL in the -Y direction, and the toner spring 605R biases the spring guide portion 601dR in the +Y direction. As a result, the force acting on the toner shutter 603 due to the biasing forces of the toner springs 605L and 605R includes substantially no component in the -X direction. This reduces the force needed to move the toner shutter 603 in the opening direction.

That is, in the present embodiment, the toner shutter 603 at the closed position is subjected to the force in the closing direction from the toner springs 605L and 605R. This force decreases as the toner shutter 603 moves from the closed position toward the open position. Among the forces that the toner shutter 603 receives from the toner springs 605L and 605R, the force acting in the closing direction is smaller in magnitude when the toner shutter 603 is at the open position than when the toner shutter 603 is at the closed position.

As illustrated in FIG. 22, with the developing shutter 613 at the closed position, the biasing forces acting on the spring guide portions 611dL and 611dR from the developing springs 615L and 615R include components in the -X direction. As a result, the developing shutter 613 is subjected to a force in the +X direction by the biasing forces of the developing springs 615L and 615R.

By contrast, in the state illustrated in FIG. 35, the developing spring 615L biases the spring guide portion 611dL in the +Y direction, and the developing spring 615R biases the spring guide portion 611dR in the -Y direction. As a result, the force acting on the developing shutter 613 due to the biasing forces of the developing springs 615L and 615R includes substantially no component in the +X direction. This reduces the force needed to move the developing shutter 613 in the opening direction.

That is, in the present embodiment, the developing shutter 613 at the closed position is subjected to a force in the closing position from the developing springs 615L and 615R. This force decreases as the developing shutter 613 moves from the closed position to the open position. Of the forces that the developing shutter 613 receives from the developing springs 615L and 615R, the force acting in the closing direction is smaller in magnitude when the developing shutter 613 is at the closed position than when the developing shutter 613 is at the open position.

In the state illustrated in FIG. 35, the inlet opening 53b and the discharge opening 71b overlap in part. In the process of mounting the first toner cartridge 70a, the to-be-positioned portion 602a of the first toner cartridge 70a engages with the positioning portion 612a of the second developing unit 50b before the inlet opening 53b and the discharge opening 71b start to overlap. As a result, the first toner cartridge 70a can be positioned with respect to the first developing unit 50a in the Y direction via the second developing unit 50b before the inlet opening 53b and the discharge opening 71b start to overlap.

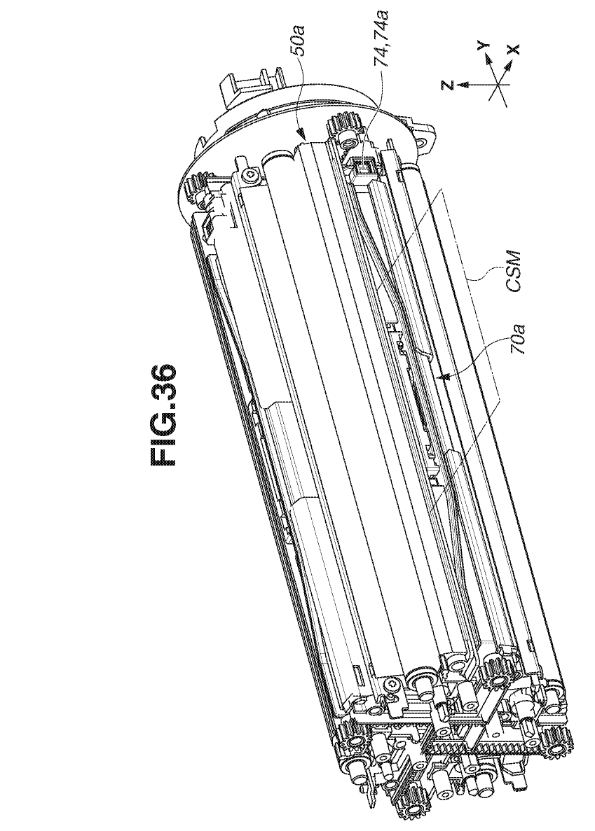

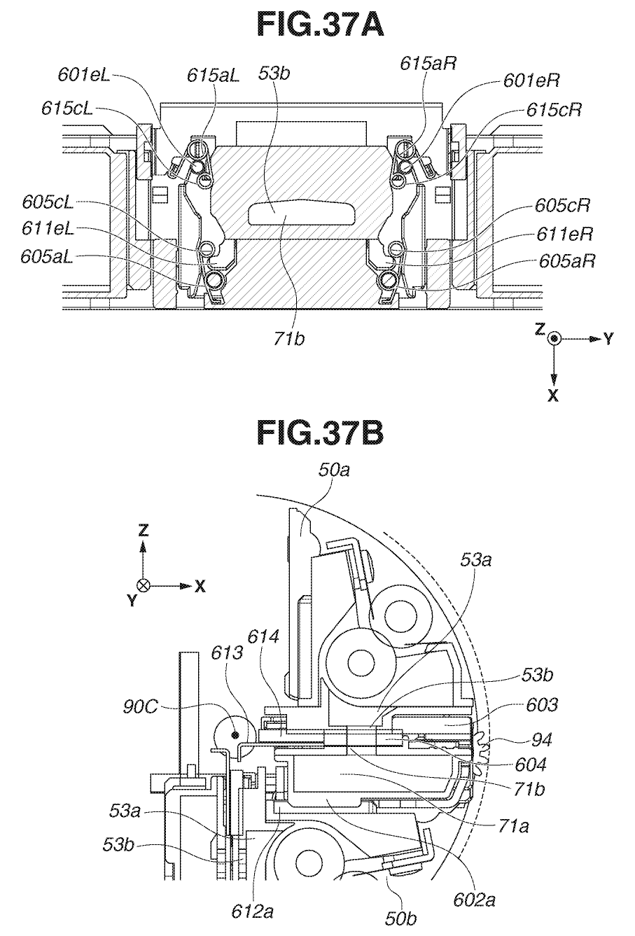

FIG. 36 is a perspective view for describing the mounting of the toner cartridge 70 (first toner cartridge 70a). FIGS. 37A and 37B are sectional views for describing the mounting of the toner cartridge 70 (first toner cartridge 70a). In FIGS. 36, 37A, and 37B, the first toner cartridge 70a is located at the mounted position.

As illustrated in FIG. 36, when the first toner cartridge 70a is located at the mounted position, the memory electrodes 74a of the memory 74 are exposed from the tray 80. The image forming apparatus 1 includes a connector capable of contact with the electrodes 74a. The control unit 100C of the image forming apparatus 1 is configured to read information from the memory 74 and write information to the memory 74.

FIG. 37B is a sectional view of the first developing unit 50a, the second developing unit 50b, and the first toner cartridge 70a taken along a cross section orthogonal to the rotation axis 90C of the rotary main body 90.

As illustrated in FIG. 37B, with the first toner cartridge 70a at the mounted position, the toner shutter 603 is located at the open position and the developing shutter 613 is located at the open position. In this state, the discharge opening 71b and the inlet opening 53b communicate with each other. When the rotary main body 90 rotates with the first toner cartridge 70a at the mounted position relative to the first developing unit 50a, and toner is discharged from the first toner cartridge 70a, the first developing unit 50a is replenished with toner.

The toner shutter 603 at the open position is closer to the rotation axis 90C of the rotary main body 90 than is the outermost portion in the radial direction of rotation of the rotary main body 90. Specifically, in the present embodiment, the dotted line illustrated in FIG. 37B represents the circumscribed circle of the rotary main body 90 about the rotation axis 90C of the rotary main body 90. The circumscribed circle is tangent to the pinion gear 94. The toner shutter 603 at the open position is located inside the circumscribed circle. This prevents the rotation of the rotary main body 90 from being interfered with by the toner shutter 603.

When viewed in the Y direction, the positioning portion 612a is closer to the second developing unit 50b than to the first developing unit 50a. More specifically, the positioning position 612a is closer to the developing-side accommodation portion 53a of the second developing unit 50b than to the developing-side accommodation portion 53a of the first developing unit 50a. When viewed in the Y direction, the to-be-positioned portion 602a of the first toner cartridge 70a at the mounted position is closer to the second developing unit 50b than to the first developing unit 50a. More specifically, the to-be-positioned portion 602a of the first toner cartridge 70a is closer to the developing-side accommodation portion 53a of the second developing unit 50b than to the developing-side accommodation portion 53a of the first developing unit 50a.

With the first toner cartridge 70a at the mounted position relative to the first developing unit 50a, the to-be-positioned portion 602a and the positioning portion 612a are engaged with each other. The first toner cartridge 70a can thus be positioned with high accuracy even during the rotation operation of the rotary main body 90 or while an image formation operation is performed on a recording material.

As illustrated in FIG. 37A, the spring engagement portion 611eL is sandwiched between the hook portion 605cL and the coil portion 605aL. Similarly, the spring engagement portion 611eR is sandwiched between the hook portion 605cR and the coil portion 605aR. In this state, when the first toner cartridge 70a moves in the retracting direction, the toner springs 605L and 605R and the toner shutter 603 are restricted from moving in the retracting direction relative to the developing lid 611. In other words, when the first toner cartridge 70a moves in the retracting direction, the toner springs 605L and 605R and the toner shutter 603 move in the -X direction relative to the toner frame 71 and the discharge opening 71b.

The spring engagement portion 601eL is sandwiched between the hook portion 615cL and the coil portion 615aL. Similarly, the spring engagement portion 601eR is sandwiched between the hook portion 615cR and the coil portion 615aR. In this state, when the first toner cartridge 70a moves in the retracting direction, the developing springs 615L and 615R and the developing shutter 613 are restricted from moving in the retracting direction relative to the toner lid 601. In other words, when the first toner cartridge 70a moves in the retracting direction, the developing springs 615L and 615R and the developing shutter 613 move in the +X direction along with the toner lid 601.

When the first toner cartridge 70a moves in the retracting direction, the relationship between the first toner cartridge 70a and the first developing unit 50a changes in the order of FIGS. 37A and 37B, 35, 34, 33, and 28.

When the first toner cartridge 70a moves in the +X direction, the engagement of the hook portions 605cL and 605cR with the spring engagement portions 611eL and 611eR causes the toner shutter 603 and the toner springs 605L and 605R to move in the -X direction relative to the toner frame 71 and the discharge opening 71b. In other words, when the first toner cartridge 70a moves in the +X direction, the engagement of the hook portions 605cL and 605cR with the spring engagement portions 611eL and 611eR restricts the toner shutter 603 and the toner springs 605L and 605R from moving in the +X direction relative to the developing frame 53. The toner springs 605L and 605R are examples of a movement restriction part (first movement restriction part, second movement restriction part) of the toner shutter unit.

The displacement of the toner frame 71 relative to the toner springs 605L and 605R displaces the spring guide portions 601dL and 601dR relative to the toner springs 605L and 605R. As a result, the toner springs 605L and 605R, which have been deformed by the spring guide portions 601dL and 601dR, return to the state of FIG. 17. This disengages the hook portions 605cL and 605cR from the spring engagement portions 611eL and 611eR. The biasing arms 605bL and 605bR of the toner springs 605L and 605R then press the spring guide portions 601dL and 601dR in the α1 and α2 directions.

In the present embodiment, the hook portions 605cL and 605cR are disengaged from the spring engagement portions 611eL and 611eR before the toner shutter 603 fully moves to the closed position.

However, the biasing arms 605bL and 605bR press the spring guides 601dL and 601dR in the α1 and α2 directions, whereby a force in the closing direction acts on the toner shutter 603, and the toner shutter 603 moves to the closed position. The hook portions 605cL and 605cR may be disengaged from the spring engagement portions 611eL and 611eR at the same time when the toner shutter 603 reaches the closed position.

When the first toner cartridge 70a moves in the +X direction, the engagement of the hook portions 615cL and 615cR with the spring engagement portions 601eL and 601eR causes the developing shutter 613 and the developing spring 615L and 615R to move in the +X direction relative to the developing frame 53 and the inlet opening 53b. That is, the engagement of the hook portions 615cL and 615cR with the spring engagement portions 601eL and 601eR causes the developing shutter 613 and the developing springs 615L and 615R to move in the +X direction along with the toner frame 71. In other words, the engagement of the hook portions 615cL and 615cR with the spring engagement portions 601eL and 601eR restricts the developing shutter 613 and the developing springs 615L and 615R from moving in the -X direction relative to the toner frame 71. The developing springs 615L and 615R are examples of a movement restriction part (first movement restriction part, second movement restriction part) of the developing shutter unit.

The displacement of the developing springs 615L and 615R relative to the developing frame 53 displaces the developing springs 615L and 615R relative to the spring guide portions 611dL and 611dR. As a result, the developing springs 615L and 615R, which have been deformed by the spring guide portions 611dL and 611dR, return to the state of FIG. 22. This disengages the hook portions 615cL and 615cR from the spring engagement portions 601eL and 601eR. The biasing arms 615bL and 615bR of the developing springs 615L and 615R then press the spring guide portions 611dL and 611dR in the β1 and β2 directions.

In the present embodiment, the hook portions 615cL and 615cR are disengaged from the spring engagement portions 601eL and 601eR before the developing shutter 613 fully moves to the closed position.

However, the biasing arms 615bL and 615bR press the spring guide portions 611dL and 611dR in the β1 and β2 directions, whereby a force in the closing direction acts on the developing shutter 613, and the developing shutter 613 moves to the closed position. The hook portions 615cL and 615cR may be disengaged from the spring engagement portions 601eL and 601eR at the same time when the developing shutter 613 reaches the closed position.

The movement of the first toner cartridge 70a from the attached position to the retracted position thus moves the toner shutter 603 from the open position to the closed position, and moves the developing shutter 613 from the open position to the closed position.

As described above, the to-be-guided portions 603dL and 603dR of the toner shutter 603 are guided by the shutter guides 601cL and 601cR. The positioning portion 612a and the to-be-positioned portion 602a are located between the to-be-guided portions 603dL and 603dR and between the shutter guides 601cL and 601cR in the Y direction. This stabilizes the opening and closing operation of the toner shutter 603.

The positioning portion 612a and the to-be-positioned portion 602a are also located between the toner springs 605L and 605R, between the spring guide portions 601dL and 601dR, and between the spring engagement portions 611eL and 611eR in the Y direction. This stabilizes the opening and closing operation of the toner shutter 603.

As described above, the to-be-guided members 616L and 616R of the developing shutter unit are guided by the shutter guides 611cL and 611cR. The positioning portion 612a and the to-be-guided portion 602a are located between the to-be-guided members 616L and 616R and between the shutter guides 611cL and 611cR in the Y direction. This stabilizes the opening and closing operation of the developing shutter unit.

The positioning portion 612a and the to-be-positioned portion 602a are also located between the developing springs 615L and 615R, between the spring guide portions 611dL and 611dR, and between the spring engagement portions 601eL and 601eR in the Y direction. This stabilizes the opening and closing operation of the developing shutter unit.

### Summary

As described above, in the present embodiment, at least a part of the discharge opening 71b and at least a part of the to-be-positioned portion 602a are located at the same position in the Y direction. The discharge opening 71b can thus be positioned with high accuracy.

In the present embodiment, at least a part of the discharge opening 71b and at least a part of the to-be-positioned portion 602a are located at the same position in the X direction. The discharge opening 71b can thus be positioned with even higher accuracy.

In the present embodiment, the to-be-positioned portion 602a is located away from the discharge opening 71b, and the part where the positioning portion 612a is disposed is different from the part where the inlet opening 53b is disposed. The discharge opening 71b and the to-be-positioned portion 602a can thus be located close to each other without obstructing toner flow through the discharge opening 71b and the inlet opening 53b.

In the present embodiment, the positioning portion 612a for positioning the to-be-positioned portion 602a of the first toner cartridge 70a is closer to the second developing unit 50b than to the first developing unit 50a. The configuration for positioning the first toner cartridge 70a can thus be disposed in a space-saving manner.

In the present embodiment, when the first toner cartridge 70a moves from the retracted position to the mounted position, the to-be-positioned portion 602a and the positioning portion 612a engage with each other before the discharge opening 71b is opposed to the inlet opening 53b. Moreover, the to-be-positioned portion 602a and the positioning portion 612a engage with each other before the developing shutter 613 moves in the opening direction and before the toner shutter 603 moves in the opening direction. The discharge opening 71b can thus be opposed to the inlet opening 53b, and the developing shutter 613 and the toner shutter 603 can move, with the first toner cartridge 70a stable.

### Second Embodiment

A second embodiment will be described. In the second embodiment, components similar to those described in the first embodiment are denoted by the same reference numerals, and a detailed description thereof will in principle be omitted.

As will be described below, a toner cartridge 170 of the second embodiment includes a to-be-positioned portion 702a, and a developing unit 150 of the second embodiment includes a positioning portion 712a. The functions and arrangement of the to-be-positioned portion 702a and the positioning portion 712a are the same as those of the to-be-positioned portion 602a and the positioning portion 612a of the first embodiment. However, the shapes of the to-be-positioned portion 702a and the positioning portion 712a are different from those of the to-be-positioned portion 602a and the positioning portion 612a of the first embodiment.

Except for the shapes of the to-be-positioned portion 702a and the positioning portion 712a, the toner cartridge 70 of the first embodiment and the toner cartridge 170 of the second embodiment, and the developing unit 50 of the first embodiment and the developing unit 150 of the second embodiment, have a common configuration.

In the first embodiment, the to-be-positioned portion 602a is a protrusion to be inserted into the recess (groove) formed by the positioning portion 612a. In the second embodiment, the positioning portion 712a is a protrusion to be inserted into a groove (recess) formed by the to-be-positioned portion 702a. As a summary of the first and second embodiments, one of the to-be-positioned portion and the positioning portion is a protrusion and is inserted into the recess (groove) formed by the other of the to-be-positioned portion and the positioning portion.

### Configuration of Toner Cartridge

The toner cartridge 170 of the second embodiment includes a toner frame 171 corresponding to the toner frame 71 of the first embodiment. While the toner frame 71 of the first embodiment includes the toner container 602, the toner frame 171 of the second embodiment includes a toner container 702. The toner cartridge 70 of the first embodiment and the toner cartridge 170 of the second embodiment have a common configuration except for the difference between the toner containers 602 and 702. The toner containers 602 and 702 have a common configuration except for the shapes of the to-be-positioned portions 602a and 702a.

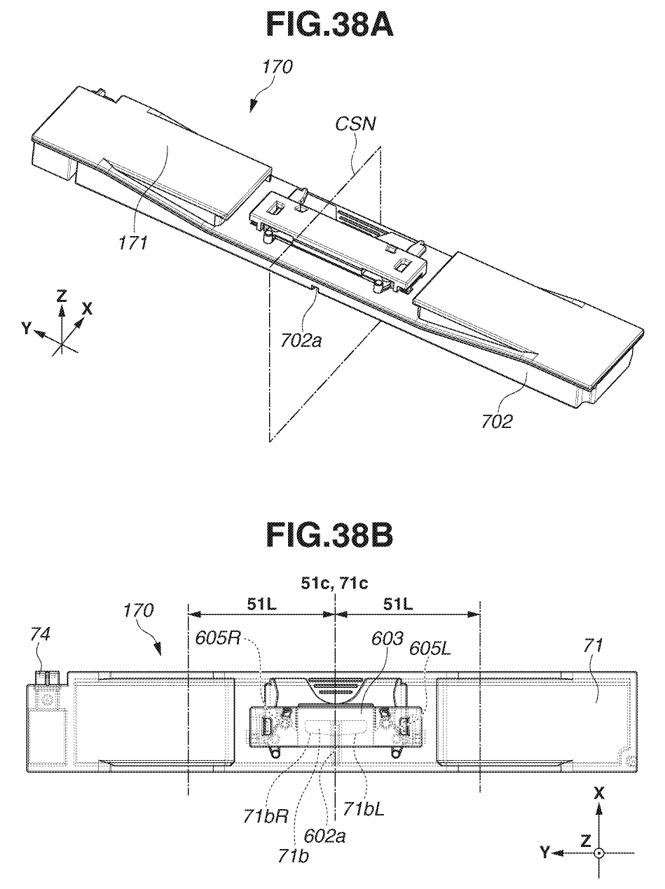

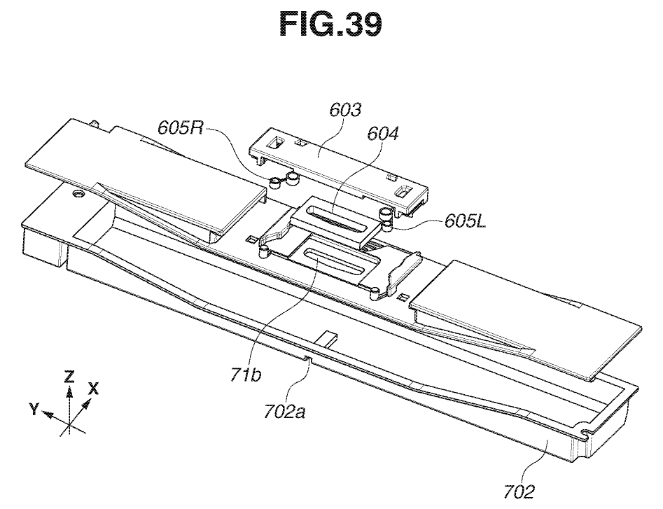

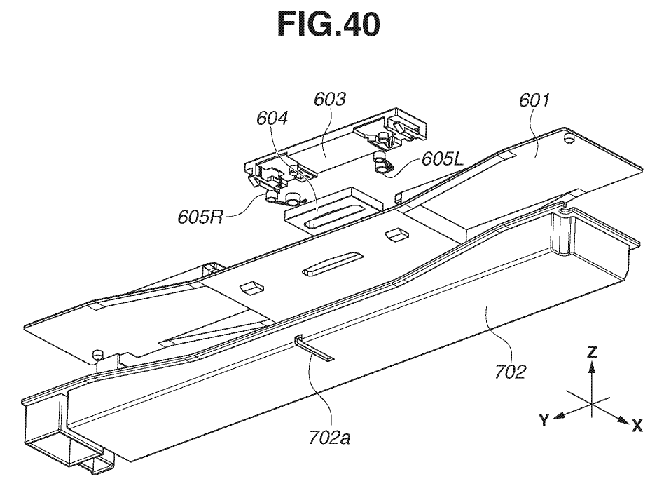

The configuration of the toner cartridge 170 will be described with reference to FIGS. 38A to 41. FIGS. 38A and 38B are explanatory diagrams of the toner cartridge 170. Specifically, FIG. 38A is a perspective view of the toner cartridge 170. FIG. 38B is a top view of the toner cartridge 170 as seen in the Z direction. FIGS. 39 and 40 are exploded perspective views of the toner cartridge 170.

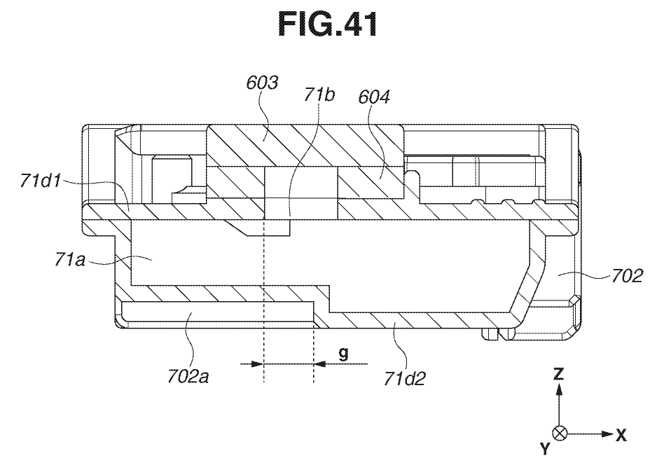

FIG. 41 is a sectional view of the toner cartridge 170. Specifically, FIG. 41 is a sectional view when the toner cartridge 170 of FIG. 38A is sectioned along a cross section CSN.

The toner cartridge 170 includes a toner lid 601, the toner container 702, a toner shutter 603, a toner seal 604, and toner springs 605L and 605R. The toner springs 605L and 605R are an example of the first spring and the second spring. A discharge opening 71b and the to-be-positioned portion 702a are located between the toner springs 605L and 605R in the Y direction.

The toner frame 171 includes the toner lid 601 and the toner container 702. The toner lid 601 and the toner container 702 are fixed to each other by welding or adhesive bonding to form a toner accommodation portion (toner accommodation chamber, accommodation chamber) 71a for accommodating toner. With the toner cartridge 170 detached from the developing unit 150, the toner shutter 603 is closed.

The to-be-positioned portion 702a is disposed in a lower part of the toner container 702. When the toner cartridge 170 is located at the mounted position, the to-be-positioned portion 702a engages with the positioning portion 712a to be described below, whereby the toner cartridge 170 is restricted from moving relative to the developing unit 50 in the Y direction.

The position of a discharge opening 71b and the position of the to-be-positioned portion 702a at least partially overlap in the Y direction. In other words, at least a part of the discharge opening 71b and at least a part of the to-be-positioned portion 702a are located at the same position in the Y direction.

The close arrangement of the to-be-positioned portion 702a and the discharge opening 71b enables accurate positioning of the discharge opening 71b. That is, the discharge opening 71b can be positioned with respect to an inlet opening 53b with high accuracy.

The to-be-positioned portion 702a is a recess formed in the bottom of the toner container 702 (the bottom of the toner frame 171). The to-be-positioned portion 702a forms a groove extending along the X direction. The to-be-positioned portion 702a is exposed to the outside of the toner container 702. As illustrated in FIG. 38B, the length of the to-be-positioned portion 702a in the Y direction is smaller than the length of the to-be-positioned portion 702a in the X direction. The length of the to-be-positioned portion 702a in the Y direction is also smaller than the length of the to-be-positioned portion 702a in the moving direction (opening direction and closing direction) of the toner shutter 603. At least a part of the to-be-positioned portion 702a and at least a part of the discharge opening 71b are located at the same position in the moving direction of the toner shutter 603. When viewed in the Z direction, the to-be-positioned portion 702a overlaps the discharge opening 71b.

The to-be-positioned portion 702a is located substantially at the center of the toner cartridge 170. Specifically, as illustrated in FIG. 38B, a position of a reference length 51L away from a center 51c to one side in the Y direction will be referred to as a first position, and a position of the reference length 51L away from the center 51c to the other side will be referred to as a second position. The to-be-positioned portion 702a of the toner cartridge 170 at the mounted position is located between the first position and the second position.

The length of the to-be-positioned portion 702a in the Y direction is smaller than that of the toner accommodation portion 71a. The length of the to-be-positioned portion 702a in the Y direction is also smaller than that of the discharge opening 71b. The to-be-positioned portion 702a is located between a first end 71bL and a second end 71bR in the Y direction (longitudinal direction of the toner cartridge 170).

As illustrated in FIG. 41, the position of the to-be-positioned portion 702a and the position of the discharge opening 71b at least partially overlap in the X direction. In other words, at least a part of the to-be-positioned portion 702a and at least a part of the discharge opening 71b are located at the same position in the X direction. More specifically, the to-be-positioned portion 702a and the discharge opening 71b overlap across a range g illustrated in FIG. 41.

That is, the position of the to-be-positioned portion 702a and the position of the discharge opening 71b at least partially overlap in the Y direction and the X direction. As a result, when the to-be-positioned portion 702a is positioned by the positioning portion 712a, the discharge opening 71b can be positioned with even higher accuracy. That is, the discharge opening 71b can be positioned with respect to the inlet opening 53b with high accuracy.

At least a part of the to-be-positioned portion 702a is located downstream of the discharge opening 71b in the -X direction. At least a part of the to-be-positioned portion 702a is also located downstream of the toner shutter 603 at the closed position in the -X direction. The to-be-positioned portion 702a is closer to the downstream end of the toner frame 171 than to the upstream end of the toner frame 171 in the -X direction.

The toner frame 171 includes a first wall 71d1 where the discharge opening 71b is disposed and a second wall 71d2 opposed to the first wall 71d1. The first wall 71d1 and the second wall 71d2 are opposed via the toner accommodation portion 71a. That is, the toner accommodation portion 71a is located between the first wall 71d1 and the second wall 71d2. The to-be-positioned portion 702a is disposed in the second wall 71d2.

### Configuration of Developing Unit

The developing unit 150 of the second embodiment includes a developing frame 153 corresponding to the developing frame 53 of the first embodiment. While the developing frame 53 of the first embodiment includes the developing container 612, the developing frame 153 of the second embodiment includes a developing container 712. The developing unit 50 of the first embodiment and the developing unit 150 of the second embodiment have a common configuration except for the difference between the developing containers 612 and 712.

The developing containers 612 and 712 have a common configuration except for the shapes of the positioning portions 612a and 712a.

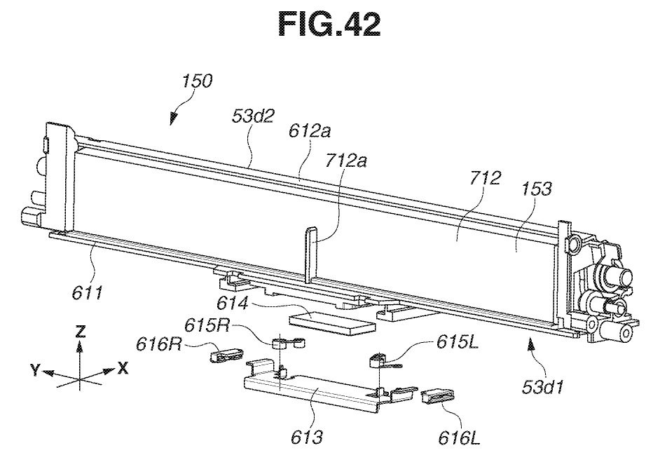

A configuration of the developing unit 150 will be described with reference to FIG. 42. FIG. 42 is an exploded perspective view of the developing unit 150.

As illustrated in FIG. 42, the developing unit 150 includes a developing lid 611, the developing container 712, a developing shutter 613, a developing seal 614, and developing springs 615L and 615R. To-be-guided members 616L and 616R are attached to the developing shutter 613.

The developing frame 153 includes the developing lid 611 and the developing container 712. The developing lid 611 and the developing container 712 are fixed to each other by welding or adhesive bonding to form a developing-side accommodation portion 53a. The developing lid 611 has an inlet opening 53b communicating with the developing-side accommodation portion 53a. The developing unit 150 also includes a developing roller 51 and a supply roller 52.

With the toner cartridge 170 detached from the developing unit 150, the developing shutter 613 is closed. In other words, the developing shutter 613 is located at a closed position.

The developing frame 153 has a first surface 53d1 where the inlet opening 53b is disposed and a second surface 53d2 inclined relative to the first surface 53d1. That is, the second surface 53d2 extends in a direction intersecting (desirably orthogonal to) the first surface 53d1. The second surface 53d2 is a surface different from the first surface 53d1. The first surface 53d1 is a part of the developing lid 611, and the second surface 53d2 is a part of the developing container 712. The inlet opening 53b and the developing shutter 613 are disposed in/on the first surface 53d1. The positioning portion 712a is disposed on the second surface 53d2.

The engagement of the to-be-positioned portion 702a of the toner cartridge 170 with the positioning portion 712a restricts the toner cartridge 170 from moving relative to the developing unit 150 in the Y direction.

The position of the inlet opening 53b and the position of the positioning portion 712a at least partially overlap in the Y direction. In other words, at least a part of the inlet opening 53b and at least a part of the positioning portion 712a are located at the same position in the Y direction.

The positioning portion 712a is a protrusion that protrudes from the second surface 53d2 and is to be inserted into the to-be-positioned portion 702a. In the present embodiment, the positioning portion 712a is a rib.

The positioning portion 712a is located substantially at the center of the developing unit 150. The position of the center 51c of the developing roller 51, the position of the inlet opening 53b, and the position of the positioning portion 712a overlap in the Y direction.

In the Y direction (longitudinal direction of the toner cartridge 170), the inlet opening 53b has a first end 53bL and a second end 53bR opposite to the first end 53bL (see FIG. 22). The positioning portion 712a is located between the first end 53bL and the second end 53bR in the Y direction.

In the present embodiment as well, the positional relationship between the positioning portion 712a of one developing unit 150 and the inlet opening 53b of another developing unit 150 is similar to that between the positioning portion 712a and the inlet opening 53b of a single developing unit 150.

### Configuration of Rotary Main Body and Plurality of Developing Units

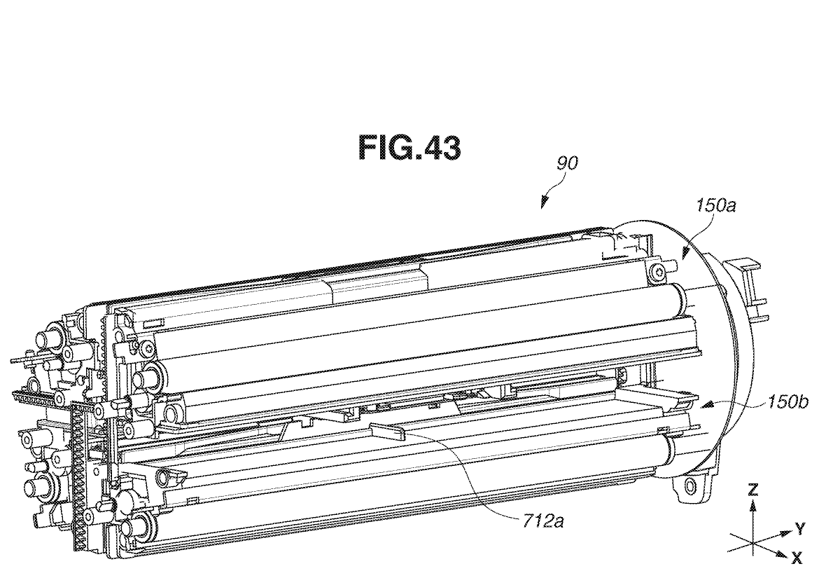

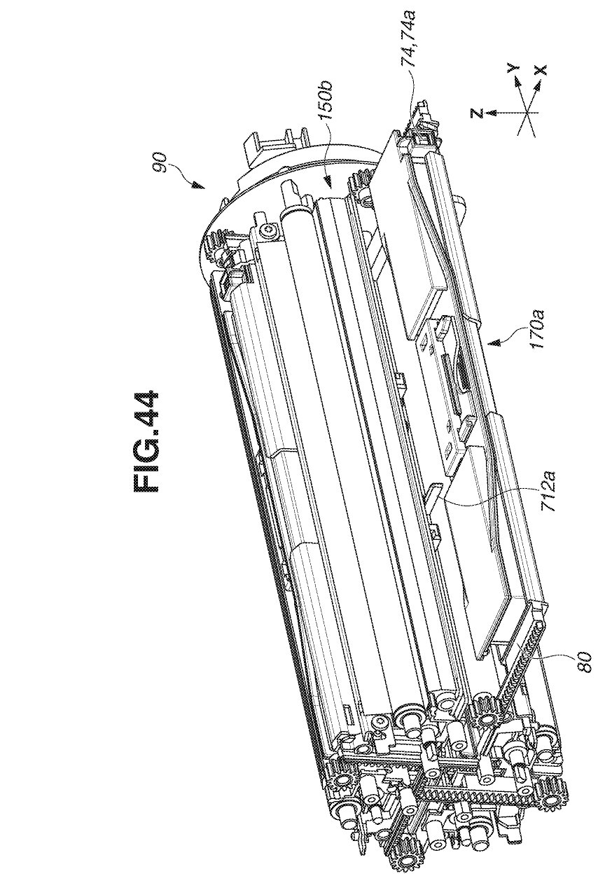

A configuration of a rotary main body and a plurality of developing units will be described with reference to FIGS. 43 and 44.

FIG. 43 is a perspective view of a rotary main body 90. FIG. 44 is a perspective view for describing the mounting of the toner cartridge 170 (first toner cartridge 170a). Specifically, FIG. 44 is a perspective view when the toner cartridge 170a is placed on a tray 80 of the rotary main body 90.

In the rotary main body 90, the plurality of developing units 150 is arranged at intervals of 90º. A first developing unit will be denoted by 150a, and a second developing unit adjacent to the first developing unit 150a will be denoted by 150b. A toner cartridge 170 mounted in the first developing unit 150a will be referred to as a first toner cartridge 170a. The first developing unit 150a and the second developing unit 150b have the same configuration as that of the foregoing developing unit 150. The first toner cartridge 170a has the same configuration as that of the foregoing toner cartridge 170.

In FIG. 43, the tray 80 of the first developing unit 150a is omitted.

The first toner cartridge 170a accommodating toner to be supplied to the first developing unit 150a is mounted between the first developing unit 150a and the second developing unit 150b.

The to-be-positioned portion 702a disposed in the first toner cartridge 170a engages with the positioning portion 712a disposed on the second developing unit 150b. That is, when the first toner cartridge 170a is at the mounted position, the first toner cartridge 170a is positioned by the positioning portion 712a disposed on the second developing unit 150b.

In mounting the first toner cartridge 170a in the first developing unit 150a, the first toner cartridge 170a is attached to the tray 80 included in the first developing unit 150a. The tray 80 is then moved to move the first toner cartridge 170a to the mounted position.

When the first toner cartridge 170a is placed on the tray 80, memory electrodes 74a of a memory 74 face outward in the radial direction of rotation of the rotary main body 90.

### Operation When Mounting Toner Cartridge

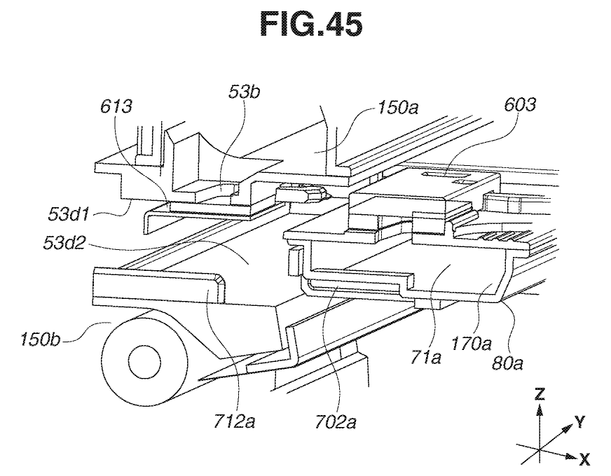

FIGS. 45, 46, and 47 are sectional views for describing the mounting of the toner cartridge 170 (first toner cartridge 170a).

As illustrated in FIG. 44, a new first toner cartridge 170a is placed on the tray 80.

As described in the first embodiment, when the first toner cartridge 170a moves from the retracted position to the mounted position, to-be-supported portions 601hL and 601hR and cartridge support portions 611hL and 611hR engage with each other before the first toner cartridge 170a reaches the mounted position.

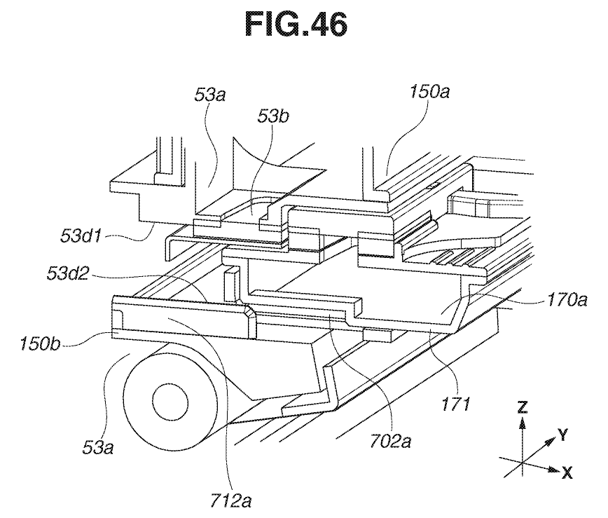

As illustrated in FIG. 45, the tray 80 has an opening 80a, where the to-be-positioned portion 702a of the toner cartridge 170a is exposed. In a state where the to-be-supported portions 601hL and 601hR start to engage with the cartridge support portions 611hL and 611hR, as illustrated in FIG. 46, the positioning portion 712a of the second developing unit 150b and the to-be-positioned portion 702a of the first toner cartridge 170a are not engaged.

When the tray 80 moves from the position illustrated in FIG. 45 and the first toner cartridge 170a is further pulled into the rotary main body 90, the to-be-positioned portion 702a of the first toner cartridge 170a comes into engagement with the positioning portion 712a of the second developing unit 150b. As a result, the first toner cartridge 170a is restricted from moving in the Y direction relative to the first developing unit 150a and the second developing unit 150b. The first toner cartridge 170a is thereby positioned with respect to the first developing unit 150a and the second developing unit 150b in the Y direction. In other words, the contact between the to-be-positioned portion 702a and the positioning portion 712a restricts movement of the first toner cartridge 170 in the +Y direction and the -Y direction.

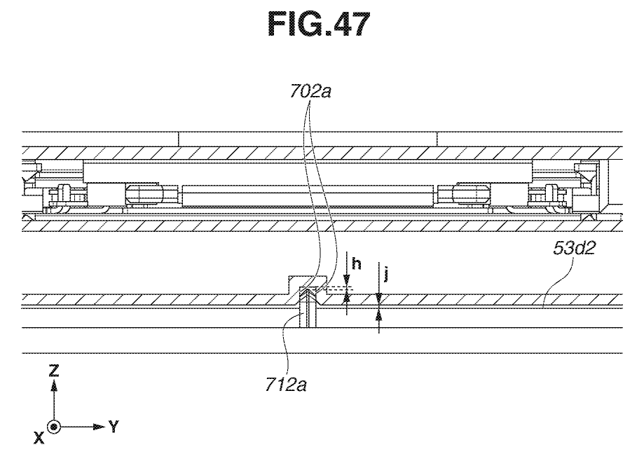

As illustrated in FIG. 47, there is a gap h between the bottom of the recess of the to-be-positioned portion 702a and the tip of the positioning portion 712a in the Z direction. Meanwhile, there is a gap j between the second surface 53d2 where the positioning portion 712a is disposed and the toner frame 171 of the first toner cartridge 170a.

With the to-be-supported portions 601hL and 601hR and the cartridge support portions 611hL and 611hR engaged with each other and the to-be-positioned portion 702a and the positioning portion 712a engaged with each other, movement of the first toner cartridge 170a is restricted in the Y direction and the Z direction. Meanwhile, in this state, the first toner cartridge 170a can move in the X direction.

As described above, when the first toner cartridge 170a moves from the retracted position to the mounted position, the to-be-positioned portion 702a and the positioning portion 712a engage with each other before the first toner cartridge 170a reaches the mounted position. The to-be-positioned portion 702a and the positioning portion 712a remain engaged with each other with the first toner cartridge 170a at the mounted position.

The to-be-positioned portion 702a and the positioning portion 712a are in a clearance fit relationship. Due to the difference in size between the to-be-positioned portion 702a and the positioning portion 712a, the first toner cartridge 170a may tilt such that the longitudinal direction of the first toner cartridge 170a is oblique to the Y direction. Since the position of the to-be-positioned portion 702a and the position of the discharge opening 71b at least partially overlap in the Y direction, displacement of the discharge opening 71b due to the tilt of the first toner cartridge 170a can be suppressed. In other words, the discharge opening 71b can be positioned with high accuracy.

The inlet opening 53b of the first developing unit 150a is disposed in the first surface 53d1. The positioning portion 712a is located away from the first surface 53d1. As a result, the to-be-positioned portion 702a of the first toner cartridge 170a is located away from the discharge opening 71b. At least a part of the to-be-positioned portion 702a and at least a part of the discharge opening 71b can thus be located at the same position in the Y direction without the to-be-positioned portion 702a obstructing the toner discharge from the discharge opening 71b.

In the present embodiment as well, the to-be-positioned portion 712a is disposed on the second surface 53d2 of the second developing unit 150b. The positioning portion 712a is closer to the second developing unit 150b than to the first developing unit 150a in a direction orthogonal to the Y direction. More specifically, the positioning portion 712a is closer to the developing-side accommodation portion 53a of the second developing unit 150b than to the developing-side accommodation portion 53a of the first developing unit 150a. In the present embodiment, the positioning portion 712a is disposed on the developing frame 153 of the second developing unit 150b.

Such an arrangement prevents the to-be-positioned portion 702a from interfering with toner discharge from the discharge opening 71b, even with the position of the to-be-positioned portion 702a and the position of the discharge opening 71b at least partially overlapping in the Y direction and the X direction. Moreover, the configuration for positioning the first toner cartridge 170a in the Y can be disposed in a space-saving manner.

The positioning portion 712a may be disposed on a component different from the developing frame 153 of the second developing unit 150b. However, the integral disposition of the positioning portion 712a on the developing frame 153 of the second developing unit 150b as in the present embodiment can reduce an increase in parts count.

In the present embodiment, when the first toner cartridge 170a moves from the retracted position to the mounted position, the to-be-positioned portion 702a and the positioning portion 712a engage with each other before the discharge opening 71b is opposed to the inlet opening 53b. Moreover, the to-be-positioned portion 702a and the positioning portion 712a engage with each other before the developing shutter 613 moves in the opening direction and before the toner shutter 603 moves in the opening direction. The discharge opening 71b and the inlet opening 53b can thus be opposed to each other, and the developing shutter 613 and the toner shutter 603 can move, with the first toner cartridge 170a stable.

### Summary

As described above, in the present embodiment, at least a part of the discharge opening 71b and at least a part of the to-be-positioned portion 702a are located at the same position in the Y direction. The discharge opening 71b can thus be positioned with high accuracy.

In the present embodiment, at least a part of the discharge opening 71b and at least a part of the to-be-positioned portion 702a are located at the same position in the X direction. The discharge opening 71b can thus be positioned with even higher accuracy.

In the present embodiment, the to-be-positioned portion 702a is located away from the discharge opening 71b, and the part where the positioning portion 712a is disposed is different from the part where the inlet opening 53b is disposed. The discharge opening 71b and the to-be-positioned portion 702a can thus be located close to each other without obstructing toner flow through the discharge opening 71b and the inlet opening 53b.

In the present embodiment, the positioning portion 712a for positioning the to-be-positioned portion 702a of the first toner cartridge 170a is closer to the second developing unit 150b than to the first developing unit 150a. The configuration for positioning the first toner cartridge 170a can thus be disposed in a space-saving manner.

In the present embodiment, when the first toner cartridge 170a moves from the retracted position to the mounted position, the to-be-positioned portion 702a and the positioning portion 712a engage with each other before the discharge opening 71b is opposed to the inlet opening 53b. Moreover, the to-be-positioned portion 702a and the positioning portion 712a engage with each other before the developing shutter 613 moves in the opening direction and before the toner shutter 603 moves in the opening direction. The discharge opening 71b can thus be opposed to the inlet opening 53b, and the developing shutter 613 and the toner shutter 603 can move, with the first toner cartridge 170a stable.

In the present embodiment as well, the positioning portion 712a and the to-be-positioned portion 702a are located between the to-be-guided portions 603dL and 603dR and between the shutter guides 601cL and 601cR in the Y direction. This stabilizes the opening and closing operation of the toner shutter 603.

The positioning portion 712a and the to-be-positioned portion 702a are also located between the toner springs 605L and 605R, between the spring guide portions 601dL and 601dR, and between the spring engagement portions 611eL and 611eR in the Y direction. This stabilizes the opening and closing operation of the toner shutter 603.

The positioning portion 712a and the to-be-positioned portion 702a are also located between the to-be-guided portion 616L and 616R and between the shutter guides 611cL and 611cR in the Y direction. This stabilizes the opening and closing operation of the developing shutter unit.

The positioning portion 712a and the to-be-positioned portion 702a are also located between the developing springs 615L and 615R, between the spring guide portions 611dL and 611dR, and between the spring engagement portions 601eL and 601eR in the Y direction. This stabilizes the opening and closing operation of the developing shutter unit.

### Other Embodiments

In the foregoing embodiments, the first developing unit 50a or 150a and the second developing unit 50b or 150b are included in the rotary main body 90. However, the present disclosure is also applicable to an image forming apparatus of tandem type where the first developing unit 50a or 150a and the second developing unit 50b or 150b are arranged in series.

The present disclosure can provide an image forming apparatus of a new form that is an advancement of the conventional technology.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-076509, filed May 2, 2025, which is hereby incorporated by reference herein in its entirety.

What is claimed is:

1. An image forming apparatus comprising:
a first developing unit including a first developing roller configured to rotate, a first supply chamber configured to accommodate toner to be supplied to the first developing roller, and a first inlet opening communicating with the first supply chamber;
a second developing unit including a second developing roller configured to rotate, a second supply chamber configured to accommodate toner to be supplied to the second developing roller, and a second inlet opening communicating with the second supply chamber;
a first toner cartridge including a first accommodation chamber configured to accommodate toner, a first discharge opening communicating with the first accommodation chamber, and a to-be-positioned portion, the first toner cartridge being configured to move relative to the first developing unit between a first mounted position where the first discharge opening is opposed to the first inlet opening and a first retracted position retracted from the first mounted position;
a second toner cartridge including a second accommodation chamber configured to accommodate toner and a second discharge opening communicating with the second accommodation chamber, the second toner cartridge being configured to move relative to the second developing unit between a second mounted position where the second discharge opening is opposed to the second inlet opening and a second retracted position retracted from the second mounted position; and
a positioning portion configured to engage with the to-be-positioned portion of the first toner cartridge at the first mounted position such that the first toner cartridge is restricted from moving relative to the first developing unit in a rotation axis direction of the first developing roller,
wherein in the rotation axis direction, at least a part of the to-be-positioned portion and at least a part of the first discharge opening are located at a same position, and at least a part of the positioning portion and at least a part of the first inlet opening are located at a same position, and
wherein, in a direction orthogonal to the rotation axis direction, the positioning portion is disposed closer to the second developing unit than to the first developing unit.

2. The image forming apparatus according to claim 1, wherein, in the direction orthogonal to the rotation axis direction, the positioning portion is disposed closer to the second supply chamber than to the first supply chamber.

3. The image forming apparatus according to claim 1, wherein the positioning portion is disposed on the second developing unit.

4. The image forming apparatus according to claim 1, wherein the positioning portion and the to-be-positioned portion are configured to, in a case where the first toner cartridge moves from the first retracted position to the first mounted position, engage with each other before the first toner cartridge reaches the first mounted position.

5. The image forming apparatus according to claim 1, wherein a moving direction of the first toner cartridge when the first toner cartridge moves from the first retracted position to the first mounted position intersects the rotation axis direction.

6. The image forming apparatus according to claim 1, wherein, in the rotation axis direction, the to-be-positioned portion is located between a first position and a second position, the first position being a position of a reference length away from a center of the first developing roller to one side, the second position being a position of the reference length away from the center of the first developing roller to the other side, the reference length being 20% of a length of the first developing roller.

7. The image forming apparatus according to claim 1,
wherein the first toner cartridge includes:
a first wall having the first discharge opening, and
a second wall opposed to the first wall, and
wherein the to-be-positioned portion is disposed on the second wall.

8. The image forming apparatus according to claim 1,
wherein the first discharge opening has a first end and a second end opposite to the first end in the rotation axis direction, and
wherein the to-be-positioned portion is located between the first end and the second end in the rotation axis direction.

9. The image forming apparatus according to claim 1,
wherein the first toner cartridge includes a toner shutter,
wherein the toner shutter is configured to move between a closed position where the first discharge opening is covered and an open position where the first discharge opening is exposed, and
wherein the toner shutter is configured to move from the closed position toward the open position in contact with the first developing unit.

10. The image forming apparatus according to claim 1, further comprising:
a photosensitive drum; and
a rotary configured to support the first developing unit and the second developing unit,
wherein the rotary is configured to rotate such that the first developing roller and the second developing roller are displaced relative to the photosensitive drum.

11. A toner cartridge configured to be detachably mounted in a developing unit including a positioning portion, the toner cartridge comprising:
a toner frame including an accommodation chamber configured to accommodate toner, a discharge opening communicating with the accommodation chamber, and a to-be-positioned portion, wherein the to-be-positioned portion is configured to engage with the positioning portion such that the toner cartridge is restricted from moving relative to the developing unit in a longitudinal direction of the toner cartridge; and
a toner shutter configured to move in an opening direction from a closed position where the discharge opening is covered to an open position where the discharge opening is exposed,
wherein the discharge opening has a first end and a second end opposite to the first end in the longitudinal direction,
wherein the to-be-positioned portion is located between the first end and the second end in the longitudinal direction, and
wherein the to-be-positioned portion extends along the opening direction of the toner shutter.

12. The toner cartridge according to claim 11, wherein the toner shutter is configured to move in a direction intersecting the longitudinal direction of the toner cartridge.

13. The toner cartridge according to claim 11,
wherein the toner frame includes:
a first wall having the discharge opening, and
a second wall opposed to the first wall, and
wherein the to-be-positioned portion is disposed on the second wall.

14. The toner cartridge according to claim 11, wherein a length of the to-be-positioned portion in the longitudinal direction is less than a length of the to-be-positioned portion in the opening direction.

15. The toner cartridge according to claim 11, wherein at least a part of the to-be-positioned portion and at least a part of the discharge opening are located at a same position in the opening direction.

16. The toner cartridge according to claim 11, further comprising a biasing member,
wherein the biasing member is configured to, when the toner shutter is at the closed position, bias the toner shutter in a closing direction opposite to the opening direction.

17. The toner cartridge according to claim 16, wherein, among forces that the toner shutter receives from the biasing member, a force acting in the closing direction is smaller in magnitude when the toner shutter is at the open position than when the toner shutter is at the closed position.

18. The toner cartridge according to claim 16, wherein the biasing member includes a first spring and a second spring.

19. The toner cartridge according to claim 18, wherein the discharge opening is located between the first spring and the second spring in the longitudinal direction.
